(19) United States
(12) Patent Application Publication
(10) Pub. No.: US 2010/0105595 A1
(43) Pub. Date: Apr. 29, 2010

(54) COMPOSITION COMPRISING CHELATING AGENTS CONTAINING AMIDOXIME COMPOUNDS

(76) Inventor: Wai Mun Lee, Fremont, CA (US)

Correspondence Address: Dunlap Codding, P.C. - EKC Technology, P.O. Box 16370, Oklahoma City, OK, 73113, US

(21) Appl. No.: 12/260,672

(22) Filed: Oct. 29, 2008

(51) Int. Cl. C11D 7/18; C11D 7/32

(52) U.S. Cl. 510/176; 510/175

(57) ABSTRACT

The present invention is a novel aqueous cleaning solution for use in semiconductor front end of the line (FEOL) manufacturing process wherein the cleaning solution comprises at least one amidoxime compound.

### BACKGROUND

Front End Of Line processes (FEOL) perform an operation on a semiconductor wafer in the course of device manufacturing up to first metallization. Back End Of Line processes (BEOL) perform an operation on a semiconductor wafer in the course of device manufacturing following first metallization.

A large number of complexing agents for metal ions are used in a wide variety of applications, such as: semiconductor cleaning, detergents and cleaners, electroplating, water treatment and polymerizations, the photographic industry, the textile industry, the papermaking industry, pharmaceuticals, cosmetics, foodstuffs and plant feeding.

The present invention relates to the field of semiconductor processing and more specifically to a cleaning solution and a method of using the cleaning solution for Front End Of Line processes (FEOL) in a semiconductor manufacturing cleaning process.

Metal gate materials are currently being introduced in conjunction with high-k gate dielectrics. Some of the likely candidates, such as ruthenium or molybdenum, are likely to pose major challenges for wet processing, particularly in relation to the decontamination of the wafer backside. An undesired by-product of the chemical vapor or atomic layer deposition used to deposit these materials is the deposition of films on the wafer backside. A wet etch will likely be necessary to remove the deposited films from the backside of the wafer and to prevent front-side contamination issues and effective removal will likely be difficult.

There may also be changes in the nature of the metal silicides used. Nickel silicide (NiSi) will likely be the primary choice at 65 nm and, likely, 45 nm. Metal silicides are formed by depositing the metal onto the surface of the wafer and annealing to form the silicide on the exposed silicon surfaces on the gate stack and source/drain regions. Where silicon is not exposed, there is a need for selective removal of the unreacted metal. Nickel will likely provide a challenge for selective frontside etch and backside decontamination. There is also interest in Ni(Pt)Si, mostly at 45 nm and below, as a replacement silicide because of its ability to improve the salicidation process. The addition of even 5% platinum may introduce a challenge to remove the unreacted metal after the salicidation process. Platinum metal is difficult to wet etch, and efforts to identify appropriate solutions are ongoing.

The effectiveness of different cleaning methods is heavily dependent on the surface being cleaned and the nature of the material being removed from the surface. The wafer fabrication process may be broadly divided up into front end of line (FEOL) and back end of line (BEOL) processes. The FEOL process is focused on the fabrication of the different devices that make up the circuit and the BEOL process is focused on interconnecting the devices. Historically, the surfaces being cleaned in FEOL cleaning are typically silicon (Si) or silicon dioxide (SiO₂). In BEOL cleaning, metal layers are present on the wafers and the allowable cleaning solutions are limited versus FEOL cleaning.

As devices continue to shrink below 45 nm, wafer surface preparation has become more critical to high yield devices. The successful implementation of the new high-k and metal gate materials in different integration schemes requires a fundamental understanding of their cleaning properties. The integration of dual metal gates for CMOS fabrication is challenging and requires a selective removal of the first metal prior to depositing the second one, such as Ti and Ta-based metals and the underlying high-k such as SiON, HfO₂, RuO₂ or HfSiO(N) etc. which will require further optimization of the cleaning solutions and/or complete removal of the underlying gate dielectric to reduce the metal contamination below the detection limit.

Surfaces may also be characterized as hydrophobic or hydrophilic. SiO₂ surfaces are hydrophilic. Hydrophilic surfaces are easily wetted by cleaning solutions. During drying, any particles on the surface tend to stay in solution until the solution is removed from the surface. Si surfaces free of oxide are hydrophobic. Hydrophobic surfaces are more difficult to clean because cleaning solutions do not wet as well and during drying, the solutions tend to “bead” up on the surface, leaving particles on the surface instead of maintaining the particles in solution.

The analytical method for describing wetting and for determining whether a surface is hydrophobic or hydrophilic is measurement of contact angle.

Contact angle is a quantitative measurement of the wetting of a solid by a liquid. It is defined geometrically as the angle formed by a liquid at the three phase boundary where a liquid, gas and solid intersect as shown below. Contact angle measurement characterizes the interfacial tension between a solid and a liquid drop. The technique provides a simple method to generate a great amount of information for surface analysis. And because the technique is extremely surface sensitive, it can be used in semiconductor cleaning applications. Contact angle measurement is a simplified method of characterizing the interfacial tension present between a solid, a liquid, and a vapor. When a droplet of a high surface tension liquid rests on a solid of low surface energy, the liquid surface tension will cause the droplet to form a spherical shape (lowest energy shape). Conversely, when the solid surface energy exceeds the liquid surface tension, the droplet is a flatter, lower profile shape. See FIG. 1.

Most cleaning challenges are evolutionary as structures get smaller and specifications get tighter and are advanced by a variety of new materials, new integration schemes and process flows.

Another common problem with cleaning semiconductor surfaces is the deposition of contaminants on the surface of the semiconductor device. Any cleaning solutions that deposit even a few molecules of an undesirable composition, such as carbon, will adversely affect the performance of the semiconductor device. Cleaning solutions that require a rinsing step can also result in depositing contaminants on the semiconductor surface. Thus, it is desirable to use a cleaning chemistry that will leave little or no residue on the semiconductor surface.

It may also be desirable to have a surface wetting agent present in the cleaning solution. Surface wetting agents prevent contamination of the semiconductor work-piece by helping to stop spotting of the surface caused by droplets clinging to the surface. Spotting (also called watermarks) on the surface can saturate metrology tools that measure light point defects, thus masking defects in the semiconductor work-piece.

More than 100 steps in a standard IC manufacturing process flow involve wafer cleaning or surface preparation, which includes post-resist strip/ash residue removal, native oxide removal, and even selective etching. Although dry processes continue to evolve and offer unique advantages for some applications, most cleaning/surface prep processes are “wet,” involving the use of a mixture of chemicals such as hydrofluoric; hydrochloric, sulfuric or phosphoric acid; or hydrogen peroxide, along with copious amounts of de-ionized water for dilution and rinsing.

It is no longer valid that FEOL cleaning involves only silicon or silicon oxide. There are many new metals that will be employed for the metal gate in the FEOL, such as tantalum, tungsten, titanium, molybdenum or hafnium etc. Integrating these new materials requires new clean solutions for advanced gate stacks with high-k and metal gates. Post-etch cleaning strategies for high-k and metal gate materials are required to implement the cleaning process into the design of transistor flow to prevent corrosion of metal gate/new materials and eliminate cross contaminations.

An important distinction in wafer cleaning today is that the main goal is not only particle removal, but other functions, such as removing native silicon oxide, metal oxide and ionic contamination or photoresist residue removal after strip/ash and to ensure that there are substantially no foreign contaminants remaining when the process is completed. This must be done with very high selectivity to minimize material loss of exposed adjacent films. Effective management of damage and defects is critical.

Ion implantation through resist-coated wafers is employed to control the doping levels in integrated circuit fabrication. The number of photoresist cleaning or stripping steps employed in the front end of the line (FEOL) semiconductor manufacturing process has grown greatly in the last few years. The increasing number of ion implantation steps needed in the device manufacturing process has driven this increase. Current high-current or high-energy implant operations (high dose implantation or HDI) are the most demanding in that they require a high degree of wafer cleanliness to be obtained while minimizing or eliminating photoresist popping, surface residues, and metal contamination, while requiring substantially no substrate/junction loss, or oxide loss.

Therefore, following the ion implantation step(s), the resist and unwanted residues should be completely removed, leaving the wafer surface residue-free. Otherwise, ineffective residue removal has the potential for high levels of process defects, and the quality of the cleaning step can directly impact electrical yield. Dry ashing followed by wet chemistry washing, e.g., oxygen plasma and a piranha wet-clean application, a mixture of sulfuric acid with either hydrogen peroxide or ozone, has generally been used to remove the hardened resist and residues. This process is costly and hazardous and also does not effectively remove inorganic residues such as implant species, silicon, silicon dioxide and resist additives. Additionally, further wet chemistries are then required to remove these inorganic residues. Moreover, such dry ashing followed by those wet chemistry cleans causes unwanted damage to the doped wafers, i.e., to the source and drain areas of the doped wafer. Accordingly, there is a need for FEOL cleaning compositions that can effectively and efficiently strip-clean photoresist and ion implantation residues from ion implanted wafers, and for such strip-cleaning compositions that do not cause corrosion, i.e., alteration of the wafer structure in regard to the source and drain areas of the doped wafer.

Wafers are typically processed in a batch immersion or batch spray system or, increasingly, with a single-wafer approach. The trend is toward more dilute chemistries, aided by the use of some form of mechanical energy, such as megasonics or jet-spray processing.

Batch wet etching and wet cleaning of silicon wafers is usually accomplished by immersing silicon wafers into a liquid. This is also sometimes accomplished by spraying a liquid onto a batch of wafers. Wafer cleaning and etching is traditionally conducted in a batch mode where several wafers (e.g. 50-100 wafers) are processed simultaneously.

Several semiconductor manufacturing companies have adopted this approach for large diameter silicon wafer. These cleaning processing tools (also known as “processor”) are available from companies, such as Semitool (The Raider HT single-wafer cleaning system), and Applied Materials. Since these tools process one wafer at a time, there is a need for shorter cycle times in chip manufacturing to increase wafer throughput to compete with the batch system, which usually processes 50-100 wafers simultaneously. There is a need for a cleaning chemistry for cleaning process. In order to make a cleaning process economical, the processing time per wafer should be on the order of two minutes.

Other problems are related to the fact that some of the dielectric materials are easily attacked by wet chemicals (e.g., hafnium silicates, tantalum-based dielectrics, etc.), and there is also the possibility of galvanic corrosion of the gate electrode if different materials, such as polysilicon are in contact on top of the metal. In addition, factors such as capillary force and force induced by fluid flow, implosion of bubbles and so forth are sufficient to impart energy to cause deformation of gate structures. This issue becomes more critical for 22 nm generation devices and advanced 3-D transistor structures such as finFET. A new chemical approach is needed to make cleaning processes aggressive enough to be effective, yet still highly selective and damage free to the gate structures.

Typical cleaning chemistries for the FEOL are mixtures of hydrogen peroxide with ammonium hydroxide, and/or hydrochloric acid, and/or sulfuric acid, and/or hydrofluoric acid with a surfactant. These solutions are commonly referred to as SC1, SC2, HPM, APM and IMEC cleaning solutions. The cleaning sequence using these kinds of mixtures is also referred as a “RCA clean” (developed at Radio Corporation of America in the 1960's), “IMEC clean” (a clean and wet cleaning sequence developed at the Inter-University Microelectronics Center in Leuven, Belgium in the 1990's) and “Ohmi Clean” (developed by Professor T. Ohmi)

The RCA clean

In 1970, the “first systematically developed wafer cleaning process for the bare oxidized Si” was published by Werner Kern of RCA. The clean that Kern disclosed had been used at RCA since 1965 and went on to become known as the “RCA clean”—the most widely used clean in the industry.

The RCA clean is a FEOL clean. The original RCA clean sequence is as follows:
Standard Clean 1 (SC1)—5 volumes H₂O, 1 volume hydrogen peroxide (H₂O₂) 30%, 1 volume ammonium hydroxide (NH₄OH) 29%, at 70-80° C.;
Ultrapure water rinse and dry;
Standard Clean 2 (SC 2)—6 volumes of H₂O, 1 volume hydrogen peroxide (H₂O₂) 30%, 1 volume hydrochloric acid 37%, at 70° C.; and
Ultrapure water rinse and dry

The SC1 clean removes organic residues and particles. The SC1 clean works by forming and dissolving hydrous oxide films. The SC2 clean removes alkali metals and hydroxides (e.g., Li, Al, Ti, Zn, Cr, Fe, Ag, Pd, Au, S, Cu Ni, Co Pd, Mg, Nb, Te, W, Na, Fe) and leaves Cl residues.

The implementation of the RCA clean is important. H₂O₂ is commonly provided with stabilizers such as sodium phosphate, sodium stannate and many that may contain high levels of aluminum. In order to prevent recontamination of wafers, high purity semiconductor grade chemicals with un-stabilized H₂O₂ must be used. H₂O₂ also has a limited bath life and decomposes over time. Solution change-outs must be designed to insure proper cleaning activity. Insufficient H₂O₂ levels in SC1 baths can lead to surface pitting and insufficient H₂O₂ levels in SPM baths lead to carbon build-up in the bath and poor removal of organic contaminants.

IMEC clean

IMEC (Interuniversity Microelectronics Center) has done a great deal of research into cleaning technologies. One of the major findings of the IMEC work is that dilute versions of SC1 and SC2 are still effective cleans. Dilute chemistries have the potential to result in significant reductions in chemical consumption and thus lower costs and environmental impact. IMEC has developed a roadmap of cleaning process technology. The IMEC roadmap is as follows:
RCA clean—The IMEC wafer cleaning roadmap begins with the standard RCA clean.
Dilute clean—The dilute clean replaces hydrogen peroxide with ozone in the sulfuric acid bath. Sulfuric acid breaks down organic layers effectively, but over time carbon from organic layers builds up in the sulfuric acid bath. Hydrogen peroxide is added to sulfuric acid to oxidize the carbon into carbon dioxide or carbon monoxide gases which volatilize out of the bath. The dilute clean replaces hydrogen peroxide with ozone gas as the oxidizer in sulfuric acid baths, the use of ozone extends the bath life by 3× over hydrogen peroxide. The dilute clean also replaces SC1—ammonium hydroxide/hydrogen peroxide/water (1:1:5) and the SC2 hydrochloric acid/hydrogen peroxide/water (1:1:6) bath with more dilute versions of the similar chemistries (1:1:50 for SC1 and 1:1:60 to 1:1:100 for SC2). The final dry after the dilute clean uses a Marangoni technique which employs surface tension gradients in a thin aqueous film to induce a film of water to flow off of the wafer surface.
Reduced Clean (IMEC)—The reduced clean combines the HF oxide removal step with the HC1 metal removal in a single step. An optional rinse in ultrapure water with added ozone can be used to grow a thin protective chemical oxide on the clean surface.
Reduce Clean (IMEC Ozone)—The reduced clean IMEC Ozone replaces the sulfuric acid bath with an ozone-ultrapure water bath for organic removal. Utilizing ozone-ultrapure water allows the wafer to proceed directly from organic removal to the HF-HC1 bath.
Next generation cleans—Next generation cleans are projected to evolve to single tank and then single wafer cleaning and finally to dry/wet hybrid cleans.

Ohmi Cleans

The Ohmi clean is another simplified clean methodology incorporating ozone and adding hydrogen peroxide to hydrofluoric acid to improve metallic removal.

The basic steps to the Ohmi clean are as follows:
Water and ozone mixture is used for organic removal (2 ppm ozone).
Hydrofluoric acid and water (1:100) is used to remove the thin oxide grown in the ozonated water and to removal metals
A dilute ammonium hydroxide/hydrogen peroxide/water (0.05:1:5) mixture is used for organic, particles and metal removal.
A hydrofluoric acid/hydrogen peroxide/water (1:35:65) mixture is used to remove the oxide grown in the dilute ammonium hydroxide/hydrogen peroxide/water (0.05:1:5) mixture and to remove metals. The use of hydrofluoric acid as the last step—the so called HF last method requires very careful rinsing to minimize particles.

Ohmi has also observed that while ammonium hydroxide/hydrogen peroxide/water solutions are effective at removing particles from silicon and silicon oxide surfaces, the same solution tends to deposit particles onto silicon nitride surfaces. Ohmi has proposed the addition of anionic surfactants to the mixtures to prevent particle deposition on silicon nitride.

A typical cleaning sequence consists of HF-SC1-SC2. HF (hydrofluoric acid) is a dilute HF solution used for etching thin layers of oxide. This is typically followed by the Standard Clean 1 (SC1 solution) that consists of a mixture of NH₄OH, H₂O₂, and H₂O. Sometimes the SC1 solution is also called the APM solution, which stands for Ammonia Hydrogen Peroxide Mixture. The SC1 solution is mainly used for removing particles and residual organic contamination. The SC1 solution, however, leaves metallic contaminants behind.

The final solution is the Standard Clean 2 solution (SC2) that is a mixture of HCl, H₂O₂, and H₂O. Sometimes the SC2 solution is also called the HPM solution, which stands for Hydrochloric Acid Hydrogen Peroxide Mixture. The SC2 solution is mainly used for removing metallic contamination. The particular sequence of SC1 and SC2 is most often referred to as the RCA (Radio Corporation of America) cleaning sequence. Between the HF, SC1, and SC2 solutions there is usually a DI (deionized) water rinse. There is usually a DI water rinse after the SC2 solution.

During the modified SC1 clean, the surface of the wafer is covered with a silicon dioxide film terminated by hydroxide groups (Si—OH) as shown in the following diagram:

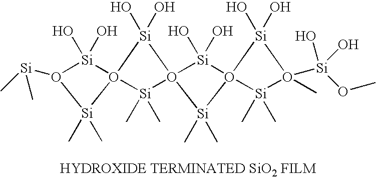

Metals are bound to this surface as (Si—O^{y}M^{(x-y)+} as shown in the following diagram:

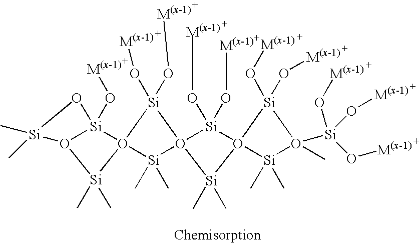

The equilibrium reaction governing the binding (chemisorption) and unbinding (desorption) is described by the following equation:

M²++y(Si—OH)→(Si—O)_{y}M^{(x-y)+}+yH³⁰

From this equation, it can be seen that there are two ways to remove metallic ions from the oxide surface. The first way is to increase the acidity [H+] of the solution. This produces a solution where most of the metallic ions that are common in semiconductor processing are soluble provided that there is a suitable oxidizing agent in the solution. Suitable oxidizing agents include O₂, H₂O₂, and O₃. The suitability of these ions is determined by their ability to prevent the reduction of any ions in the solution, such as copper (Cu²⁺) Increasing the acidity and having a suitable oxidizing agent present is the method used by the most common metallic impurity removing solution, i.e., SC2.

The second way of removing metallic ions from the oxide surface is to decrease the free metal ion concentration [M^{x+}] in the solution. The free metal ion concentration of the solution may be decreased by adding a chelating agent to the solution. The same level of metal ion impurity removal found through the use of the SC2 solution may be achieved through the use of a chelating agent in the SC1 solution (the modified SC1 solution) by meeting two requirements. The first requirement is that the complex of the chelating agent and the bound metal ion remains soluble. The second requirement is that the chelating agent binds to all the metal ions removed from the wafer surface.

Complexing agents for metal ions are required for a wide variety of industries. Examples of relevant purposes and uses are: detergents and cleaners, industrial cleaners, electroplating, water treatment and polymerizations, the photographic industry, the textile industry and the papermaking industry, and various applications in pharmaceuticals, in cosmetics, in foodstuffs and in plant feeding.

Chelating agents have been added to the SC1, SC2, APM, HPM etc., for RCA, IMEC and Ohmi cleaning processes as described in U.S. Pat. Nos. 6,927,176; 6,927,176; 5,885,362 and others.

The purpose of the chelating agent is to remove metallic ions from the wafer. Chelating agents are also known as complexing or sequestering agents. These agents have negatively charged ions called ligands that bind with free metal ions and form a combined complex that will remain soluble. The ligands bind to the free metal ions as follows:

M^{x+}+L^{y-}→M^{(x-y)+}L

Common metallic ions that may be present on the wafer are transition metals, such as copper, iron, nickel, aluminum, calcium, magnesium, and zinc. Other metallic ions may also be present.

U.S. Pat. No. 6,927,176 describes the following suitable chelating agents include polyacrylates, carbonates, phosphonates, and gluconates. Specific chelating agents that would be useful as part of the cleaning solution include, but are not limited to, ethylenediaminetetraacetic acid (EDTA), N,N′-bis(2-hydroxyphenyl)ethylenediiminodiacetic acid (HPED), triethylenetetranitrilohexaacetic acid, desferriferrioxamine B (1-Amino-6,17-dihydroxy-7,10,18,21-tetraoxo-27-(N-acetyl hydroxylamino)-6,11,17,22-tetraazaheptaeicosane), N,N′,N″-tris[2-(N-hydroxycarbonyl)ethyl]-1,3,5-benzenetricarboxamide (BAMTPH) and ethylenediaminodiorthohydroxyphenylacetic acid, the structures of which are indicated below:

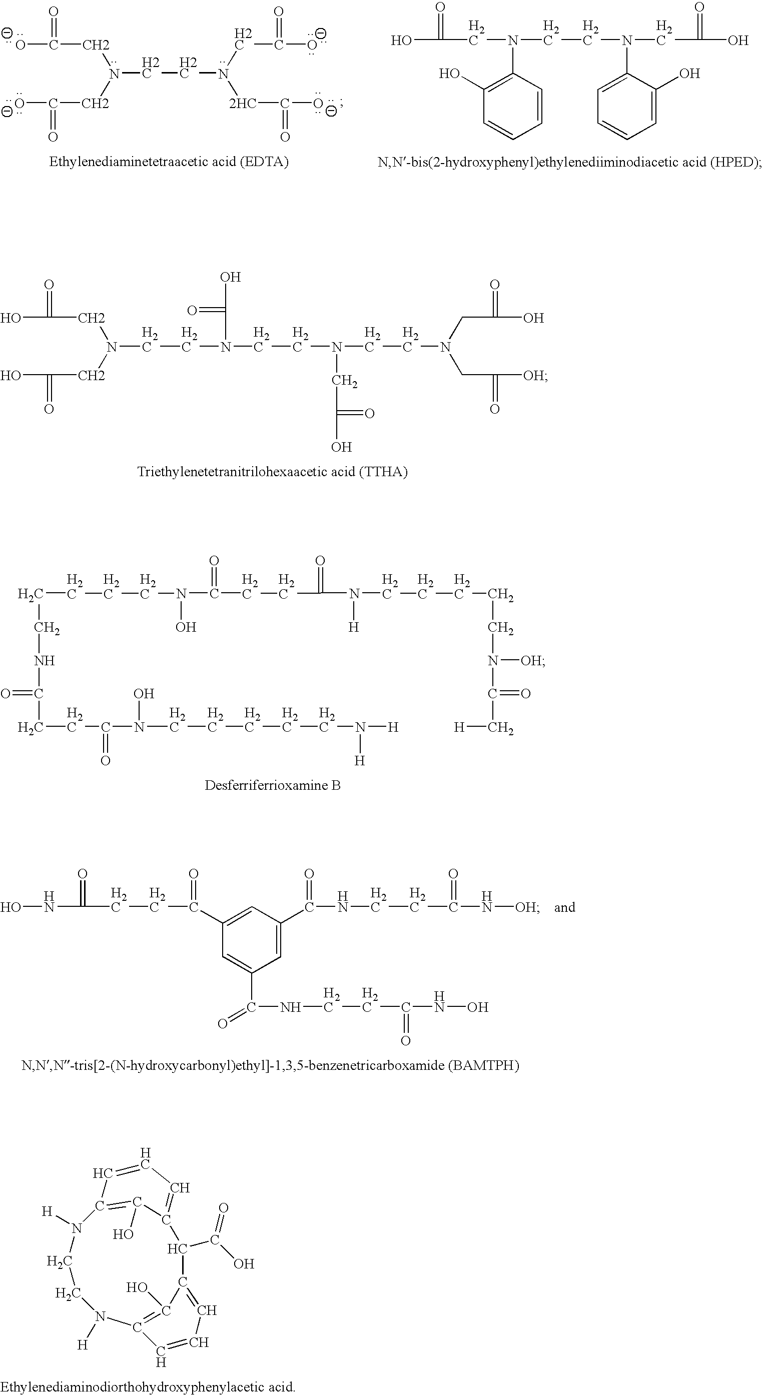

Furthermore, U.S. Pat. No. 5,885,362 describes the following chelating agents: ethylenediaminediorthohydroxyphenylacetic acid, [ethylenediamine-N,N′-bis(orthohydroxyphenylacetic acid)], 2-hydroxy-1-(2-hydroxy-5-methylphenylazo)-4-naphthalenesulfonic acid, diammonium 4,4′-bis(3,4-dihydroxyphenylazo)-2,2′-stilbenedisulfonate, Pyrocatechol Violet, o,o′-dihydroxyazobenzene, 1′2-dihydroxy-5-nitro-1,2′-azonaphthalene-4-sulfonic acid and N,N′-bis(2-hydroxybenzyl)ethylenediamine-N,N′-diacetic acid as a metal deposition preventive in a liquid medium.

Additional examples of complexing agents familiar to the skilled artisan are nitrilotriacetic acid (NTA), ethylenediaminetetraacetic acid (EDTA), ethylenediaminetetramethylenephosphonic acid (EDTMP), propylenediaminetetraacetic acid (PDTA), hydroxypropylenediaminetetraacetic acid (HPDTA), isoserinediacetic acid (ISDA), .beta.-alaninediacetic acid (βADA), hydroxyethanediphosphonic acid, diethylenetriaminetetraacetic acid, diethylenetriaminetetramethylenephosphonic acid, hydroxyethyleneaminodiacetic acid, hydroxyethylethylenediaminetriacetic acid, diethylenetriaminepentaacetic acid and, furthermore, diethanolglycine, ethanolglycine, citric acid, glucoheptonic acid or tartaric acid.

In some cases, the biodegradability of the above mentioned chelating agents are unsatisfactory. For example, EDTA proves to have inadequate biodegradability in conventional tests, as does PDTA or HPDTA, and corresponding aminomethylenephosphonates which, moreover, are often undesirable because of their phosphorus content, phosphorus (P) is one of the dopant for silicon.

Examples of complexing agents include, but are not limited to, nitrilotriacetic acid (NTA), ethylenediaminetetraacetic acid (EDTA), N,N′-bis(2-hydroxyphenyl)ethylenediiminodiacetic acid (HPED), triethylenetetranitrilohexaacetic acid (TTHA), desferriferrioxamin B, N,N′,N″-tris[2-(N-hydroxycarbonyl)ethyl]-1,3,5-benzenetricarboxamide (BAMTPH), and ethylenediaminediorthohydroxyphenylacetic acid (EDDHA), ethylenediaminetetramethylenephosphonic acid (EDTMP), propylenediaminetetraacetic acid (PDTA), hydroxypropylenediaminetetraacetic acid (HPDTA), isoserinediacetic acid (ISDA), β-alaninediacetic acid (β~ADA), hydroxyethanediphosphonic acid, diethylenetriaminetetraacetic acid, diethylenetriaminetetramethylenephosphonic acid, hydroxyethyleneaminodiacetic acid, hydroxyethylethylenediaminetriacetic acid, diethylenetriaminepentaacetic acid, diethanolglycine, ethanolglycine, citric acid, glycolic acid, glyoxylic acid, lactic acid, phosphonic acid, glucoheptonic acid, tartaric acid, polyacrylates, carbonates, phosphonates, and gluconates.

The concern regarding biodegradibility is increased in semiconductor processing applications due to the extent of the use of chemistries containing complexing agents. In fact, more than one hundred steps are involved in a standard IC manufacturing process which involve wafer cleaning or surface preparation including post-resist strip/ash residue removal, native oxide removal, and even selective etching. Although dry processes continue to evolve and offer unique advantages for some applications, most cleaning/surface prep processes are “wet,” sometimes involving the use of other chemicals that may offer environmental challenges, such as hydrofluoric; hydrochloric, sulfuric or phosphoric acid; or hydrogen peroxide. Due, in part to environmental reasons the use of more dilute chemistries has increased, aided by the use of some form of mechanical energy, such as megasonics or jet-spray processing. Accordingly, there is a need for chemistries that can effectively be used in diluted form.

In juxtaposition, cleaning needs and goals have become more demanding. Increasingly, wafers are being processed with a single-wafer approach, as compared to a batch immersion or batch spray system or, increasingly, with a single-wafer approach. This requires faster and effective chemical cleaning. Further, in wafer cleaning applications, particle removal may not be the main goal, but some other goal, such as removing native oxide or photoresist residue removal after strip/ash. Accordingly, there is a need for chemistries that can be used in both single-wafer and batch processing, while addressing a variety of goals in the removal process.

In some cases, the biodegradability is also unsatisfactory. Thus, EDTA proves to have inadequate biodegradability in conventional tests, as does PDTA or HPDTA and corresponding aminomethylenephosphonates which, moreover, are often undesirable because of their phosphorus content. Phosphorus is also a dopant in semiconductor devices. Therefore it is desirable to have cleaning solutions with non-phosphorus containing compounds.

Many formulations being used in cleaning substrates containing metallic-etch residue removal, post-CMP cleaning, and other semiconductor applications, contain complexing agents, sometimes called chelating agents. Much metal-chelating functionality are known which cause a central metal ion to be attached by coordination links to two or more nonmetal atoms (ligands) in the same molecule. Heterocyclic rings are formed with the central (metal) atom as part of each ring. When the complex becomes more soluble in the solution, it functions as a cleaning process. If the complexed product is not soluble in the solution, it becomes a passivating agent by forming an insoluble film on top of the metal surface. The current complexing agents in use, such as, glycolic acid, glyoxylic acid, acetic acid, lactic acid, phosphonic acid, are acidic in nature and have a tendency to attack the residue and remove both metals and metal oxides, such as copper and copper oxide. This presents a problem for formulators where a chelating function is sought but only selectively to metal oxide and not the metal itself, e.g in an application involving metal, such as copper. Accordingly, there is a need for complexing agents that are not aggressive toward metal substrates, while effectively providing for the chelation of metal ions residue created during the manufacturing processes.

The present invention addresses these problems.

### SUMMARY OF THE INVENTION

One embodiment of the present invention involves the use of an aqueous composition comprising an amidoxime compound (i.e., a compound containing one or more amidoxime functional groups) in a semiconductor application wherein the amidoxime compound complexes with metal (or a metal oxide) on a surface, in a residue, or both. Optionally, the composition contains one or more organic solvents. Optionally, the composition contains one or more surfactants. Optionally, the composition contains one or more additional compounds that contain functional groups which complex or chelate with metals or metal oxides. Optionally, the composition contains one or more acids or bases. Optionally, the composition contains a compound which has oxidation and reduction potentials, such as a hydoxylamine or a hydroxylamine derivative, such as a salt, and hydrogen peroxide.

The composition may contain from about 0.1% to about 99.9% water and from about 0.01% to about 99.9% of one or more compounds with one or more amidoxime functional groups.

In an exemplary embodiment, the amidoxime compounds may be used with other chelating compounds or in compounds with other functional groups that provide a complexing or chelating function, such as hydroxamic acid, thiohydroxamic acid, N-hydroxyurea, N-hydroxycarbamate and/or N-nitroso-alkyl-hydroxylamine groups. The amidoxime compounds may be used in semiconductor manufacturing processes; including, but not limited to, use as a complexing agent for removal of residues from semiconductor substrates and for use in CMP slurries.

In an exemplary embodiment, amidoxime compounds can be prepared by the reaction of nitriles (i.e., compounds containing a nitrile functional group) with hydroxylamine, as shown.

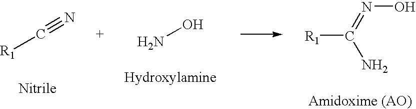

The amidoxime structure may also be represented in its resonance (or tautomeric) form as illustrated below.

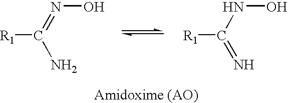

In an exemplary embodiment, the amidoxime compounds are prepared by the reaction of hydroxylamine with nitrile compounds. The nitrile compounds may be prepared by any known methods, including, but not limited to, cyanoethylation. Particular classes of compounds which are suitable to undergo cyanoethylation include, but are not limited to, the following: compounds containing one or more —OH or —SH groups, such as water, alcohols (e.g., phenols), oximes, and thiols (e.g., hydrogen sulphide); compounds containing one or more —NH— or —NH₂ groups (e.g., ammonia, primary and secondary amines, hydrazines, and amides); ketones or aldehydes possessing a —CH—, —CH₂—, or —CH₃ group adjacent to the carbonyl group; and compounds such as malonic esters, malonamide and cyanoacetamide, in which a —CH— or —CH₂— group is situated between —CO₂R, —CN, or —CONH— groups.

Listings of the above exemplary compounds can be found in the relevant tables of the CRC Handbook—Table for Organic Compound Identification, 3^{rd} Ed., published by The Chemical Rubber Company, with such tables being incorporated herein by reference.

Formulations containing amidoximes may optionally include other complexing agents and the amidoxime compounds themselves could contain other functional groups within the molecule that have a chelating functionality.

The compositions of the present application include semiconductor processing compositions comprising water and at least one amidoxime compound. In an exemplary embodiment, the amidoxime compound is prepared from a nitrile compound, either before its contact with the composition (i.e., pre-formed) or alternatively, during contact with the composition (i.e., in-situ formation).

In particular embodiments, the nitrile compound is derived from the cyanoethylation of a compound selected from the group consisting of sugar alcohols, hydroxy acids, sugar acids, monomeric polyols, polyhydric alcohols, glycol ethers, polymeric polyols, polyethylene glycols, polypropylene glycols, amines, amides, imides, amino alcohols, and synthetic polymers containing at least one functional group that is —OH or —NHR, where R is H or alkyl, heteroalkyl, aryl or heteroaryl.

Another exemplary embodiment of the present invention is a process for preparing a semiconductor surface comprising: (a) forming an aqueous mixture of a cyanoethylation catalyst and an alcohol or amine; (b) adding an unsaturated nitrile to the aqueous mixture of the catalyst and alcohol or amine, and allowing the unsaturated nitrile to react with the alcohol or amine to form a first aqueous solution; (c) adding a source of hydroxylamine to the first aqueous solution of step (b) to form a second aqueous solution; and (d) applying the second aqueous solution to a semiconductor surface containing copper. In particular embodiments, the alcohol is sucrose or sorbitol. In exemplary embodiments, the amine is a primary or secondary amine having 1 to 30 carbon atoms, or is a polyethyleneamine In particular embodiments, the source of hydroxylamine is hydroxylamine as the free base or a hydroxylamine salt, such as, for example, hydroxylamine hydrochloride or hydroxylamine sulfate. In exemplary embodiments, the cyanoethylation catalyst is an effective amount (typically catalytic) of a hydroxide base such as, for example, lithium hydroxide, sodium hydroxide, or potassium hydroxide. In a particular embodiment, the unsaturated nitrile is acrylonitrile.

Another exemplary embodiment of the present invention is a method of processing a wafer comprising: placing a wafer in a single wafer or batch cleaning tool and exposing the wafer to an aqueous cleaning solution comprising at least one amidoxime compound, wherein the wafer is exposed to the solution for an appropriate time, such as in the approximate range of 30 seconds to 90 seconds. In exemplary embodiments, the composition comprises water that is introduced as a constituent of the raw materials or components present in the composition. In exemplary embodiments, the amidoxime compound is present in the amount of about 0.001 to about 99 percent by weight. In exemplary embodiments, the cleaning solution optionally comprises an organic solvent in the amount of up to about 99 percent by weight; an acid in the amount of about 0.001 to about 15 percent by weight; an activator in the amount of about 0.001 to about 25 percent by weight; optionally an additional chelating or complexing agent in the amount of between 0 to about 15 percent by weight; and a surfactant in an amount of about 10 ppm to about 5 percent by weight. In exemplary embodiments, the cleaning solution optionally comprises an organic solvent in the amount of up to about 99 percent by weight; a base in the amount of about 1 to about 45 percent by weight; an activator in the amount of about 0.001 to about 25 percent by weight; optionally an additional chelating or complexing agent in the amount of up to about 15 percent by weight; and a surfactant in an amount of about 10 ppm to about 5 percent by weight.

Another exemplary embodiment of the invention is a method of cleaning a wafer comprising: placing a wafer in single wafer cleaning tool; cleaning said wafer with a solution comprising: water, a compound with an amidoxime group; an organic solvent in the amount of up to about 99 percent by weight; a base in the amount of about 1 to about 45 percent by weight; a compound with oxidation and reduction potential in an amount of about 0.001 to about 25 percent by weight; an activator in the amount of about 0.001 to about 25 percent by weight; optionally an additional chelating or complexing agent in the amount of up to about 15 percent by weight; a surfactant in an amount of about 10 ppm to about 5 percent by weight; and a fluoride ion source in an amount of about 0.001 to about 10 percent by weight.

### DESCRIPTION OF FIGURES

FIG. 1 demonstrates the contact angles in semiconductor cleaning on a hydrophilic surface, a hydrophobic surface, and an optimal surface.

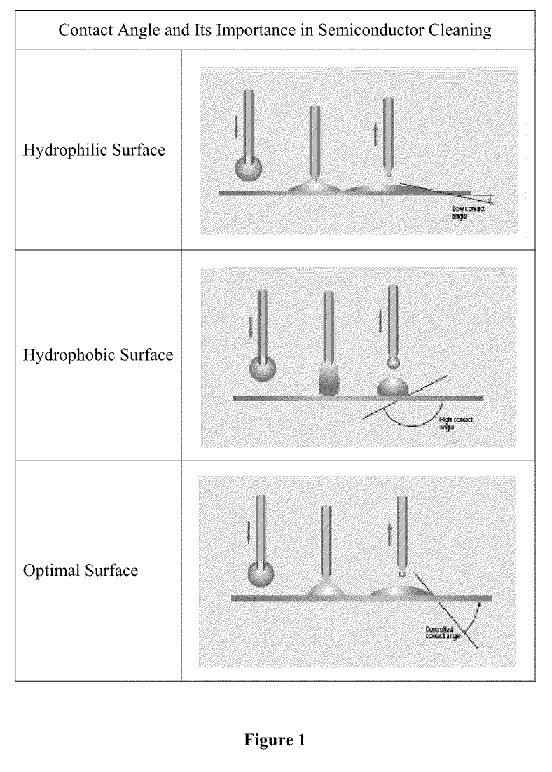

FIG. 2 demonstrates the particle counts on Blackdiamond.

### DETAILED DESCRIPTION

The present invention relates to methods of using compositions containing one or more complexing agents or compounds having one or more multidentate chelating groups where at least one agent or group is an amidoxime at the front end of line (FEOL) to prepare surfaces for semiconductor processing. Such compositions exhibit improved performance in semiconductor applications, for example processes involving metals and metal oxides. In addition to the one or more amidoxime compounds or groups, the compositions preferably contain other chelating agents or compounds having chelating/complexing functional groups. Non-exhaustive examples of such complexing agents include nitrilotriacetic acid (NTA), ethylenediaminetetraacetic acid (EDTA), ethylenediaminetetramethylenephosphonic acid (EDTMP), propylenediaminetetraacetic acid (PDTA), hydroxypropylenediaminetetraacetic acid (HPDTA), isoserinediacetic acid (ISDA), β-alaninediacetic acid (β-ADA), hydroxyethanediphosphonic acid, diethylenetriaminetetraacetic acid, diethylenetriaminetetramethylenephosphonic acid, hydroxyethyleneaminodiacetic acid, hydroxyethylethylenediaminetriacetic acid, diethylenetriaminepentaacetic acid and, furthermore, diethanolglycine, ethanolglycine, citric acid, glycolic acid, glyoxylic acid, acetic acid, lactic acid, phosphonic acid, glucoheptonic acid, catechol, gallic acid, tartaric acid, and groups such as hydroxamic acid, thiohydroxamic acid, N-hydroxyurea, N-hydroxycarbamate and N-nitroso-alkyl-hydroxylamine groups.

Surprisingly, it has been found that the addition of such compounds to residue removal, resist stripping, post-CMP clean, as an additive for CMP slurries, and other semiconductor applications, particularly where it is desired effectively to remove contaminants while having no negative effect on the substrate surfaces.

Without being bound to any particular theory, it is understood that the multidentate complexing agents described above complex with substrate surfaces to remove contaminants on such surfaces. Amidoxime compounds can be designed to function as passivation agents on a metal surface by rendering insoluble the metal complex formed from the amidoxime compound or, alternatively, as cleaning agents by increasing the solubility of the metal complex containing residue.

Amidoxime copper complexes have been shown to be readily soluble in water under basic conditions but are less soluble under acidic conditions. Accordingly, the passivating/cleaning duality effect of the amidoxime compound can be controlled by altering the pH.

U.S. Pat. No. 6,166,254, for example, describes the formation of amidoxime compounds from aqueous hydroxylamine free base and nitriles, such as the reaction of acetonitrile with aqueous hydroxylamine at ambient temperature to yield the amidoxime in high purity.

It will be obvious to those of skill in the art that many other nitriles would react with hydroxylamine free base under similar conditions to provide amidoximes.

Amidoximes have been shown to complex with metals, such as copper, iron, sodium, potassium etc. Amidoximes of cyanoethylated cellulose have also been shown to complex with copper and other metal ions. (See, Altas H. Basta, International Journal of Polymeric Materials, 42, 1-26 (1998)).

According to the present invention the cleaning solution comprises an amidoxime in mixture of metal ion free quaternary ammonium hydroxide, an oxidizer and water.

The following illustrates the principle of metal capture by amidoxime group:

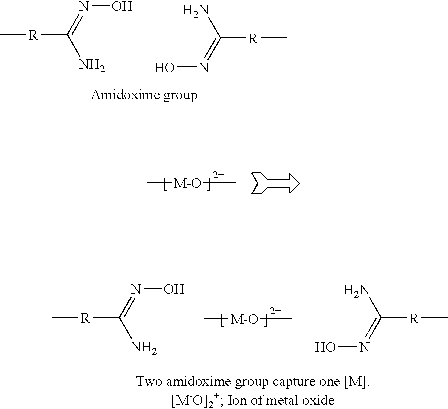

Various nitrile compounds can be prepared from a typical cyanoethylation reaction.

General cyanoethylation reactions such as those described in Section VI, 22 (p. 914-917) in Practical Organic Chemistry, 3^{rd} ed., Longman Group Limited, (1956) are summarized below.

Many inorganic and organic compounds possessing labile hydrogen atoms add acrylonitrile readily with the formation of compounds containing a cyanoethyl grouping (—CH₂—CH₂—CN). This reaction is usually known as cyanoethylation:

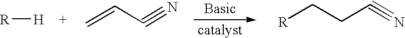

Typical compounds which undergo cyanoethylation include the following:
1. compounds containing one or more —OH or —SH groups, such as water, alcohols, phenols, oximes, hydrogen sulphide and thiols;
2. compounds containing one or more —NH— groups, e.g., ammonia, primary and secondary amines, hydrazines, hydroxylamines and amides;
3. ketones or aldehydes possessing a —CH—, —CH₂—, or —CH₃ group adjacent to the carbonyl group; and
4. compounds such as malonic esters, malonamide and cyanoacetamide, in which a —CH— or —CH₂— group is situated between. —CO₂R, —CN, or —CONH— groups.

In addition, nitrile functional groups can be introduced to organic compounds, such as polyethylene, by using radiation grafting of acrylonitrile to the substrate molecule and subsequently converting the resulting nitrile to an amidoxime by reacting the nitrile with hydroxylamine as exemplified below.

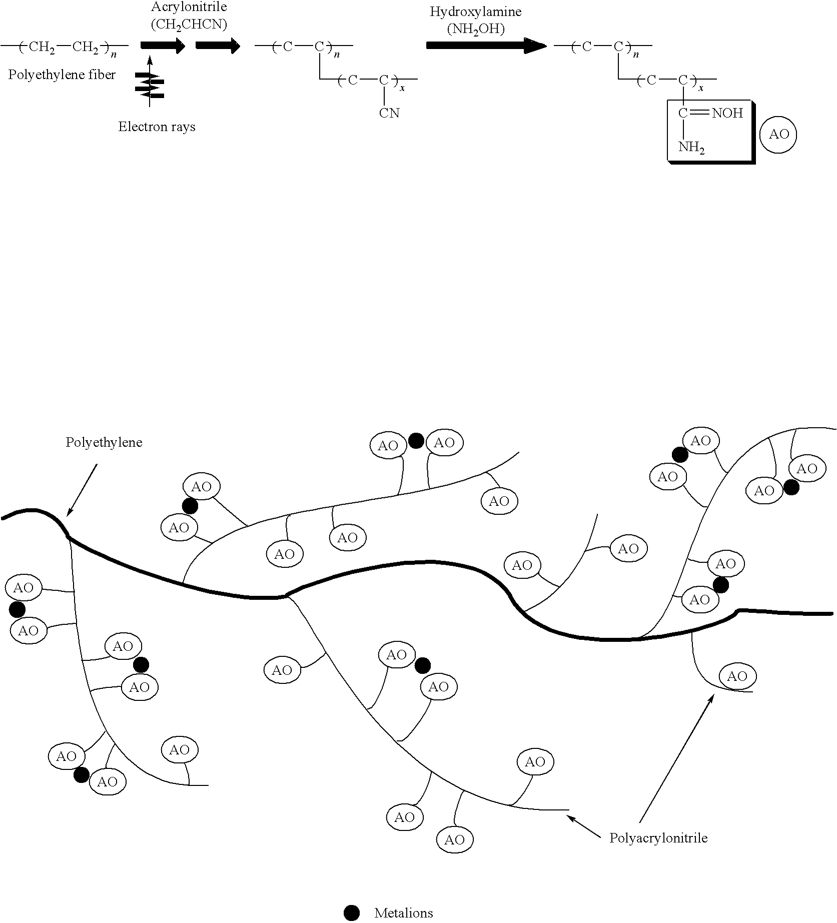

The cyanoethylation reaction, except with certain amines, usually requires the presence of an alkaline catalyst (0.5 to 5 percent of the weight of acrylonitrile) such as, but not limited to, hydroxides, alkoxides and amides of sodium and potassium and the strongly basic quaternary ammonium hydroxides, particularly, tetramethylammonium hydroxide, benzyltrimethylammonium hydroxide etc., which are very effective because of their solubility in organic solvents. Many of the reactions are vigorously exothermic and require cooling to prevent excessive polymerization of the acrylonitrile. The addition of inert solvents, such as, but not limited to, benzene, dioxan and pyridine, may moderate the reaction. In an exemplary embodiment, the catalyst is dissolved or dispersed in the hydrogen donor, with or without the use of an inert solvent, and acrylonitrile is added gradually while controlling the temperature of the reactions.

Anion exchange resins of the quaternary ammonium hydroxide type (e.g., De-Acidite FF, IRA-400 or Dowex I) are strong bases and in an exemplary embodiment, provide useful catalysts for the cyanoethylation of alcohols and possibly of other active hydrogen compounds.

In the case of SC-1 cleaning, surface treatment is carried out with a composition of (ammonia+hydrogen peroxide+water+amidoxime chelating compound), but when the surface treatment composition is employed for an extended time, the ammonia is evaporated and the metal deposition preventive is gradually decomposed, thereby degrading the metal deposition preventive effect. Therefore, when the evaporated ammonia content is supplied, the supplement may be conducted in an exemplary embodiment with aqueous ammonia containing an amidoxime chelating compound in an amount of from 10⁻⁷ to 15 wt %, such as from 10⁻⁶ to 10 wt %.

The surface treatment composition of the present invention is used for surface treatment operations including cleaning, etching, polishing, film-forming and the like, for substrates such as semiconductor, metal, glass, ceramics, plastic, magnetic material, superconductor and the like, the metal impurity contamination of which becomes troublesome. In an exemplary embodiment, the present invention is applied to cleaning or etching of a semiconductor substrate, the surface of which is demanded to be highly clean. Among the cleaning operations of semiconductor substrates, when the present invention is applied particularly to alkali cleaning with a cleaning solution comprising (ammonia+hydrogen peroxide+water), the problem of said cleaning method, i.e., the problem of metal impurity deposition on a substrate can be solved, and by this cleaning, there can be satisfactorily provided a highly clean substrate surface without being contaminated with particles, organic materials and metals.

The surface treatment composition of the present invention achieves a satisfactory effect of preventing deposition of metal impurities for at the reason that a portion of the stable water-soluble metal complex is effectively formed between metal ions and/or is in combination with two or more added complexing agents.

When the surface treatment composition of the present invention is used as a cleaning solution for cleaning a substrate, a method of bringing the cleaning solution directly into contact with the substrate is employed. Examples of such a cleaning method include dipping type cleaning wherein a substrate is dipped in the cleaning solution in a cleaning tank, spraying type cleaning wherein the cleaning solution is sprayed on a substrate, spinning type cleaning wherein the cleaning solution is dropped on a substrate rotated at a high speed, and the like. In the present invention, among the above-mentioned cleaning methods, a suitable method is employed depending on an object. In an exemplary embodiment, the dipping type cleaning method is used. The cleaning is carried out for a suitable time, such as from 10 seconds to 30 minutes, such as from 30 seconds to 15 minutes. If the cleaning time is too short, the cleaning effect is not satisfactory. Conversely, if the cleaning time is too long, it the throughput becomes poor and the cleaning effect is not improved any further. In an exemplary embodiment, the cleaning is be carried out at normal temperature, while in another embodiment, the cleaning is carried out at a heated temperature to improve the cleaning effect. Also, the cleaning may be carried out in combination with a cleaning method employing a physical force. Examples of the cleaning method employing a physical force include, but are not limited to, ultrasonic cleaning, mechanical brush cleaning, and the like.

An exemplary embodiment of the present invention is compositions, and methods of use thereof, containing at least one of a group of higher pH range chelating compounds comprising at least two functional groups where at least one such group is an amidoxime. The other groups or complexing compounds may be selected as may be beneficial for the application, the chemistry, and/or the conditions. Examples of other complexing groups include, but are not limited to, hydroxamic acid, thiohydroxamic acid, N-hydroxyurea, N-hydroxycarbamate, and N-nitroso-alkyl-hydroxylamine These groups offer synergistic advantages when used with amidoximes for the removal of metal oxides, such as tungsten, molydeum oxide etc., where metals are being used as metal gate electrodes in the front end of the line fabrication. Solutions of the amidoxime compounds form complexes with the metal oxide residues and render such oxides soluble in aqueous solutions.

Regarding other complexing agents that may optionally be used with the amidoxime compounds in the compositions of the present invention, these complexing agents may be purchased commercially or prepared by known methods. A representative list has been previously presented.

One example of a synergistic functional group is a hydroxamic acid group. Such groups are well known (H. L. Yale, “The Hydroxamic Acids”, Chem. Rev., 209-256 (1943)). Polymers containing hydroxamic acid groups are known and can be prepared by addition of hydroxylamine to anhydride groups of anhydride-containing copolymers, such as styrene-maleic anhydride copolymer or poly(vinylmethylether/maleic anhydride) copolymers, or by reaction of hydroxylamine with ester groups. Hydroxamic acid-containing polymers can also be prepared by acid-catalyzed hydrolysis of polymers that contain amidoxime groups (U.S. Pat. No. 3,345,344).

U.S. Pat. No. 6,259,353, for example, discusses the formation of high purity oximes from aqueous hydroxylamine and ketones reacted at ambient temperature without addition of impurities such as salts or acids.

Thiohydroxamic acids represent another synergistic type of functional group with amidoximes and may be prepared by addition of hydroxylamine to dithiocarboxylic acids (H. L. Yale, Chem. Rev., 33, 209-256 (1943)).

N-hydroxyureas represent another synergistic type of functional group with amidoximes and may be prepared by reaction of hydroxylamine with an isocyanate (A. O. Ilvespaa et al., Chimia (Switz.) 18, 1-16 (1964)).

N-Hydroxycarbamates represent another synergistic type of functional group with amidoximes and may be prepared by reaction of hydroxylamine with either a linear or cyclic carbonate (A. O. Ilvespaa et al., Chimia (Switz.) 18, 1-16 (1964)).

N-Nitroso-alkyl-hydroxylamines represent another synergistic type of functional groups with amidoximes and can be prepared by nitrosation of alkyl hydroxylamines (M. Shiino et al., Bioorganic and Medicinal Chemistry 95, 1233-1240 (2001)).

An exemplary embodiment of the present invention involves a cleaning solution which comprises a chelating compound with one or more amidoxime functional group.

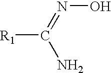

The amidoximes can be prepared by the reaction of nitrile-containing compounds with hydroxylamine

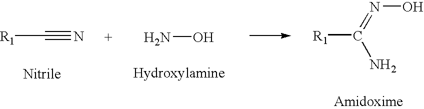

An exemplary route to the formation of amidoxime chelating compounds is to add hydroxylamine to the nitrile compound corresponding to the amidoxime compound. There are several methods known for preparing nitrile-containing compounds, including cyanide addition reactions such as, but not limited to, hydrocyanation, polymerization of nitrile-containing monomers to form polyacrylonitrile or copolymers of acrylonitrile with vinyl monomers, and dehydration of amides. Exemplary procedures for the syntheses of nitriles may be found in J. March, Advanced Organic Chemistry, 4th ed., John Wiley and Sons, NY, (1992).

Nitrile compounds listed in the CRC Handbook (see, e.g., pages 344-368) suitable for use in preparing the amidoxime compounds of this invention include, but are not limited to, the following: Cyanoacetylene, Cyanoacetaldehyde, Acrylonitrile, Fluoroacetonitrile, Acetonitrile (or Cyanomethane), Trichloroacetonitrile, Methacrylonitrile (or α-Methylacrylonitrile), Propionitrile (or Cyanoethane), Isobutyronitrile, Trimethylacetonitrile (or tert-Butylcyanide), 2-Ethyacrylonitrile, Dichloroacetonitrile, α-Chloroisobutyronitrile, n-Butyronitrile (or 1-Cyanopropane), trans-Crotononitrile, Allycyanide, Methoxyacetonitrile, 2-Hydroxyisobutyronitrile (or Acetone cyanohydrins), 3-Hydroxy-4-methoxybenzonitrile, 2-Methylbutyronitrile, Chloroacetonitrile, Isovaleronitrile, 2,4-Pentadienonitrile, 2-Chlorocrotononitrile, Ethoxyacetonitrile, 2-Methycrotononitrile, 2-Bromoisobutyronitrile, 4-Pentenonitrile, Thiophene-2,3-dicarbonitrile (or 2,3-Dicyanothiophene), 3,3-Dimethylacrylonitrile, Valeronitrile (or 1-Cyanobutane), 2-Chlorobutyronitrile, Diethylacetonitrile, 2-Furanecarbonitrile (or α-Furonitrile or 2-Cyanofuran), 2-Methylacetoacetonitrile, Cyclobutanecarbonitrile (or Cyanocyclobutane), 2-Chloro-3-methybutyronitrile, Isocapronitrile (or 4-Methylpentanonitrile), 2,2-Dimethylacetoacetonitrile, 2-Methylhexanonitrile, 3-Methoxypropionitrile, n-Capronitrile (n-Hexanonitrile), (Ethylamino)acetonitrile (or N-Ethylglycinonitrile), d,l-3-Methylhexanonitrile, Chlorofumaronitrile, 2-Acetoxypropionitrile (or O-Acetyllactonitrile), 3-Ethoxypropionitrile, 3-Chlorobutyronitrile, 3-Chloropropionitrile, Indole-3-carbonitrile (or 3-Cyanoindole), 5-Methylhexanonitrile, Thiophene-3-carbonitrile (or 3-Cyanothiophene), d,l-4-Methylhexanonitrile, d,l-Lactonitrile (or Acetaldehydecyanohydrin), Glycolnitrile (or Formaldehydecyanohydrin), Heptanonitrile, 4-Cyanoheptane, Benzonitrile, Thiophene-2-carbonitrile (or 2-Cyanothiophene), 2-Octynonitrile, 4-Chlorobutyronitrile, Methyl cyanoacetate, Dibenzylacetonitrile, 2-Tolunitrile (or 2-Methoxybenzonitrile), 2,3,3-Trimethyl-1-cyclopentene-1-carbonitrile (or -Campholytonitrile), Caprylonitrile (or Octanonitrile), 1,1-Dicyanopropane (or Ethylmalononitrile), Ethyl cyanoacetate, 1,1-Dicyanobutane (or Propylmalononitrile), 3-Tolunitrile (or 3-Methylbenzonitrile), Cyclohexylacetonitrile, 4,4-Dicyano-1-butene (or Allylmalononitrile), 3-Isopropylidene-1-methyl-cyclopentane-1-carbonitrile (or 3-Fencholenonitrile), 3-Hydroxypropionitrile, 1,1-Dicyano-3-methylbutane (or Isobutylmalononitrile), Nonanonitrile, 2-Phenylcrotononitrile, Ethylenecyanohydrin, 2-Phenylpropionitrile, Phenylacetonitrile (or Benzylcyanide), Phenoxyacetonitrile, 4-Hydroxy-butyronitrile, (3-Tolyl)acetonitrile (or m-Xylycyanide), (4-Tolyl)acetonitrile (or p-Xylycyanide), 4-Isopropylbenzonitrile, (2-Tolyl)acetonitrile (or o-Xylycyanide), Decanonitrile, 3-Methyl-2-phenylbutyronitrile, 1,2-Dicyanopropane, 1-Undecanonitrile (or 1-Hendecanonitrile), 2-Phenylvaleronitrile, 10-Undecenonitrile (or 10-Hendecenonitrile), 3-Phenylpropionitrile, 2-Cyanobenzalchloride (or α,α-Dichloro-o-tolunitrile), N-Methylanilinonitrile (or N-Cyano-N-methylaniline), 3-(2-Chlorophenyl)propionitrile, 1,3-Dicyano-2-methypropane (or 2-Methylglutaronitrile), O-Benzoyl lactonitrile (or Lactonitrile benzoate), 3-Cyanobenzalchloride (or α,α-Dichloro-m-tolunitrile), 4-Cyanobenzalchloride (or α,α-Dichloro-p-tolunitrile), Dodecanonitrile (or Lauronitrile), 1,3-Dicyanopropane (or Glutaronitrile), 4-Methoxyhydrocinnamonitrile (or 3-(4-Methoxyphenyl)-propionitrile), 1,4-Dicyanobutane (Adiponitrile), 1,2,2,3-Tetramethyl-3-cyclopentene-1-acetonitrile (or 5-Methyl-α-campholenonitrile), 1-Cyanocyclohexene, 2-Hydroxybutyronitrile (or Propanalcyanohydrin), Hydnocarponitrile, α-Chloro-α-phenylacetonitrile, Butyl cyanoacetate, 3-Bromopropionitrile, 2,4-Diphenylbutyronitrile, Thiophene-2-acetonitrile, Trans-4-Chlrocrotononitrile, 2-Cyanopentanoic acid, Azelaonitrile (or 1,7-Dicyanoheptane), 3-Chloro-2-hydroxy-2-methylpropionitrile (or Chloroacetone cyanohydrins), 1,11-Dicyanoundecane (or 1,11-Dicyanohendecane), 2-Cyanobutyric acid, 2-Cyanobiphenyl, 1,12-Dicyanodedecane (or α,ω-Dodecane dicyanide), 1-Cyano-4-isopropenylcyclohexene, Sebaconitrile (or 1,8-Dicyanooctane), Suberonitrile (or 1,6-Dicyanohexane), 3-Cyanoindene (or Indene-3-carbonitrile), Aminoacetonitrile (or Glycinonitrile), 2-Cyanodiphenylmethane, N-Piperdinoacetonitrile, 3-Chloro-2-tolunitrile, Tetradecanonitrile, Cinnamonitrile, Trichloroacrylonitrile, DL-Mandelonitrile (or Benzaldehyde cyanohydrins), Pentadecanonitrile, 2-Methoxybenzonitrile, (2-Chlorophenyl) acetonitrile (or 2-Chlorobenzylcyanide), 1,1-Dicyanoethane (or Methylmalononitrile), 2-Cyanopyridine (or 2-Pyridinecarbonitrile; Picolinonitrile), 4-tolunitrile (or 4-Methylbenzonitrile), D-Mandelonitrile, d,l-(2-Bromophenyl) acetonitrile (or 2-Bromobenzyl cyanide), (4-Chlorophenyl) acetonitrile (or 4-Chlorobenzyl cyanide), Malononitrile (or Methylene cyanide), Hexadecanonitrile, Maleonitrile (or cis-1,2-Dicyanoethylene), 2,2-Dicyanopropane (or Dimethylmalononitrile), tert-Butylacetonitrile (or Neopentyl cyanide), 1-Naphthylacetonitrile, 4,4-Dicyanoheptane (or Dipropylmalononitrile), Heptadecanonitrile, 1-Naphthonitrile (or 1-Cyanonapthalene), 2-Cyanopropionic acid, 4-Fluorobenzonitrile, Coumarilonitrile (or Coumarin-2-carbonitrile), Indole-3-acetonitrile, 3-Bromobenzonitrile, 2-(N-Anilino)-butyronitrile, Trans-o-Chlorocinnamonitrile, Octadecanonitrile, 3-Chlorobenzonitrile, 2-Chlorobenzonitrile, 4-Chloromandelonitrile, Nonadecanonitrile, 2-Bromo-4-tolunitrile, 3,3-Dicyanopentane (or Diethylmalononitrile), 4-Cyanobutyric acid, 5-Chloro-2-tolunitrile, (4-Aminophenyl)acetonitrile (or 4-Aminobenzyl cyanide), meso-2,3-Dimethyl-succinonitrile, 3-Bromo-4-tolunitrile, (4-Bromophenyl)acetonitrile (or 4-Bromobenzyl cyanide), N-Anilinoacetonitrile, 3-Cyanopropionic acid, 3-Chloro-4-tolunitrile, 3,3-Diphenylacrylonitrile (β-Phenylcinnamonitrile), 3-Bromo-2-hydroxy benzonitrile, 4,4-Dicyanoheptane (or Dipropylmalononitrile), trans-2,3-Diphenyl acrylonitrile, Eicosanonitrile, 3-Cyanopyridine (or Nicotinonitrile), (4-Iodophenyl)acetonitrile (or 4-Iodobenzyl cyanide), 4-Cyanodiphenyl methane, 2-(N-Anilino)valeronitrile, 2-Aminobenzonitrile (or Anthranilonitrile), 2-Bromobenzonitrile, 5-Cyanothiazole, 3-Aminobenzonitrile, 2-Quinolinoacetonitrile, 2-Iodobenzonitrile, 2,4,6-Trimethylbenzonitrile, α-Aminobenzyl cyanide, Cyanoform (or Tricyanomethane), Succinonitrile, 2-Iodo-4-tolunitrile (2-Iodo-4-methylbenzonitrile), 2,6-Dinitrobenzonitril, d,l-2,3-Dimethylsuccinonitrile, 2-Chloro-4-tolunitrile, 4-Methoxybenzonitrile, 2,4-Dichlorobenzonitrile, 4-Methoxycinnamonitrile, 3,5-Dichlorobenzonitrile, cis-1,4-Dicyanocyclohexane, Bromomalononitrile, 2-Naphthonitrile (or 2-Cyanonaphthalene), Cyanoacetic acid, 2-Cyano-2-ethylbutyric acid (or Diethylcyanoacetic acid), 2,4-Diphenylglutaronitrile, α-Chloro-3-tolunitrile, 4-Chloro-2-tolunitrile, 1-Cyanoacenaphthene (or Acenaphthene-1-carbonitrile), Phenylmalononitrile (α-Cyanobenzyl cyanide), 6-Nitro-2-tolunitrile, (4-Hydroxyphenyl)acetonitrile (or 4-Hydroxybenzyl cyanide), bromo-tolunitriles such as 5-Bromo-2-tolunitrile, 2,2-Diphenylglutaronitrile, (2-Aminophenyl) acetonitrile (or 2-Aminobenzyl cyanide), 3,4-Dichlorobenzonitrile, 1,2,2,3-Tetramethylcyclopentene-1-carbonitrile (or Campholic nitrile), Dicyanodimethylamine (or Bis(cyanomethyl) amine), Diphenylacetonitrile (α-Phenylbenzyl cyanide), 4-Cyano-N,N-dimethylaniline, 1-Cyanoisoquinoline, 4-Cyanopyridine, α-Chloro-4-tolunitrile (or 4-Cyanobenzyl chloride), 2,5-Diphenylvaleronitrile, 3-Cyanobenzaldehyde (or 3-Formylbenzonitrile), 6-Nitro-3-tolunitrile, Benzoylacetonitrile, 6-Chloro-2-tolunitrile, 8-Cyanoquinoline, 2-Nitro-3-tolunitrile, 2,3,4,5-Tetrachlorobenzonitrile, 4-Cyanobiphenyl, 2-Naphthylacetonitrile, cis-2,3-Diphenylacrylonitrile, 4-Aminobenzonitrile (or 4-Cyanoaniline), 1-Cyano-2-phenylacrylonitrile (or Benzalmalononitrile), 5-Bromo-2,4-dimethyl-benzonitrile, 2-Cyanotripbenylmethane, 5-Cyanoquinoline, 2,6-Dimethylbenzonitrile, Phenylcyanoacetic acid, 2-(N-Anilino)-propionitrile, 2,4-Dibromobenzonitrile, β-(2-Nitrophenyl)-acrylonitrile, 5-Chloro-2-nitro-4-tolunitrile, α-Bromo-3-tolunitrile (or 3-Cyanobenzyl bromide), 4-Nitro-3-tolunitrile, 2-(N-Anilino)-isobutyronitrile, 2-Cyanoquinoline, 4-Cyanovaleric acid (or 2-Methylglutaromononitrile), Fumaronitrile, 4-Chlorobeuzonitrile, 9-Phenanthrylacetonitrile, 3,5-Dibromobenzonitrile, 2-Chloro-3-nitrobenzonitrile, 2-Hydroxybenzonitrile (or 2-Cyanophenol), 4-Chloro-2-nitrobenzonitrile, 4-Cyanotriphenylmethane, 4-Chloro-3-nitrobenzonitrile, 3-Nitro-4-tolunitrile, 2-Cyano-3-phenylpropionic acid, 3-Cyanophenanthrene, 2,3,3-Triphenylpropionitrile, 4-Cyanoquinoline, 4-Bromo-1-naphthonitrile (or 1-Bromo-4-cyanonaphthalene), 4-Bromo-2,5-dimethylbenzonitrile, 5-Nitro-3-tolunitrile, 2,4-Dinitrobenzonitrile, 4-Nitro-2-tolunitrile, 6-Chloro-3-nitrobenzonitrile, 5-Bromo-3-nitro-2-tolunitrile, 2-Nitro-4-tolunitrile, 9-Cyanophenanthrene, 3-Cyanoquinoline, 2-Cyanophenanthrene, 3-Nitro-2-tolunitrile, 2-Nitrobenzonitrile, 4-Chloro-1-naphthonitrile (or 1-Chloro-4-cyanonaphthalene), 5-Cyanoacenaphthene (or Acenaphthene-5-carbonitrile), 4-Bromobenzonitrile, 2,4,5-Trimethoxybenzonitrile, 4-Hydroxybenzonitrile (or 4-Cyanophenol), 2,3-Diphenylvaleronitrile, α-Bromo-4-tolunitrile (or 4-Cyanobenzylbromide), (4-Nitropbenyl)acetonitrile (or 4-Nitrobenzylcyanide), 6-Bromo-3-nitrobenzonitrile, (2-Hydroxyphenyl)acetonitrile (or 2-Hydroxybenzyl cyanide), 3-Nitrobenzonitrile, 4-Bromo-3-nitrobenzonitrile, 4-Cyanoazobenzene, Dipicolinonitrile (or 2,6-Dicyanopyridine), 2-Cyanohexanoic acid, Dibromomalononitrile (or Bromodicyanomethane), 1-Cyanoanthracene, 2,2,3-Triphenylpropionitrile, 1-Cyanophenanthrene, 2,3-Diphenylbutyronitrile, 5-Bromo-3nitro-4-tolunitrile, 2,5-Dichlorobenzonitrile, 2,5-Dibromobenzonitrile, 5-Bromo-2-nitro-4-tolunitrile, 2-Hydroxy-3-nitrobenzonitrile (or 2-Cyano-6-nitrophenol), 4-Nitro-1-naphthonitrile (or 1-Cyano-4-nitronaphthalene), 4-Acetamidobenzonitrile, 6-Cyanoquinoline, Apiolonitrile (or 2,5-Dimethoxy-3,4-methylenedioxybenzonitrile), 1-Nitro-2-naphthonitrile (or 2-Cyano-1-nitronaphthalene), 3,5-Dichloro-2-hydroxybenzonitrile, trans-1,4-Dicyanocyclohexane, 3,3,3-Triphenylpropionitrile, 4-Cyano-2-phenylquinoline (or 2-Phenyl-4quinolinonitrile), Phthalonitrile (or o-Dicyanobenzene), 8-Nitro-2-naphthonitrile (or 2-Cyano-8-nitronaphthalene), 5-Chloro-2-naphthonitrile (or 5-Chloro-2cyanonaphthalene), 5-Chloro-1-naphthonitrile (or 5-Chloro-1-cyanonaphthalene), 3,5-Dichloro-4-hydroxybenzonitrile, 4-Nitrobenzonitrile, 5-Bromo-1-naphthonitrile (or 1-Bromo-5cyanonaphthalene), 5-Iodo-2-naphthonitrile (or 2-Cyano-5-iodonaphthalene), 3-Cyano-3-phenylpropionic Acid, 2-Cyano-2-propylvaleramide (or Dipropylcyanoacetamide), 2,6-Dibromobenzonitrile, 3-Chloro-4-hydroxybenzonitrile, 5-Chloro-2,4-dinitrobenzonitrile, 4-Benzamidobenzonitrile (or N-Benzoylanthranilonitrile), 5-Bromo-2-hydroxybenzonitrile, d,l-2,3-Diphenylsuccinonitrile, Isophthalonitrile (or m-Dicyanobenzene), 2-Hydroxy-4-nitrohenzonitrile (or 2-Cyano-5-nitrophenol), d,l-4-Cyano-3,4-diphenylbutyric acid (or d,l-2,3-Diphenylglutaromononitrile), d-3-Carboxy-2,2,3-trimethyicyclopentylacetonitrile, 5-Chloro-2-hydroxyhenzonitrile (or 4-Chloro-2-cyanophenol), 2,3-Diphenylcinnamonitrile (or Cyanotriphenylethylene), 1,7-Dicyanonaphthalene, 4,4′-Dicyanodiphenylmethane, 2,2′-Diphenic acid mononitrile (or 2-Carboxy-2′-cyanobiphenyl), 5-Nitro-2-naphthonitrile (or 2-Cyano-5-nitronaphthalene), 9-Cyanoanthracene (or 9-Anthracenecarbonitrile), 2,3-Dicyanopyridine, 1,3-Dicyanonaphthalene, 3-Cyanocoumarin, 2-Cyanocinnamic acid, 2-Cyanobenzoic acid, 1,2-Dicyanonaphthalene, 2-Hydroxy-5-nitrobenzonitrile (or 2-Cyano-4-nitrophenol), Tetracyanoethylene, 5-Nitro-1-naphthonitrile (or 1-Cyano-5-nitronaphthalene), 1,4-Dicyanonaphthalene, 1,6-Dicyanonaphthalene, 1,5-Dicyanonaphthalene, 3-Cyanobenzoic acid, 4-Cyanobenzoic acid, Terephthalonitrile (or p-Dicyanobenzene), 1,8-Dicyanonaphthalene, 4,4′-Dicyanobiphenyl, 1-2,3-Diphenylsuccinonitrile, 1-Cyano-9,10-anthraquinone, 2,3-Dicyanonaphthalene, 2,7-Dicyanonaphthalene, and 2,6-Dicyanonaphthalene.

The present invention further include the “nitrile quaternaries”, cationic nitriles of the formula

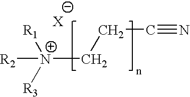

in which R1 is —H, —CH₃, a C₂₋₂₄-alkyl or a C₂₋₂₄-alkenyl radical, a substituted methyl,substituted C₂₋₂₄-alkyl or substituted C₂₋₂₄-alkenyl radical, wherein the substituted radicals contain at least one substituent from the group —Cl, —Br, —OH, —NH₂, —CN, an alkyl-aryl or alkenyl-aryl radical with a C₁₋₂₄-alkyl group, a substituted alkyl-aryl or substituted alkenyl-aryl radical with a C₁₋₂₄-alkyl group, at least one further substituent on the aromatic ring; R2 and R3, independently of one another, are chosen from CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—OH)ₙH where n=1, 2, 3, 4, 5 or 6 and X is an anion.

The general formula covers a large number of cationic nitrites which can be used within the scope of the present invention. With particular advantage, the detergent and cleaner according to the invention comprise cationic nitrites in which R1 is methyl, ethyl, propyl, isopropyl or an n-butyl, n-hexyl, n-octyl, n-decyl, n-dodecyl, n-tetradecyl, n-hexadecyl or n-octadecyl radical. R2 and R3 are preferably chosen from methyl, ethyl, propyl, isopropyl and hydroxyethyl, where one or both of the radicals may advantageously also be a cyanomethylene radical.

For reasons of easier synthesis, preference is given to compounds in which the radicals R₁ to R₃ are identical, for example (CH₃)₃N⁽⁺⁾CH₂—CN (X⁻), (CH₃CH₂)₃N⁽⁺⁾CH₂—CN X⁻, (CH₃CH₂CH₂)₃N⁽⁺⁾CH₂—CN X⁻, (CH₃CH(CH₃))₃N⁽⁺⁾CH₂—CN X⁻ or (HO—CH₂—CH₂)₃N⁽⁺⁾CH₂—CN X⁻, where X⁻ is preferably an anion which is chosen from the group consisting of hydroxide, chloride, bromide, iodide, hydrogensulfate, methosulfate, p-toluenesulfonate (tosylate) or xylenesulfonate.

Examples of typical acrylonitrile polymeric materials, which serve as precursors for preparing our polyamidoximes, are listed below. The figures are the percents by weight of each monomer in the polymer.

| | | |
|---|---|---|
| 90% acrylonitrile | 10% vinylacetonitrile | |
| 50%′ acrylonitrile | 50% methacrylonitrile | |
| 97% acrylonitrile | 3% vinyl acetate | |
| 50% acrylonitrile | 50% vinyl acetate | |
| 95% acrylonitrile | 5% methyl methacrylate | |
| 65% acrylonitrile | 35% methyl acrylate | |
| 45% acrylonitrile | 10% methyl acrylate | 45% vinyl acetate |
| 44% acrylonitrile | 44% vinyl chloride | 12% methyl acrylate |
| 93% acrylonitrile | 7% 2-vinyl pyridine | |
| 26% acrylonitrile | 74% butadiene | |
| 40%1 acrylonitrile | 60% butadiene | |
| 33% acrylonitrile | 67% styrene | |
| 100% acrylonitrile | | |

Several of the polymers are available commercially, such as:

| Product | Manufacturer | Composition |
|---|---|---|
| Orion | DuPont de Nemours | 90% Acrylonitriles |
| Acrilan | Chemstrand | 90% Acrylonitriles |
| Creslan | American Cyanamid | 95-96% Acrylonitriles |
| Zefran | Dow Chemical Co., | 90% Acrylonitriles |
| Verel | Eastman | About 50% acrylonitrile |
| Dyrel | Carbide & Carbon | 40% acrylonitrile-60% |
| | Chemical | Vinyl chloride |
| Darlan | B. F Goodrich | 50 Mole percent |
| | | vinylidene cyanide-50 |
| | | Mole percent Vinyl |
| | | acetate |

In a particular embodiment, the route used to obtain nitriles is termed “cyanoethylation”, in which acrylonitrile, which is optionally substituted, undergoes a conjugate addition reaction with protic nucleophiles such as alcohols and amines. Other unsaturated nitriles can also be used in place of acrylonitrile.

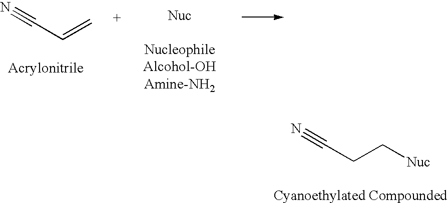

Exemplary amines for the cyanoethylation reaction are primary amines and secondary amines having 1 to 30 carbon atoms, and polyethylene amine. Alcohols may be primary, secondary, or tertiary. The cyanoethylation reaction (or “cyanoalkylation” reaction) using an unsaturated nitrile other than acrylonitrile may be carried out in the presence of a cyanoethylation catalyst. In an exemplary embodiment, the cyanoethylation catalysts include lithium hydroxide; sodium hydroxide; potassium hydroxide; and metal ion free bases from tetraalkylammonium hydroxide, such as tetramethylammonium hydroxide (TMAH), TMAH pentahydrate, BTMAH (benzyltetramethylammonium hydroxide), tetrabutylammonium hydroxide (TBAH), choline, and TEMAH (Tris(2-hydroxyethyl)methylammonium hydroxide). In an exemplary embodiment, the amount of catalyst used is between 0.05 mol % and 15 mol %, based on unsaturated nitrile.

In an exemplary embodiment, the cyanoethylation products are derived from the following groups:

from arabitol, erythritol, glycerol, isomalt, lactitol, maltitol, mannitol, sorbitol, xylitol, sucrose and hydrogenated starch hydrosylate (HSH);

from hydroxy acids: hydroxyphenylacetic acid (mandelic acid), 2-hydroxypropionic acid (lactic acid), glycolic acid, hydroxysuccinic acid (malic acid), 2,3-dihydroxybutanedioic, acid (tartaric acid), 2-hydroxy-1,2,3-propanetricarboxylic, acid (citric acid), ascorbic acid, 2-hydroxybenzoic, acid (salicylic acid), 3,4,5-trihydroxybenzoic acid (gallic acid);

from sugar acids: galactonic acid, mannonic, acid, fructonic acid, arabinonic acid, xylonic acid, ribonic, acid, 2-deoxyribonic acid, and alginic acid;

from amino acids: alanine, valine, leucine, isoleucine, proline, tryptophan, phenylalanine, methionine, glycine, serine, tyrosine, threonine, cysteine, asparagine, glutamine, aspartic acid, glutamic acid, lysine, arginine, and histidine;

from monomeric polyols- or polyhydric alcohols, or glycol ethers, chosen from ethanol, n-propanol, isopropanol, butanols, glycol, propane-or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy, ethoxy or butoxy triglycol, 1-butoxyethoxy-2-propanol, 3-methyl-3-methoxybutanol, propylene glycol t-butyl ether, and pentaerythritol;

from polymeric polyols, chosen from the group of polyethylene glycols and polypropylene glycols, wherein the polyethylene glycols (PEGS) are polymers of ethylene glycol which satisfy the general formula

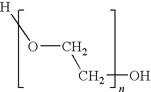

where n can assume values between 1 (ethylene glycol, see below) and about 16. A number of polyethylene glycols are commercially available, for example, under the trade names Carbowax®, PEG 200 (Union Carbide), Emkapol® 200 (ICI Americas), Lipoxol® 200 MED (HOLS America), Polyglycol® E-200 (Dow Chemical), Alkapol® PEG 300 (Rhone-Poulenc), Lutrol® E300 (BASF), and the corresponding trade names with higher numbers. Polypropylene glycols (PPGs) which can be used according to the invention are polymers of propylene glycol which satisfy the general formula

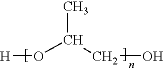

where n can assume values between 1 (propylene glycol) and about 12. In an exemplary embodiment, the polypropylene glycols are di-, tri- and tetrapropylene glycol, i.e., the representatives where n=2, 3 and 4 in the above formula;

from organic nitrogen compounds, wherein these compounds include the classes of amines, amides and imides as described below in greater detail;

amines: structurally, amines resemble the compound ammonia (NH₃), wherein one or more hydrogen atoms are replaced by organic substituents such as alkyl, heteralkyl, aryl and heteroaryl groups. Compounds containing one or more —NH— groups of the formula, wherein R₁, R₂ and R₃ are as described above for the nitrile quaternaries:

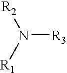

amides: an amide may be regarded as an amine where one of the nitrogen substituents is an acyl group; it is generally represented by the formula: R₁(CO)NR₂R₃, where either or both R₂ and R₃ may be hydrogen and R₁ is as described above for the nitrile quaternaries. Specifically, an amide can also be regarded as a derivative of a carboxylic acid in which the hydroxyl group has been replaced by an amine or ammonia:

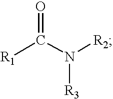

imide: an imide is a functional group consisting of two carbonyl groups bound to an amine In an exemplary embodiment, R₃ is H in the generic structure for the imide shown below and R₂ and R₃ are independently alkyl, heteroalkyl, aryl or heteroaryl:

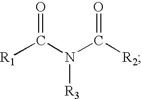

from amino alcohols (or alkanolamines) wherein the amino alcohols are organic compounds that contain both an amine functional group and an alcohol functional group, and where the amine can be a primary or secondary amine of the formula, wherein X is independently selected from alkylene, heteroalkylene, arylene, heteroarylene, alkylene-heteroaryl, or alkylene-aryl group.

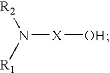

from synthetic polymers, wherein the synthetic polymers include, but are not limited to, acetone-formaldehyde condensate, acetone-isobutyraldehyde condensate, methyl ethyl ketone-formaldehyde condensate, poly(allyl alcohol), poly(crotyl alcohol), poly(3-chloroallyl alcohol), ethylene-carbon monoxide copolymers, polyketone from propylene, ethylene and carbon monoxide, poly(methallyl alcohol, poly(methyl vinyl ketone, and poly(vinyl alcohol).

Synthetic polymers such as acetone-formaldehyde condensate, acetone-isobutyraldehyde condensate, methyl ethyl ketone-formaldehyde condensate, poly(allyl alcohol), poly(crotyl alcohol), poly(3-chloroallyl alcohol), ethylene-carbon monoxide copolymers, polyketone from propylene, ethylene and carbon monoxide, poly(methallyl alcohol, poly(methyl vinyl ketone, and poly(vinyl alcohol) have also been cyanoethylated and can also serve as platforms for further modification into metal-binding polymers.

The nitrile groups of these cyanoethylates or cyanoalkylates can be reacted with hydroxylamine to form the amidoxime. In the process described herein for preparing amidoxime groups, hydroxylamine, hydroxylamine hydrochloride, and hydroxylamine sulfate are suitable sources of hydroxylamine If hydroxylamine salt is used instead of hydroxylamine freebase, a base such as sodium hydroxide, sodium carbonate or metal ion free base such ammonium hydroxide, tetraalkylammonium hydroxide should be used to release hydroxylamine as free base for the reaction.

In a particular embodiment, the metal-ion-free base, is ammonium hydroxide or a group of a tetraalkylammonium hydroxide, such as tetramethylammonium hydroxide (TMAH), TMAH pentahydrate, BTMAH (benzyltetramethylammonium hydroxide), tetrabutylammonium hydroxide (TBAH), choline, or TEMAH (Tris(2-hydroxyethyl)methylammonium hydroxide).

Metals, such as copper and others, complex strongly with molecules containing amidoxime groups, for example amidoximes of sucrose and sorbitol, to bind metal contaminant residues.

The present invention offers the benefit of binding to the metal oxide surface to create an oxidation barrier, particularly where the amidoxime is derived from functionalized amidoxime polymer, such as from polyvinylalcohol, polyacrylonitriles and its copolymers.

The present invention utilizes the cyanoethylated compounds referenced in “The Chemistry of Acrylonitrile”, 2nd ed. as starting materials for synthesis of amidoximes, and this reference is incorporated herein to the extent of the cyanoethylated compounds disclosed therein. In an exemplary embodiment, the starting materials for synthesis of amidoximes are those prepared from cyanoethylated sugar alcohols, such as sucrose, or reduced sugar alcohols, such as sorbitol.

The present invention further offers the benefit of increasing the bulk removal of metal during the CMP process when a chelating agent disclosed herein (e.g., (1,2,3,4,5,6-(hexa-(2-amidoximo)ethoxy)hexane) combined with a compound with oxidation and reduction potentials such as hydroxylamine and its salts, hydrogen peroxide, hydrazines.

Because the chelating agents disclosed herein are not carboxylic acid based but instead contain multiple ligand sites, the present invention further offers the benefit of more efficient and effective binding to metal ions found in semiconductor manufacturing processes, such as residue after plasma etching particularly with leading edge technology where copper is used as conducting metal.

Another advantage of the chelating agents disclosed herein is that such chelating agent could be used in dilution as a Post-copper CMP clean because these groups of compounds are less acidic than organic acid and less basic than ammonia, choline hydroxide and THEMAH. In an exemplary embodiment, the compositions comprising an amidoxime compound are further diluted with water prior to removing residue from a substrate, such as during integrated circuit fabrication. In a particular embodiment, the dilution factor is from about 10 to about 500.

### General Procedures on Preparation of Amidoximes

Examples of cyanoethylation to produce nitrile compounds:

### Preparation of β-Ethoxypropionitrile, C₂H₅—O—CH₂—CH₂—CN

Placed 25 ml of 2 percent aqueous sodium hydroxide and 26 g. (33 ml.) of ethyl alcohol in a 250 ml. reagent bottle, add 26·5 g. (33 ml.) of acrylonitrile and closed the mouth of the bottle with a tightly-fitting cork. Agitated the resulting clear homogeneous liquid in a shaking machine for 2 hours. During the first 15 minutes the temperature of the mixture increased 15° C. to 20° C. and thereafter decreased gradually to room temperature; two liquid layers separated after about 10 minutes. Removed the upper layer and added small quantities of 5 percent acetic acid to it until neutral to litmus; discarded the lower aqueous layer. Dried with anhydrous magnesium sulfate, distilled and collected the β-Ethoxypropionitrile at 172-174° C. The yield was 32 g.

### β-n-Propoxypropionitrile, C₃H₇^{α}—O—CH₂—CH₂—CN

Introduced 0.15 g of potassium hydroxide and 33 g. (41 ml) of dry n-propyl alcohol into a 150 ml. bolt-head flask, warmed gently until the solid dissolved, and then cooled to room temperature. Clamped the neck of the flask and equipped it with a dropping funnel, a mechanical stirrer and a thermometer (suitably supported in clamps). Introduced from the dropping funnel, with stirring, 26.5 g. (33 ml) of pure acrylonitrile over a period of 2.5-30 minutes (1 drop every ca. 2 seconds). Did not allow the temperature of the mixture to rise above 35-45° C.; immersed the reaction flask in a cold water bath, when necessary. When all the acrylonitrile had been added, heated under reflux in a boiling water bath for 1 hour; the mixture darkened. Cooled, filtered and distilled. Collected the β-n-Propoxypropionitrile at 187-189° C. The yield was 38 g.

### β-Diethylaminopropionitrile, (C₂H₅)₂N—CH₂—CH₂—CN

Mixed 42.5 g (60 ml) of freshly-distilled diethylamine and 26.5 g. (33 ml) of pure acrylonitrile in a 250 ml round-bottomed flask fitted with a reflux condenser. Heated at 50° C. in a water bath for 10 hours and then allowed to stand at room temperature for 2 days. Distilled off the excess of diethylamine on a water bath, and distilled the residue from a Claisen flask under reduced pressure. Collected the β-Diethylaminopropionitrile at 75-77° C./11 mm. The yield was 54 g.

### β-Di-n-butylaminopropionitrile, (C₄H₉^{α})₂N—CH₂—CH₂—CN

Proceeded as for the diethyl compound using 64.5 g. (85 ml) of redistilled di-n-butylamine and 26.5 g. (33 mL) of pure acrylonitrile. After heating at 50° C. and standing for 2 days, distiled the entire product under diminished pressure (air bath); discarded the low boiling point fraction containing unchanged di-n-butylamine and collected the β-Di-n-butylaminopropionitrile at 120-122° C./110 mm. The yield was 55 g.

### Ethyl n-propyl-2-cyanoethylmalonate

Added 8.0 g (10.0 ml) of redistilled acrylonitrile to a stirred solution of ethyl n-propyl malonate (30.2 g.) and of 30 percent methanolic potassium hydroxide (4.0 g.) in tert-butyl alcohol (100 g.). Kept the reaction mixture at 30°-35° C. during the addition and stirred for a further 3 hours. Neutralized the solution with dilute hydrochloric acid (1:4), diluted with water and extracted with ether. Dried the ethereal extract with anhydrous magnesium sulfate and distilled off the ether: the residue (ethyl n-propyl-2-cyanoethylmalonate; 11 g) solidified on cooling in ice, and melted at 31°-32° C. after recrystallization from ice-cold ethyl alcohol.

### Preparation of Cyanoethylated Compound

A cyanoethylated diaminocyclohexane was prepared according to U.S. Pat. No. 6,245,932, which is incorporated herein by reference, with cyanoethylated methylcyclohexylamines, which are readily prepared in the presence of water.

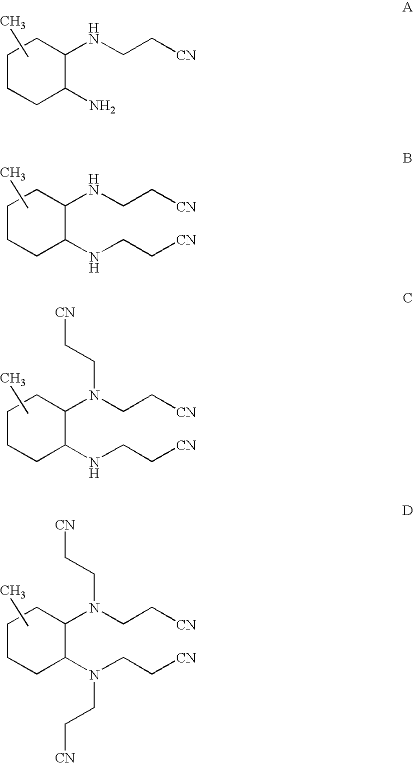

Analysis showed that almost no compounds exhibiting secondary amine hydrogen reaction and represented by structures C and D were produced when water alone is used as the catalytic promoter.

Examples of reaction of nitrile compound with hydroxylamine to form amidoxime compounds

Preparation and analysis of polyamidoxime (See, e.g., U.S. Pat. No. 3,345,344)

80 parts by weight of polyacrylonitrile of molecular weight of about 130,000 in the form of very fine powder (−300 mesh) was suspended in a solution of 300 parts by weight of hydroxylammonium sulfate, 140 parts by weight of sodium hydroxide and 2500 parts by weight of deionized water. The pH of the solution was 7.6. The mixture was heated to 90° C. and held at that temperature for 12 hours, all of the time under vigorous agitation. It was cooled to 35° C. and the product filtered off and washed repeatedly with deionized water. The resin remained insoluble throughout the reaction, but was softened somewhat by the chemical and heat. This caused it to grow from a very fine powder to small clusters of 10 to 20 mesh. The product weighed 130 grams. The yield 40 is always considerably more than theoretical because of a firmly occluded salt. The product is essentially a polyamidoxime having the following reoccurring unit.

The mixture of hydroxylamine sulfate and sodium hydroxide can be replaced with equal molar of hydroxylamine freebase solution.

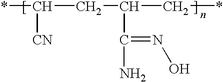

Portions of this product were then analyzed for total nitrogen and for oxime nitrogen by the well-known Dumas and Raschig methods and the following was found:

| | Percent |
|---|---|
| Total nitrogen (Dumas method) | 22.1 |
| Oxime nitrogen (Raschig method) | 6.95 |
| Amidoxime nitrogen (twice the amount of | 13.9 |
| oxime nitrogen) (calculated) | |
| Nitrile nitrogen (difference between the total | 8.2 |
| nitrogen and amidoxime nitrogen) (calculated) | |

Conversion of reacted product from cyanoethylation of cycloaliphatic vicinal primary amines (See, e.g., U.S. Pat. No. 6,245,932).

For example, cyanoethylated methylcyclohexylamines:

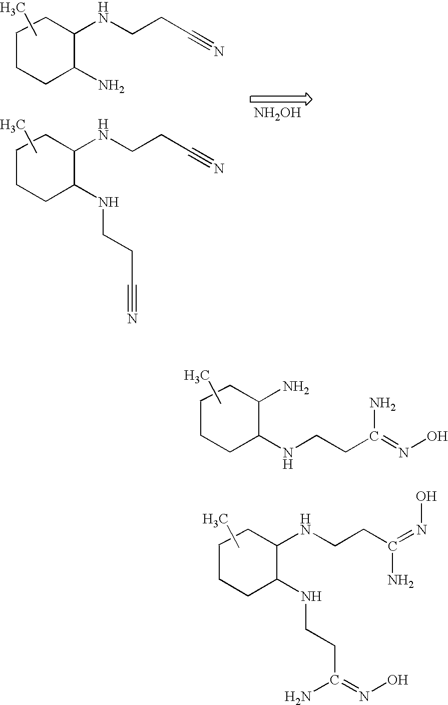

A large number of the amidoxime compounds are not commercially available. In an exemplary embodiment, these amidoxime compounds, as well as those commercially available, are prepared in-situ, particularly from nitrile compounds and hydroxylamine, while blending the cleaning formulations of the invention.

The following are photoresist stripper formulations that may be used with the amidoxime compounds of the present invention:

| | | | | Start | | After Step 1 | | After Step 2 | | End | | Stripper |
|---|---|---|---|---|---|---|---|---|---|---|---|---|
| | | Ingredient | MW | mole | Wt | mole | Wt | mole | Wt | mole | Wt | Composition |
| Step | Amine | 2-Pyrolidone | 85.11 | 1.00 | 85.11 | 0.00 | 0.00 | 0.00 | 0.00 | 0.00 | 0.00 | 0% |
| 1 | | | | | | | | | | | | |
| | Nitrile | Acrylonitrile | 53.00 | 1.00 | 53.00 | 0.00 | 0.00 | 0.00 | 0.00 | 0.00 | 0.00 | 0% |
| | Metal Ion free | TMAH | 91.00 | 0.05 | 4.55 | 0.05 | 4.55 | 0.05 | 4.55 | 0.05 | 4.55 | 2% |
| | base | | | | | | | | | | | |
| | | Water | 18.00 | 0.76 | 13.65 | 0.76 | 13.65 | 0.76 | 13.70 | 0.76 | 13.68 | 6% |
| | Cyanoethylated | | 137.10 | 0.00 | 0.00 | 1.00 | 137.10 | 0.00 | 0.00 | 0.00 | 0.00 | 0% |
| | Compound | | | | | | | | | | | |
| Step | Oxidizing/ | Hydroxylamine | 31.00 | 1.00 | 31.00 | 0.00 | 0.00 | 0.00 | 0.00 | 0.00 | 0.00 | 0% |
| 2 | Reducing | | | | | | | | | | | |
| | compound | | | | | | | | | | | |
| | Water | Water | 18.00 | 1.72 | 31.00 | 0.00 | 0.00 | 1.72 | 31.00 | 1.72 | 31.00 | 14% |
| | Amidoxime | Amidoxime | 170.00 | 0.00 | 0.00 | 0.00 | 0.00 | 1.00 | 170.00 | 1.00 | 170.00 | 78% |

| | | |
|---|---|---|
| 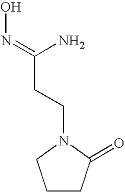 | 219.20 | 100% |

Stripping composition

| | Ingredient | Stripper Composition |
|---|---|---|
| Metal Ion free base | TMAH | 2% |
| Water | Water | 20% |
| Amidoxime | 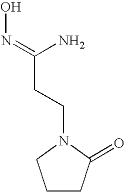 | 78% 100% |

Exemplary Amidoximes Prepared from Amines:

| 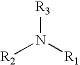 | | | 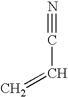 | H₂N—OH |
|---|---|---|---|---|
| R1 | R2 | R3 | Nitrile | Amidoxime |
| —H | —H | —H | 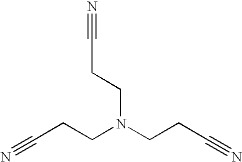 1:3 | 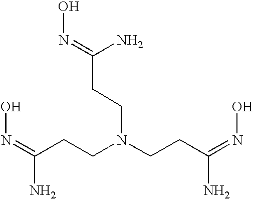 1:3:3 |
| CH3CH2 | H | H | 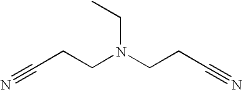 1:2 | 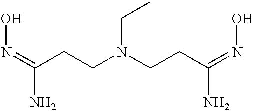 1:2:2 |
| CH3CH2 | CH3CH2 | H | 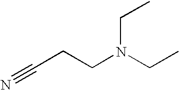 1:1 | 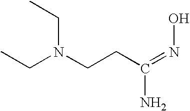 1:1:1 |

Exemplary Amidoximes Prepared from Citric Acid:

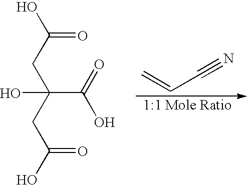

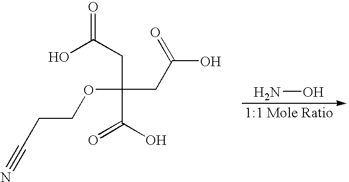

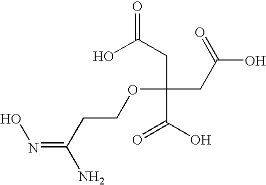

| Reactants | 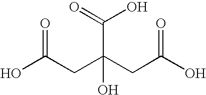 |
|---|---|
| CA:AN:HA 1:1:1 | 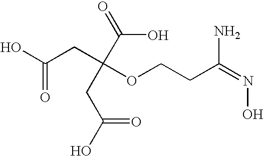 |
| CA:AN:HA 1:1:1 | 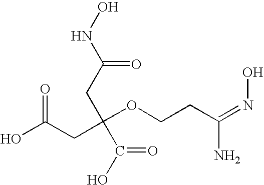 |
| CA:AN:HA 1:1:1 | 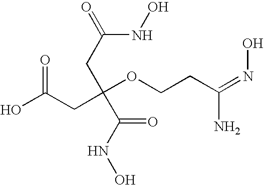 |
| CA:AN:HA 1:1:1 | 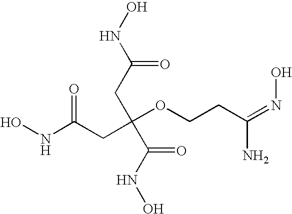 |

Exemplary Amidoximes Prepared from Lactic Acid:

| 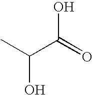 Lactic Acid | 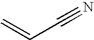 | Amidoxime Compounds | |
|---|---|---|---|
| — | 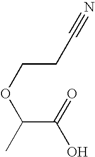 | 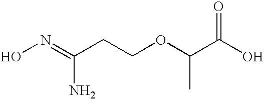 1:1:1 | 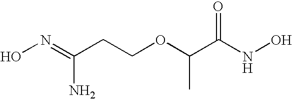 1:1:2 |

Exemplary Amidoximes Prepared from Propylene Glycol:

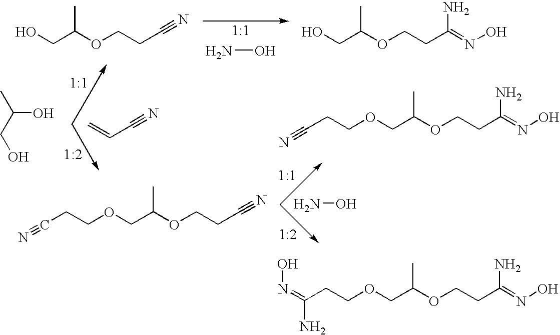

| | Amidoxime Compounds | | |
|---|---|---|---|
| Reactant | PG:AN:HA 1:1:1 | PG:AN:HA 1:2:1 | PG:AN:HA 1:2:2 |
| 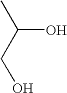 | 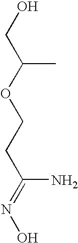 | 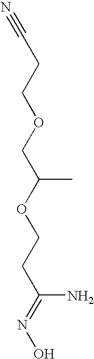 | 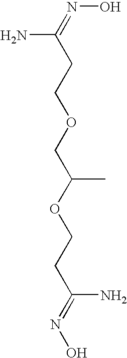 |

Exemplary Amidoximes Prepared from Pentaerythritol—DS1:

| | | | |
|---|---|---|---|
| 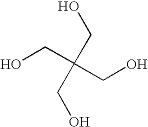 | 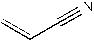 | H₂N—OH | Amidoxime Compounds |

| | | |
|---|---|---|
| 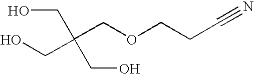 1:1 | 1 | 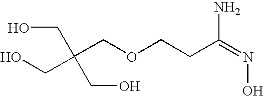 |

Exemplary Amidoximes Prepared from Pentaerythritol—DS2:

| | | | |
|---|---|---|---|
| 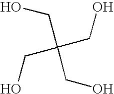 | 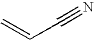 | H₂N—OH | Amidoxime Compounds |

| | | |
|---|---|---|
| 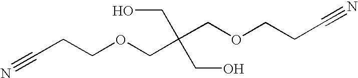 1:2 | 1 | 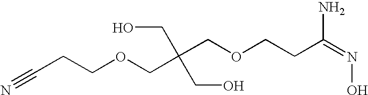 |
| | 2 | 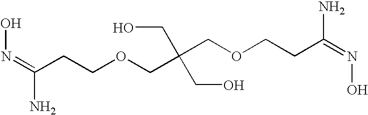 |

Exemplary Amidoximes Prepared from Pentaerythritol—DS3:

| | | | |
|---|---|---|---|
| 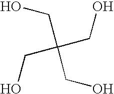 | 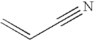 | H₂N—OH | Amidoxime Compounds |

| | | |
|---|---|---|
| 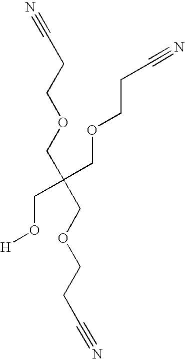 1:3 | 1 | 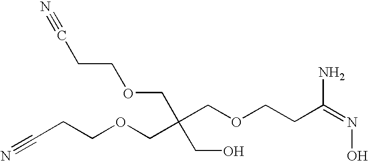 |
| | 2 | 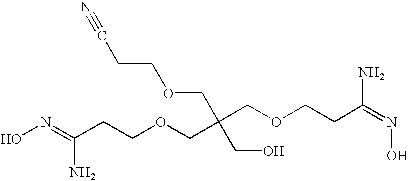 |
| | 3 | 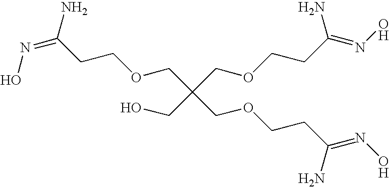 |

Exemplary Amidoximes Prepared from Pentaerythritol—DS4:

| | | | |
|---|---|---|---|
| 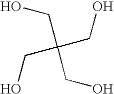 | 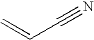 | H₂N—OH | Amidoxime Compounds |

| | | |
|---|---|---|
| 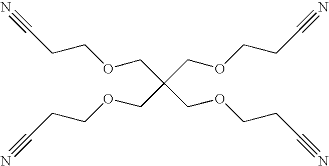 1:4 | 1 | 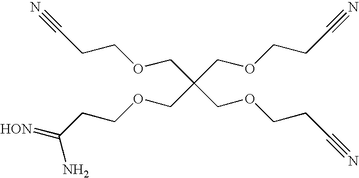 |
| | 2 | 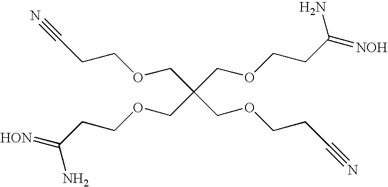 |
| | 3 | 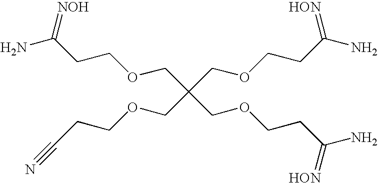 |
| | 4 | 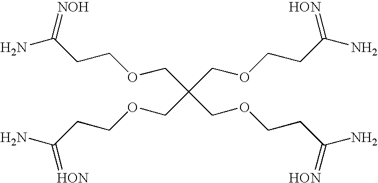 |

### α-Substituted Acetic Acid

| R | 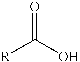 |
|---|---|
| —CH₃ | Acetic Acid |
| —CH₂OH | Glycolic Acid |
| —CH₂NH₂ | Glycine |
| —CHO | Glyoxylic Acid |

| 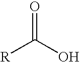 | | H₂N—OH | | |
|---|---|---|---|---|
| R | 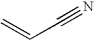 | 1 | 2 | 3 |
| —CH₃ | | 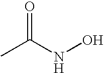 | | |
| —CH₂OH | 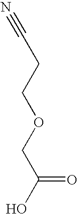 | 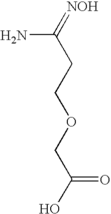 | 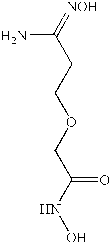 | |
| —CH₂NH₂ | 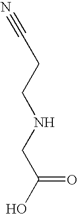 | 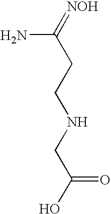 | 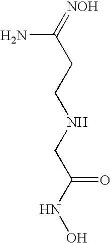 | |
| —CH₂NH₂ | 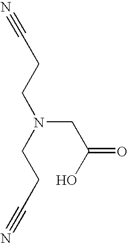 | 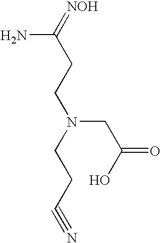 | 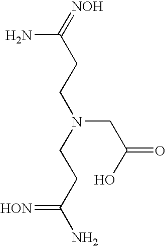 | |
| —CHO | 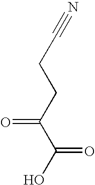 | 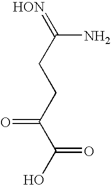 | 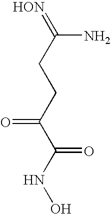 | |

Exemplary Amidoximes Prepared from Iminodiacetic Acid:

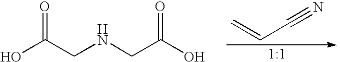

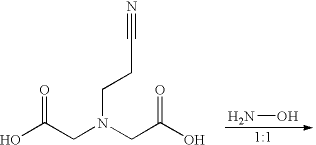

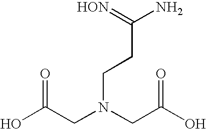

| Reactants | 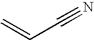 | H₂N—OH | 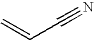 | H₂N—OH | 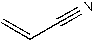 | H₂N—OH |
|---|---|---|---|---|---|---|
| 1 | 1 | 1 | 1 | 2 | 1 | 3 |

| | | | |
|---|---|---|---|
| 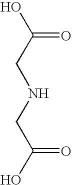 | 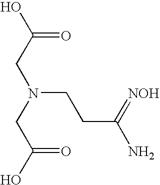 | 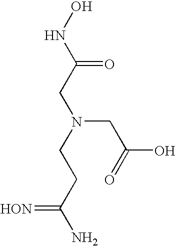 | 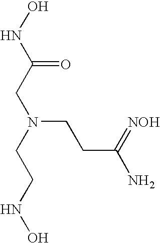 |

Exemplary Amidoximes Prepared from 2,5-piperazinedione:

| Reactants | 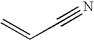 | H₂N—OH | 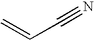 | H₂N—OH | 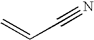 | H₂N—OH |
|---|---|---|---|---|---|---|
| 1 | 1 | 1 | 2 | 1 | 2 | 2 |

| | | | |
|---|---|---|---|
| 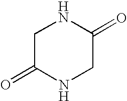 | 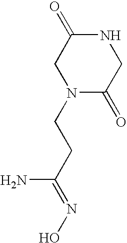 | 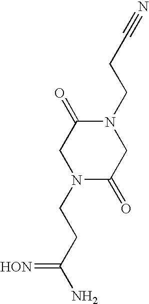 | 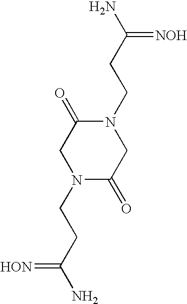 |

Exemplary Amidoximes Prepared from Cyanopyridine:

| Reactants | H₂N—OH | 1594-57-6 |
|---|---|---|
| 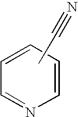 | 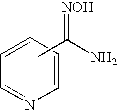 | 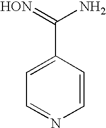 |
| 2, 3 or 4 Cyanopyridine | 2, 3 or 4 Amidoxime | 4-Amidoxime-pyridine |
| | pyridine | |

Reactions to produce nitrile precursors to amidoxime compounds:

### Cyanoethylation of Diethylamine

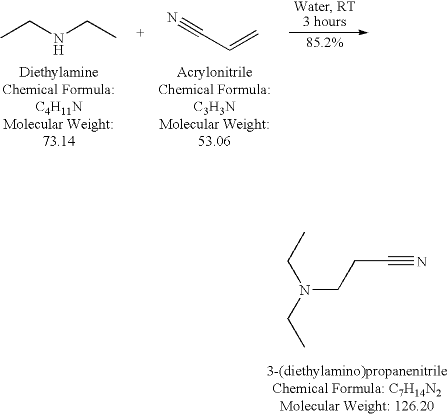

A solution of diethylamine (1 g, 13.67 mmol) and acrylonitrile (0.798 g, 15 mmol, 1.1 eq) in water (10 cm³) were stirred at room temperature for 3 hours, after which the mixture was extracted with dichloromethane (2×50 cm³). The organic extracts were evaporated under reduced pressure to give the pure cyanoethylated compound 3-(diethylamino)propanenitrile (1.47 g, 85.2%) as an oil.

### Monocyanoethylation of Glycine

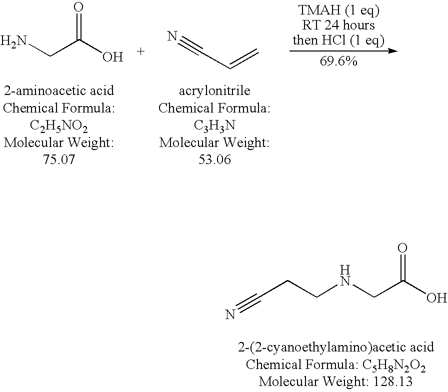

Glycine (5 g, 67 mmol) was suspended in water (10 cm³) and TMAH (25% in water, 24.3 g, 67 mmol) was added slowly, keeping the temperature at <30° C. with an ice-bath. The mixture was then cooled to 10° C. and acrylonitrile (3.89 g, 73 mmol) was added. The mixture was stirred overnight, and allowed to warm to room temperature slowly. The mixture was then neutralized with HCl (6M, 11.1 cm³), concentrated to 15 cm³ and diluted to 100 cm³ with EtOH. The solid precipitated was collected by filtration, dissolved in hot water (6 cm³) and re-precipitated with EtOH (13 cm³) to give 2-(2-cyanoethylamino)acetic acid (5.94 g, 69.6%) as a white solid, mp 192° C. (lit mp 190-191° C.).

### Cyanoethylation of Piperazine

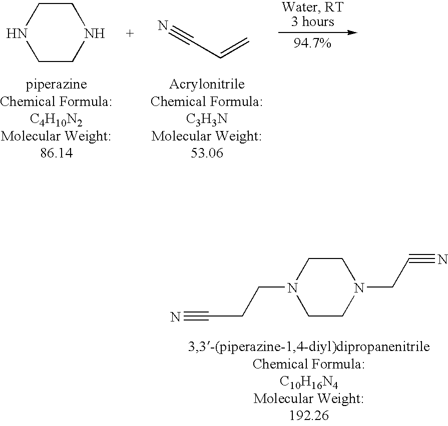

A solution of piperazine (1 g, 11.6 mmol) and acrylonitrile (1.6 g, 30.16 mmol, 2.6 eq) in water (10 cm³) were stirred at room temperature for 5 hours, after which the mixture was extracted with dichloromethane (2×50 cm³). The organic extracts were evaporated under reduced pressure to give the pure doubly cyanoethylated compound 3,3′-(piperazine-1,4-diyl)dipropanenitrile (2.14 g, 94.7%) as a white solid, mp 66-67° C.

### Cyanoethylation of 2-ethoxyethanol

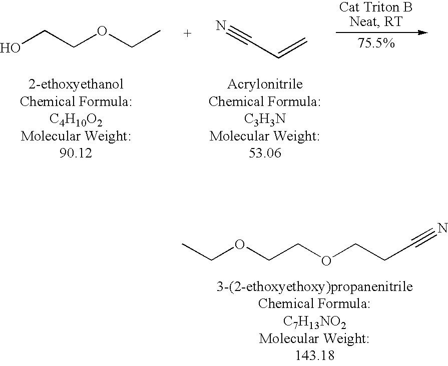

To an ice-water cooled mixture of 2-ethoxyethanol (1 g, 11.1 mmol) and Triton B (40% in MeOH, 0.138 g, 0.33 mmol) was added acrylonitrile (0.618 g, 11.6 mmol) and the mixture was stirred at room temperature for 24 hours. It was then neutralized with 0.1 M HCl (3.3 cm³) and extracted with CH₂Cl₂ (2×10 cm³) The extracts were concentrated under reduced pressure and the residue was Kugelrohr-distilled to give the product 3-(2-ethoxyethoxy)propanenitrile (1.20 g, 75.5%) as a colourless oil, by 100-130° C./20 Torr.

### Cyanoethylation of 2-(2-dimethylaminoethoxy)ethanol

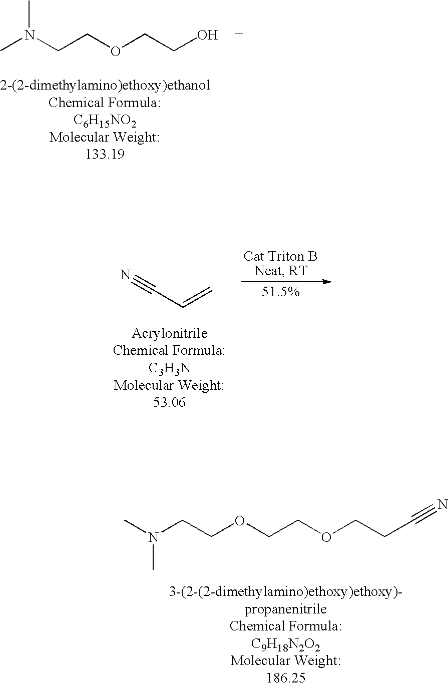

To an ice-water cooled mixture of 2-(2-dimethyleminothoxy)ethanol (1 g, 7.5 mmol) and Triton B (40% in MeOH, 0.094 g, 0.225 mmol) was added acrylonitrile (0.418 g, 7.9 mmol) and the mixture was stirred at room temperature for 24 hours. It was then neutralized with 0.1 M HCl (2.3 cm³) and extracted with CH₂Cl₂ (2×10 cm³) The extracts were concentrated under reduced pressure and the residue was purified by column chromatography (silica, Et₂O, 10% CH₂Cl₂, 0-10% EtOH) to give 3-(2-(2-(dimethylamino)ethoxy)ethoxy)propanenitrile as an oil.

### Cyanoethylation of Isobutyraldehyde

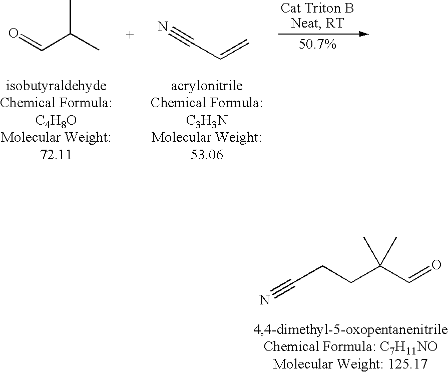

Isobutyraldehyde (1 g, 13.9 mmol) and acrylonitrile (0.81 g, 15 mmol) were mixed thoroughly and cooled with an ice-bath. Triton B (40% in MeOH, 0.58 g, 1.4 mmol) was added. The mixture was stirred at room temperature overnight. It was then neutralized with 0.1 M HCl (14 cm³) and extracted with CH₂Cl₂ (100 cm³) The extracts were concentrated under reduced pressure and the residue was Kugelrohr-distilled to give the product 4,4-dimethyl-5-oxopentanenitrile (0.8 g, 50.7%) as an oil, by 125-130° C./20 Torr.

### Cyanoethylation of Aniline

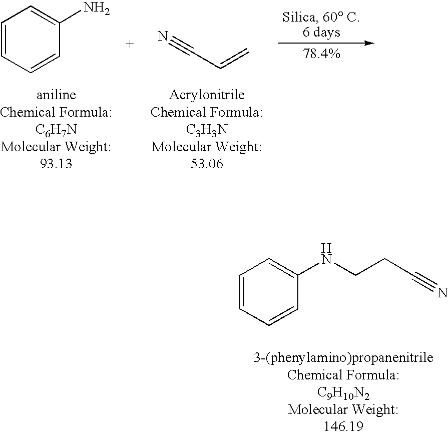

Silica was activated by heating it above 100° C. in vacuum and was then allowed to cool to room temperature under nitrogen. To the activated silica (10 g) was absorbed aniline (1.86 g, 20 mmol) and acrylonitrile (2.65 g, 50 mmol) and the flask was capped tightly. The contents were then stirred with a magnetic stirrer for 6 days at 60° C. After this time the mixture was cooled to room temperature and extracted with MeOH. The extracts were evaporated to dryness and the residue was Kugelrohr-distilled under high vacuum to give the product 3-(phenylamino)propanenitrile (2.29 g, 78.4%) as an oil which crystallised on standing; by 120-150° C./1-2 Torr (lit by 120° C./1 Torr), mp 50.5-52.5° C.

### Cyanoethylation of Ethylenediamine

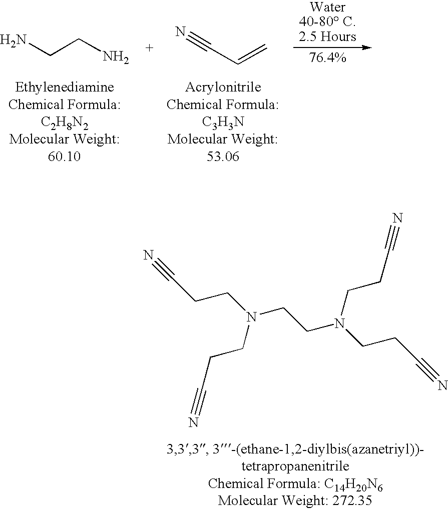

Acrylonitrile (110 g, 137 cm³, 2.08 mol) was added to a vigorously stirred mixture of ethylenediamine (25 g, 27.8 cm³, 0.416 mol) and water (294 cm³) at 40° C. over 30 min. During the addition, it was necessary to cool the mixture with a 25° C. water bath to maintain temperature at 40° C. The mixture was then stirred for additional 2 hours at 40° C. and 2 hours at 80° C. Excess acrylonitrile and half of the water were evaporated off and the residue, on cooling to room temperature, gave a white solid which was recrystallised from MeOH-water (9:1) to give pure product 3,3′,3″,3′″-(ethane-1,2-diylbis(azanetriyl))tetrapropanenitrile (86.6 g, 76.4%) as white crystals, mp 63-65° C.

### Cyanoethylation of Ethylene Glycol

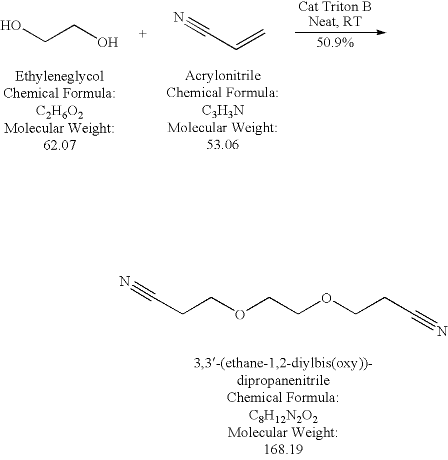

Small scale: Ethylene glycol (1 g, 16.1 mmol) was mixed with Triton B (40% in MeOH, 0.22 g, 0.53 mmol) and cooled in an ice-bath while acrylonitrile (1.71 g, 32.2 mmol) was added. The mixture was stirred at room temperature for 60 hours after which it was neutralized with 0.1 M HCl (0.6 cm³) and extracted with CH₂Cl₂ (80 cm³) The extracts were concentrated under reduced pressure and the residue was Kugelrohr-distilled to give 3,3′-(ethane-1,2-diylbis(oxy))dipropanenitrile (1.08 g, 39.9%) as a light coloured oil, by 150-170° C./20 Torr.

Large scale: Ethylene glycol (32.9 g, 0.53 mol) was mixed with Triton B (40% in MeOH, 2.22 g, 5.3 mmol) and cooled in an ice-bath while acrylonitrile (76.2 g, 1.44 mol) was added. The mixture was allowed to warm slowly to room temperature and stirred for 60 hours after which it was neutralized with 0.1 M HCl (50 cm³) and extracted with CH₂Cl₂ (300 cm³) The extracts were passed through a silica plug three times to reduce the brown colouring to give 86 g (quantitative yield) of the product as an amber coloured oil, pure by ¹H-NMR, containing 10 g of water (total weight 96 g, amount of water calculated by ¹H NMR integral sizes).

### Cyanoethylation of Diethyl Malonate

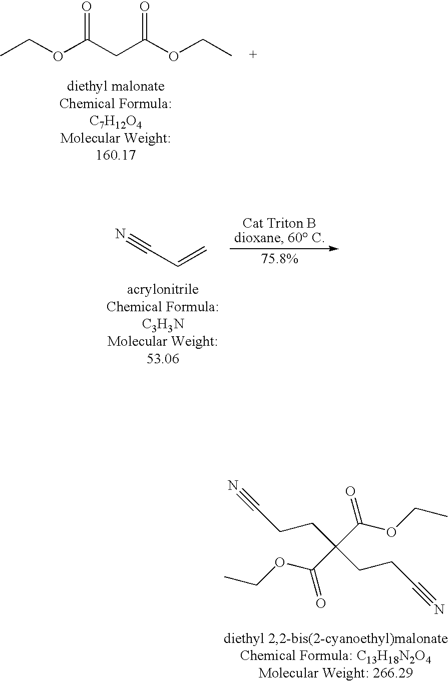

To a solution of diethyl malonate (1 g, 6.2 mmol) and Triton B (40% in MeOH, 0.13 g, 0.31 mmol) in dioxane (1.2 cm³) was added dropwise acrylonitrile (0.658 g, 12.4 mmol) and the mixture was stirred at 60° C. overnight. The mixture was then cooled to room temperature and neutralized with 0.1 M HCl (3 cm³) and poured to ice-water (10 cm³). Crystals precipitated during 30 min. These were collected by filtration and recrystallised from EtOH (cooling in freezer before filtering off) to give diethyl 2,2-bis(2-cyanoethyl)malonate (1.25 g, 75.8%) as a white solid, mp 62.2-63.5° C.

### Hydrolysis of diethyl 2,2-bis(2-cyanoethyl)malonate

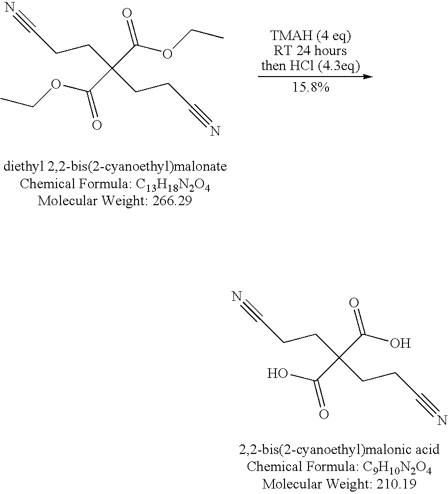

Diethyl 2,2-bis(2-cyanoethyl)malonate (2 g, 7.51 mmol) was added to TMAH (25% in water, 10.95 g, 30.04 mmol) at room temperature. The mixture was stirred for 24 hours, and was then cooled to 0° C. A mixture of 12M HCl (2.69 cm³, 32.1 mmol) and ice (3 g) was added and the mixture was extracted with CH₂Cl₂ (5×50 cm³). The extracts were evaporated under vacuum to give 2,2-bis(2-cyanoethyl)malonic acid (0.25 g, 15.8%) as a colourless very viscous oil (lit decomposed. 158° C.).

### Dicyanoethylation of glycine to give 2-(bis(2-cyanoethyl)amino)acetic acid

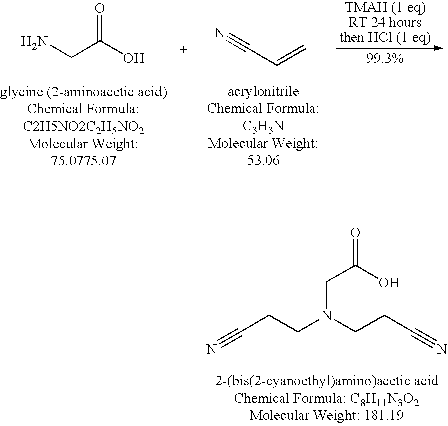

Glycine (5 g, 67 mmol) was suspended in water (10 cm³) and TMAH (25% in water, 24.3 g, 67 mmol) was added slowly, keeping the temperature at <30° C. with an ice-bath. The mixture was then cooled to 10° C. and acrylonitrile (7.78 g, 146 mmol) was added. The mixture was stirred overnight, and allowed to warm to room temperature slowly. It was then heated at 50° C. for 2 hours, using a reflux condenser. After cooling with ice, the mixture was neutralized with HCl (6M, 11.1 cm³) and concentrated to a viscous oil. This was dissolved in acetone (100 cm³) and filtered to remove NMe₄Cl. The filtrate was concentrated under reduced pressure to give an oil that was treated once more with acetone (100 cm³) and filtered to remove more NMe₄Cl. Concentration of the filtrate gave 2-(bis(2-cyanoethyl)amino)acetic acid (11.99 g, 99.3%) as a colourless, viscous oil that crystallised over 1 week at room temperature to give a solid product, mp 73° C. (lit mp 77.8-78.8° C. Duplicate ¹³C signals indicate a partly zwitterionic form in CDCl₃ solution. It was noted that when NaOH is used in the literature procedure, the NaCl formed is easier to remove and only one acetone treatment is necessary.

### Dicyanoethylation of N-methyldiethanolamine to give 3,3′-(2,2′-(methylazanediyl)bis(ethane-2,1-diyl)bis(oxy))dipropanenitrile

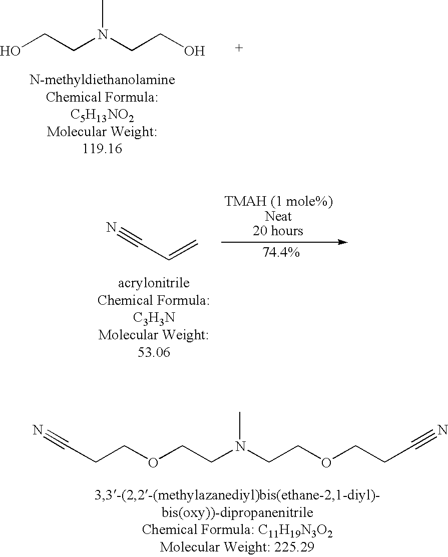

To a cooled, stirred mixture of N-methyldiethanolamine (2 g, 17 mmol) and acrylonitrile (2.33 g, 42 mmol) was added TMAH (25% in water, 0.25 cm³, 0.254 g, 7 mmol). The mixture was then stirred overnight, and allowed to warm to room temperature slowly. It was then filtered through silica using a mixture of Et₂O and CH₂Cl₂ (1:1, 250 cm³) and the filtrated was evaporated under reduced pressure to give 3,3′-(2,2′-(methylazanediyl)bis(ethane-2,1-diyl)bis(oxy))dipropanenitrile (2.85 g, 74.4%) as a colourless oil.

### Dicyanoethylation of Glycine Anhydride

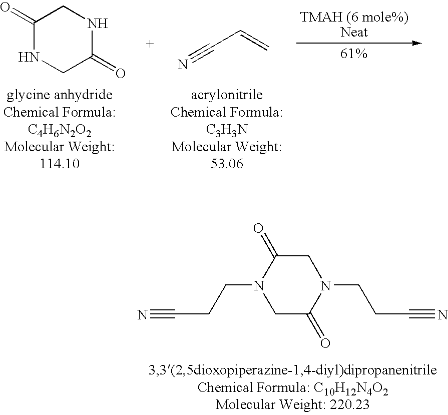

Glycine anhydride (2 g, 17.5 mmol) was mixed with acrylonitrile (2.015 g, 38 mmol) at 0° C. and TMAH (25% in water, 0.1 cm³, 0.1 g, 2.7 mmol) was added. The mixture was then stirred overnight, allowing it to warm to room temperature slowly. The solid formed was recrystallised from EtOH to give 3,3′-(2,5-dioxopiperazine-1,4-diyl)dipropanenitrile (2.35 g, 61%) as a white solid, mp 171-173° C. (lit mp 166° C.).

### N,N-Dicyanoethylation of Acetamide

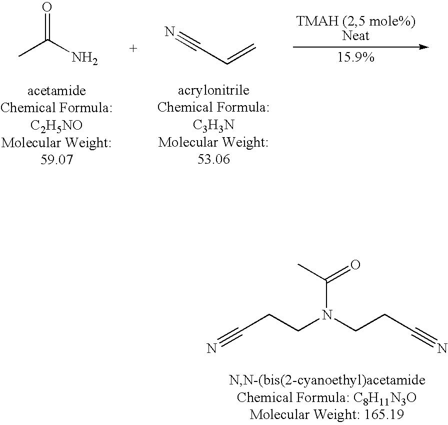

Acetamide (2 g, 33.9 mmol) was mixed with acrylonitrile (2.26 g, 42.7 mmol) at 0° C. and TMAH (25% in water, 0.06 cm³, 0.06 g, 1.7 mmol) was added. The mixture was then stirred overnight, allowing it to warm to room temperature slowly. The mixture was filtered through a pad of silica with the aid of Et₂O/CH₂Cl₂ (200 cm³) and the filtrate was concentrated under reduced pressure. The product was heated with spinning in a Kugelrohr at 150° C./2 mmHg to remove side products and to give N,N-bis(2-cyanoethyl)acetamide (0.89 g, 15.9%) as a viscous oil. The N-substituent in the amides is non-equivalent due to amide rotation.

### Tricyanoethylation of Ammonia

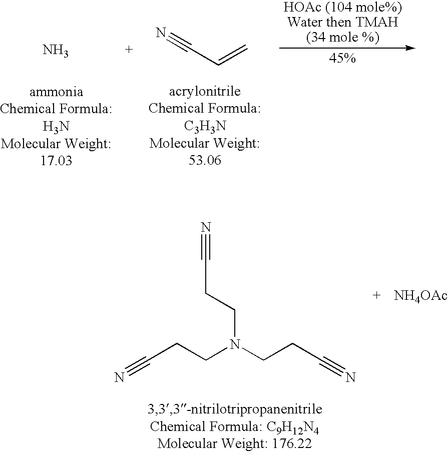

Ammonia (aq 35%, 4.29, 88 mmol) was added dropwise to ice-cooled AcOH (5.5 g, 91.6 mmol) in water (9.75 cm³), followed by acrylonitrile (4.65 g, 87.6 mol). The mixture was stirred under reflux for 3 days, after which it was cooled with ice and aq TMAH (25% in water, 10.94 g, 30 mmol) was added. The mixture was kept cooled with ice for 1 hours. The crystals formed was collected by filtration and washed with water. The product was dried in high vacuum to give 3,3′,3″-nitrilotripropanenitrile (2.36 g, 45.8%) as a white solid, mp 59-61° C. (lit mp 59° C.). When NaOH was used to neutralise the reaction (literature procedure), the yield was higher, 54.4%.

### Dicyanoethylation of Cyanoacetamide

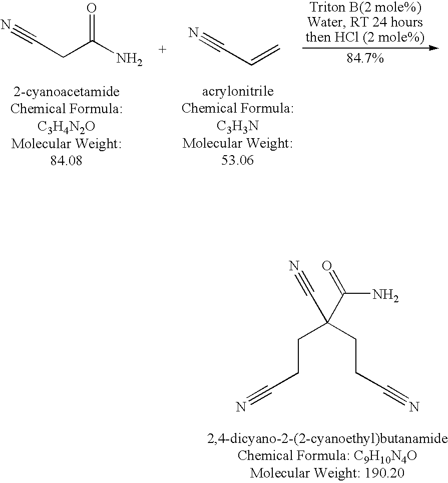

To a stirred mixture of cyanoacetamide (2.52 g, 29.7 mmol) and Triton B (40% in MeOH, 0.3 g, 0.7 mmol) in water (5 cm³) was added acrylonitrile (3.18 g, 59.9 mmol) over 30 minutes with cooling. The mixture was then stirred at room temperature for 30 min and then allowed to stand for 1 hours. EtOH (20 g) and 1M HCl (0.7 cm³) were added and the mixture was heated until all solid had dissolved. Cooling to room temperature gave crystals that were collected by filtration and recrystallised from EtOH to give 2,4-dicyano-2-(2-cyanoethyl)butanamide (4.8 g, 84.7%) as a pale yellow solid, mp 118-120° C. (lit mp 118° C.),

### N,N-Dicyanoethylation of Anthranilonitrile

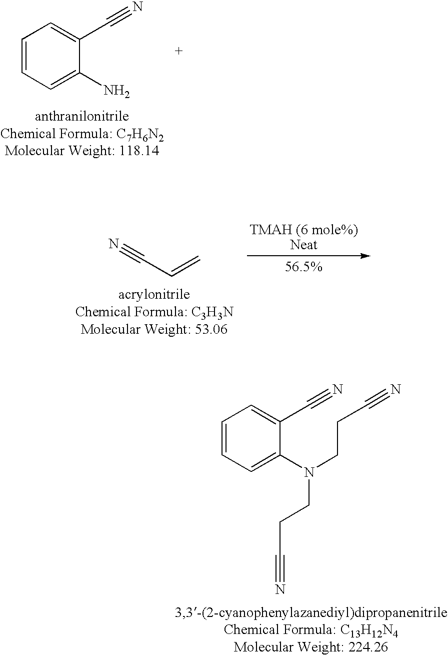

Anthranilonitrile (2 g, 16.9 mmol) was mixed with acrylonitrile (2.015 g, 38 mmol) at 0° C. and TMAH (25% in water, 0.1 cm³, 0.1 g, 2.7 mmol) was added. The mixture was then stirred overnight, allowing it to warm to room temperature slowly. The product was dissolved in CH₂Cl₂ and filtered through silica using a mixture of Et₂O and CH₂Cl₂ (1:1, 250 cm³). The filtrate was evaporated to dryness and the solid product was recrystallised from EtOH (5 cm³) to give 3,3′-(2-cyanophenylazanediyl)dipropanenitrile (2.14 g, 56.5%) as an off-white solid, mp 79-82° C.

### Dicyanoethylation of Malononitrile

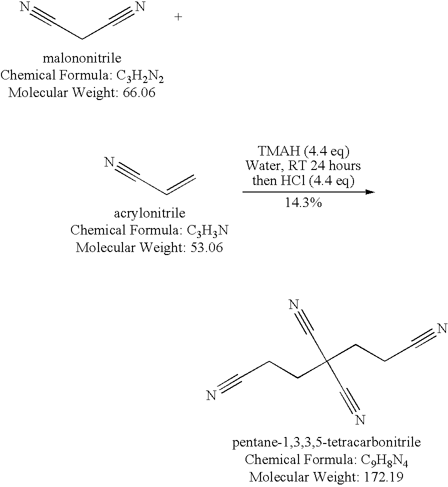

Malononitrile (5 g, 75.7 mmol) was dissolved in dioxane (10 cm³), followed by trimethylbenzylammonium hydroxide (Triton B, 40% in MeOH, 1.38 g, 3.3 mmol). The mixture was cooled while acrylonitrile (8.3 g, 156 mmol) was added. The mixture was stirred overnight, allowing it to warm to room temperature slowly. It was then neutralized with HCl (1 M, 3.3 cm³) and poured into ice-water. The mixture was extracted with CH₂Cl₂ (200 cm³) and the extracts were evaporated under reduced pressure. The product was purified by column chromatography (silica, 1:1 EtOAc-petroleum) followed by recrystallisation to give 1,3,3,5-tetracarbonitrile (1.86 g, 14.3%), mp 90-92° C. (lit mp 92° C.).

### Tetracyanoethylation of Pentaerythritol

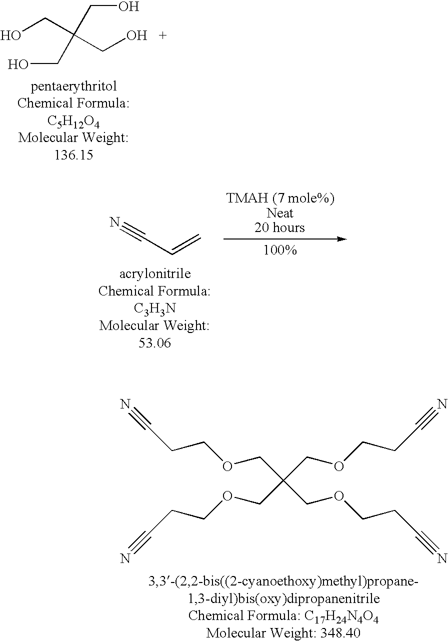

Pentaerythritol (2 g, 14.7 mmol) was mixed with acrylonitrile (5 cm³, 4.03 g, 76 mmol) and the mixture was cooled in an ice-bath while tetramethylammonium hydroxide (TMAH, 25% in water, 0.25 cm³, 0.254 g, 7 mmol) was added. The mixture was then stirred at room temperature for 20 hours. After the reaction time the mixture was filtered through silica using a mixture of Et₂O and CH₂Cl₂ (1:1, 250 cm³) and the filtrated was evaporated under reduced pressure to give 3,3′-(2,2-bis((2-cyanoethoxy)methyl)propane-1,3-diyl)bis(oxy)dipropanenitrile (5.12 g, 100%) as a colourless oil.

### Hexacyanoethylation of Sorbitol

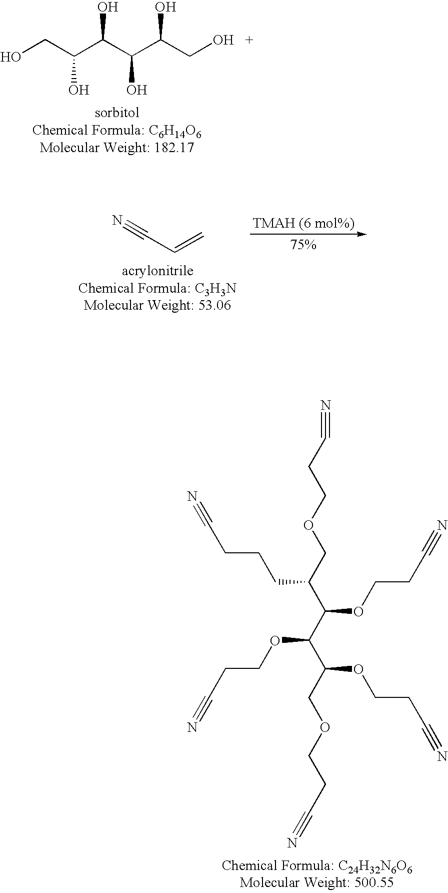

Sorbitol (2 g, 11 mmol) was mixed with acrylonitrile (7 cm³, 5.64 g, 106 mmol) and the mixture was cooled in an ice-bath while tetramethylammonium hydroxide (=TMAH, 25% in water, 0.25 cm³, 0.254 g, 7 mmol) was added. The mixture was then stirred at room temperature for 48 hours, adding another 0.25 cm³ of TMAH after 24 hours. After the reaction time the mixture was filtered through silica using a mixture of Et₂O and CH₂Cl₂ (1:1, 250 cm³) and the filtrate was evaporated under reduced pressure to give a fully cyanoethylated product (4.12 g, 75%) as a colourless oil.

### Tricyanoethylation of Diethanolamine to Give 3,3′-(2,2′-(2-cyanoethylazanediyl)bis(ethane-2,1-diyl)bis(oxy))dipropanenitrile

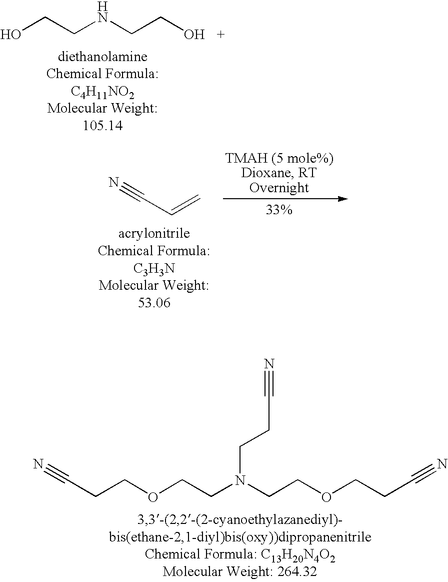

To an ice-cooled stirred solution of diethanolamine (2 g, 19 mmol) and TMAH (25% in water, 0.34 cm³, 0.35 g, 9.5 mmol) in dioxane (5 cm³) was added acrylonitrile (3.53 g, 66.1 mmol) dropwise. The mixture was then stirred overnight, and allowed to warm to room temperature. More acrylonitrile (1.51 g, 28 mmol) and TMAH (0.25 cm³, 7 mmol) was added and stirring was continued for additional 24 h. The crude mixture was filtered through a pad of silica (Et₂O/CH₂Cl₂ as eluent) and evaporated to remove dioxane. The residue was purified by column chromatography (silica, Et₂O to remove impurities followed by EtOAc to elute product) to give 3,3′-(2,2′-(2-cyanoethylazanediyl)bis(ethane-2,1-diyl)bis(oxy))dipropanenitrile (1.67 g, 33%) as an oil.

Representative reactions to produce amidoxime compounds:

### Reaction of Acetonitrile to give N′-hydroxyacetimidamide

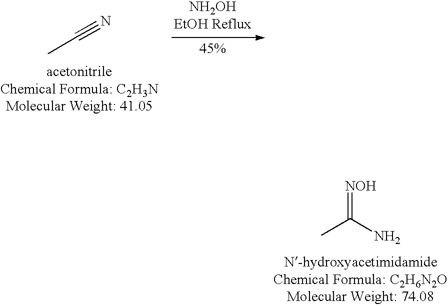

A solution of acetonitrile (0.78 g, 19 mmol) and hydroxylamine (50% in water, 4.65 cm³, 5.02 g, 76 mmol, 4 eq) in EtOH (100 cm³) was stirred under reflux for 1 hours, after which the solvent was removed under reduced pressure and the residue was recrystallised from iPrOH to give the product N′-hydroxyacetimidamide (0.63 g, 45%) as a solid, mp 134.5-136.5° C.

### Reaction of octanonitrile to give N′-hydroxyoctanimidamide

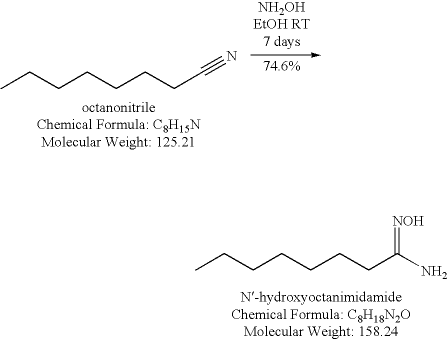

Octanonitrile (1 g, 7.99 mmol) and hydroxylamine (50% in water, 0.74 cm3, 0.79 g, 12 mmol, 1.5 eq) in EtOH (1 cm³) were stirred at room temperature for 7 days. Water (10 cm³) was then added. This caused crystals to precipitate, these were collected by filtration and dried in high vacuum line to give the product N′-hydroxyoctanimidamide (0.94 g, 74.6%) as a white solid, mp 73-75° C.

### Reaction of chloroacetonitrile to give 2-chloro-N′-hydroxyacetimidamide

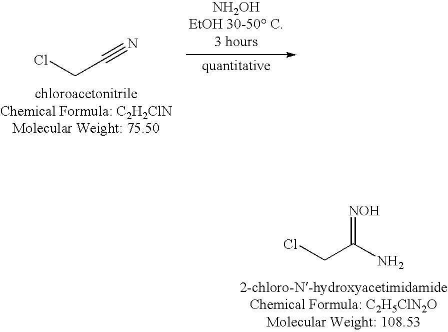

Chloroacetonitrile (1 g, 13 mmol) and hydroxylamine (50% in water, 0.89 cm³, 0.96 g, 14.6 mmol, 1.1 eq) in EtOH (1 cm³) were stirred at 30-50° C. for 30 min. The mixture was then extracted with Et2O (3×50 cm³). The extracts were evaporated under reduced pressure to give the product 2-chloro-N′-hydroxyacetimidamide (0.81 g, 57.4%) as a yellow solid, mp 79-80° C.

### Reaction of ethyl 2-cyanoacetate to give 3-amino-N-hydroxy-3-(hydroxyimino)propanamide

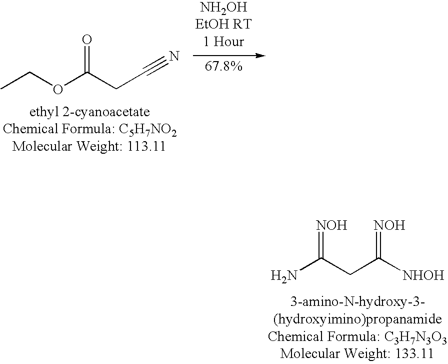

Ethyl cyanoacetate (1 g, 8.84 mmol) and hydroxylamine (50% in water, 1.19 cm3, 1.29 g, 19.4 mmol, 2.2 eq) in EtOH (1 cm³) were allowed to stand at room temperature for 1 hour with occasional swirling. The crystals formed were collected by filtration and dried in high vacuum line to give a colourless solid, 3-amino-N-hydroxy-3-(hydroxyimino)propanamide, mp 158° C. (decomposed) (lit mp 150° C.).

### Reaction of 3-hydroxypropionitrile to give N′,3-dihydroxypropanimidamide

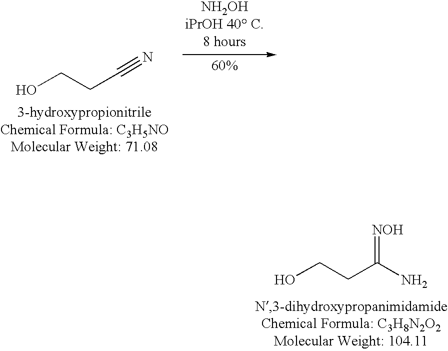

Equal molar mixture of 3-hydrxoypropionitrile and hydroxylamine heated to 40° C. for 8 hours with stirring. The solution is allowed to stand overnight yielding a fine slightly off white precipitate. The precipitated solid was filtered off and washed with iPrOH and dried to a fine pure white crystalline solid N′,3-dihydroxypropanimidamide mp 94° C.

### Reaction of 2-cyanoacetic acid to give isomers of 3-amino-3-(hydroxyimino)propanoic acid

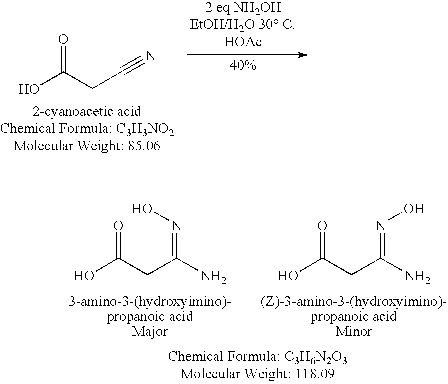

2-Cyanoacetic acid (1 g, 11.8 mmol) was dissolved in EtOH (10 cm³) and hydroxylamine (50% in water, 0.79 cm3, 0.85 g, 12.9 mmol, 1.1 eq) was added. The mixture was warmed at 40° C. for 30 min and the crystals formed (hydroxylammonium cyanoacetate) were filtered off and dissolved in water (5 cm³). Additional hydroxylamine (50% in water, 0.79 cm3, 0.85 g, 12.9 mmol, 1.1 eq) was added and the mixture was stirred at room temperature overnight. Acetic acid (3 cm³) was added and the mixture was allowed to stand for a few hours. The precipitated solid was filtered off and dried in high vacuum line to give the product 3-amino-3-(hydroxyimino)propanoic acid (0.56 g, 40%) as a white solid, mp 136.5° C. (lit 144° C.) as two isomers. Characterization of the product using FTIR and NMR: vmax(KBr)/cm⁻¹ 3500-3000 (br), 3188, 2764, 1691, 1551, 1395, 1356, 1265 and 1076; δH (300 MHz; DMSO-_{d6}; Me₄Si): 10.0-9.0 (br, NOH and COOH), 5.47 (2 H, br s, NH₂) and 2.93 (2 H, s, CH₂); δC(75 MHz; DMSO-_{d6}; Me₄Si): 170.5 (COOH minor isomer), 170.2 (COOH major isomer), 152.8 (C(NOH)NH₂ major isomer), 148.0 (C(NOH)NH₂ minor isomer), 37.0 (CH₂ minor isomer) and 34.8 (CH₂ major isomer).

### Reaction of adiponitrile to Give N′1,N′6-dihydroxyadipimidamide

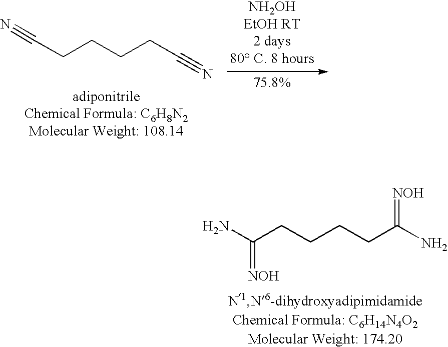

Adiponitrile (1 g, 9 mmol) and hydroxylamine (50% in water, 1.24 cm3, 1.34 g, 20 mmol, 2.2 eq) in EtOH (10 cm3) were stirred at room temperature for 2 days and then at 80° C. for 8 hours. The mixture was allowed to cool and the precipitated crystals were collected by filtration and dried in high vacuum line to give the product N′1,N′6-dihydroxyadipimidamide (1.19 g, 75.8%) as a white solid, mp 160.5 (decomposed) (lit decomposed 168-170° C.

### Reaction of sebaconitrile to give N′1,N′10-dihydroxydecanebis(imidamide)

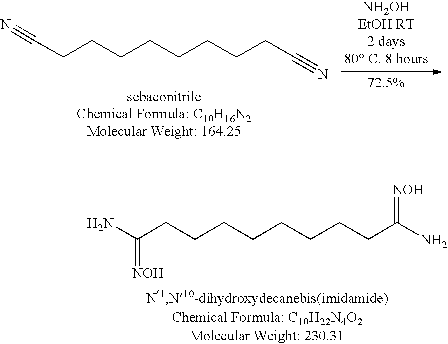

Sebaconitrile (1 g, 6 mmol) and hydroxylamine (50% in water, 0.85 cm³, 0.88 g, 13.4 mmol, 2.2 eq) in EtOH (12 cm³) were stirred at room temperature for 2 days and then at 80° C. for 8 h. The mixture was allowed to cool and the precipitated crystals were collected by filtration and dried in high vacuum line to give the product N′1,N′10-dihydroxydecanebis(imidamide) (1 g, 72.5%); mp 182° C.

### Reaction of 2-cyanoacetamide to give 3-amino-3-(hydroxyimino)propanamide

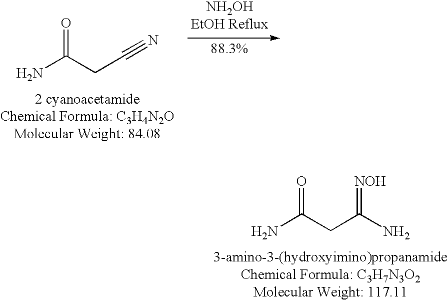

2-Cyanoacetamide (1 g, 11.9 mmol) and hydroxylamine (0.8 cm³, 13 mmol, 1.1 eq) in EtOH (6 cm³) were stirred under reflux for 2.5 hours. The solvents were removed under reduced pressure and the residue was washed with CH₂Cl₂ to give the product 3-amino-3-(hydroxyimino)propanamide (1.23 g, 88.3%) as a white solid, mp 159° C.

### Reaction of glycolonitrile to give N′,2-dihydroxyacetimidamide

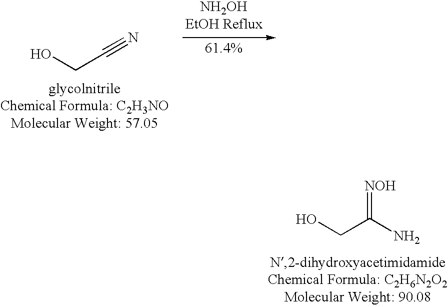

Glycolonitrile (1 g, 17.5 mmol) and hydroxylamine (50% in water, 2.15 cm³, 35 mmol, 2 eq) in EtOH (10 cm³) were stirred under reflux for 6 hours and then at room temperature for 24 hours. The solvent was evaporated and the residue was purified by column chromatography (silica, 1:3 EtOH—CH₂Cl₂) to give the product N′,2-dihydroxyacetimidamide (0.967 g, 61.4%) as an off-white solid, mp 63-65° C.

### Reaction of 5-hexynenitrile to give 4-cyano-N′-hydroxybutanimidamide

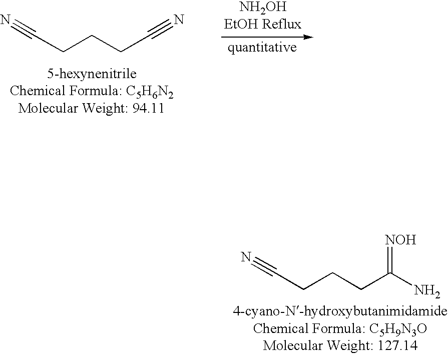

A solution of 5-hexynenitrile (0.93 g, 10 mmol) and hydroxylamine (50% in water, 1.22 cm³, 20 mmol) was stirred under reflux for 10 hours, after which volatiles were removed under reduced pressure to give the product 4-cyano-N′-hydroxybutanimidamide (1.30 g, 100%) as a white solid, mp 99.5-101° C.

### Reaction of iminodiacetonitrile to give 2,2′-azanediylbis(N′-hydroxyacetimidamide)

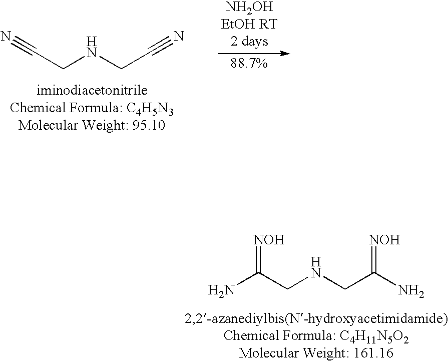

Commercial iminodiacetonitrile (Alfa-Aesar) was purified by dispersing the compound in water and extracting with dichloromethane, then evaporating the organic solvent from the extracts to give a white solid. Purified iminodiacetonitrile (0.82 g) and hydroxylamine (50% in water, 2.12 ml, 2.28 g, 34.5 mmol, 4 eq) in MeOH (6.9 ml) and water (6.8 ml) were stirred at room temperature for 48 hours. Evaporation of volatiles under reduced pressure gave a colorless liquid which was triturated with EtOH (40° C.) to give 2,2′-azanediylbis(N′-hydroxyacetimidamide) (1.23 g, 88.7%) as a white solid, mp 135-136° C., (lit mp 138° C.).

### Reaction of 3-methylaminopropionitrile to give N′-hydroxy-3-(methylamino)propanimidamide

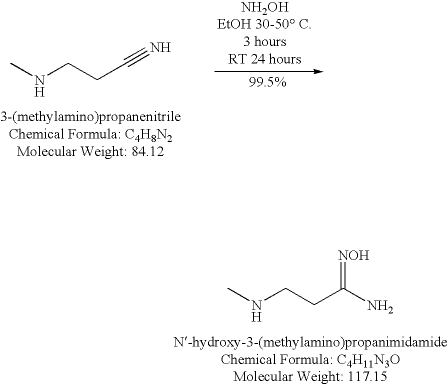

A solution of 3-methylaminopropionitrile (1 g, 11.9 mmol) and hydroxylamine (50% in water, 0.8 cm3, 0.864 g, 13.1 mmol, 1.1 eq) in EtOH (1 cm³) was stirred at 30-50° C. for 3 hours and then at room temperature overnight. The solvent was removed under reduced pressure (rotary evaporator followed by high vacuum line) to give the product N′-hydroxy-3-(methylamino)propanimidamide (1.387 g, 99.5%) as a thick pale yellow oil.

### Reaction of 3-(diethylamino)propanenitrile to give 3-(diethylamino)-N′-hydroxypropanimidamide

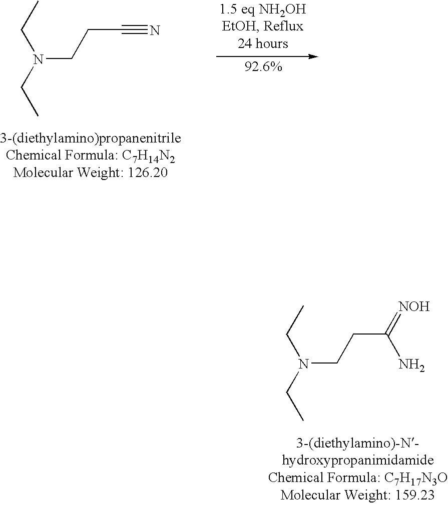

A solution of 3-(diethylamino)propanenitrile (1 g, 8 mmol) and NH₂OH (50% in water, 0.73 cm³, 11.9 mmol) in EtOH (10 cm³) were heated to reflux for 24 hours, after which the solvent and excess hydroxylamine were removed by rotary evaporator. The residue was freeze-dried and kept in high vacuum line until it slowly solidified to give give 3-(diethylamino)-N′-hydroxypropanimidamide (1.18 g, 92.6%) as a white solid, mp 52-54° C.

### Reaction of 3,3′,3″-nitrilotripropanenitrile with hydroxylamine to give 3,3′,3″-nitrilotris(N′-hydroxypropanimidamide)

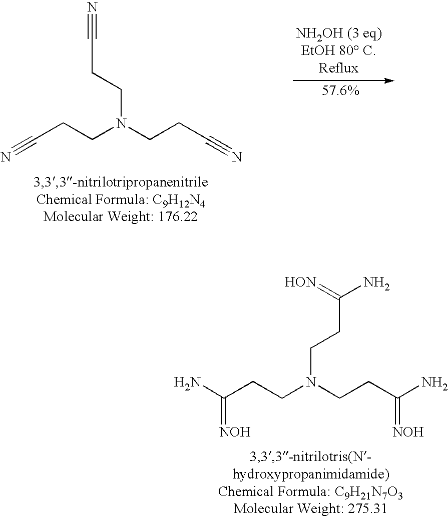

A solution of 3,3′,3″-nitrilotripropanenitrile (2 g, 11.35 mmol) and hydroxylamine (50% in water, 2.25 g, 34 mmol) in EtOH (25 cm³) was stirred at 80° C. overnight, then at room temperature for 24 hours. The white precipitate was collected by filtration and dried in high vacuum to give 3,3′,3″-nitrilotris(N′-hydroxypropanimidamide) (1.80 g, 57.6%) as a white crystalline solid, mp 195-197° C. (decomposed)

### Reaction of 3-(2-ethoxyethoxy)propanenitrile to give 3-(2-ethoxyethoxy)-N′-hydroxypropanimidamide

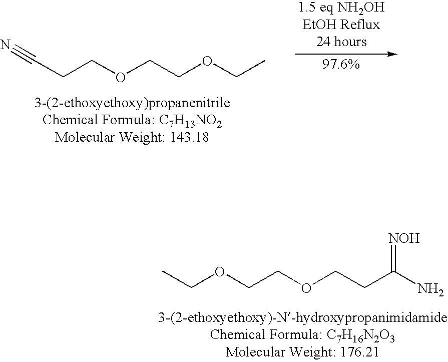

A solution of 3-(2-ethoxyethoxy)propanenitrile (1 g, 7 mmol) and NH₂OH (50% in water, 0.64 cm³, 10.5 mmol) in EtOH (10 cm³) were heated to reflux for 24 hours, after which the solvent and excess hydroxylamine were removed by rotary evaporator. The residue was freeze-dried and kept in high vacuum line for several hours to give 3-(2-ethoxyethoxy)-N′-hydroxypropanimidamide (1.2 g, 97.6%) as a colourless oil.

### Reaction of 3-(2-(2-(dimethylamino)ethoxy)ethoxy)propanenitrile to give 3-(2-(2-(dimethylamino)ethoxy)ethoxy)-N′-hydroxypropanimidamide

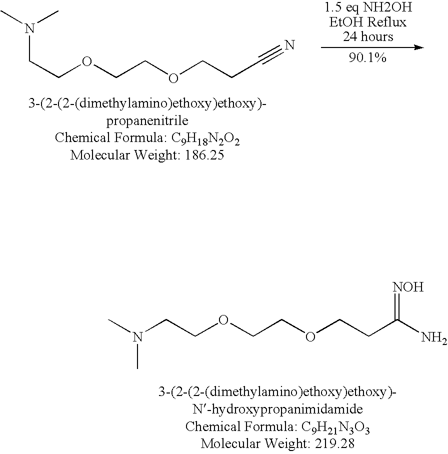

A solution of 3-(2-(2-(dimethylamino)ethoxy)ethoxy)propanenitrile (0.5 g, 2.68 mmol) and NH₂OH (50% in water, 0.25 cm³, 4 mmol) in EtOH (10 cm³) were stirred at 80° C. for 24 hours, after which the solvent and excess hydroxylamine were removed by rotary evaporator. The residue was freeze-dried and kept in high vacuum line for several hours to give give 3-(2-(2-(dimethylamino)ethoxy)ethoxy)-N′-hydroxypropanimidamide (0.53 g, 90.1%) as a light yellow oil.

### Reaction of 3,3′-(2,2′-(2-cyanoethylazanediyl)bis(ethane-2,1-diyl)bis(oxy))dipropanenitrile with hydroxylamine to give 3,3′-(2,2′-(3-amino-3-(hydroxyimino)propylazanediyl)bis(ethane-2,1-diyl))bis(oxy)bis(N′-hydroxypropanimidamide)

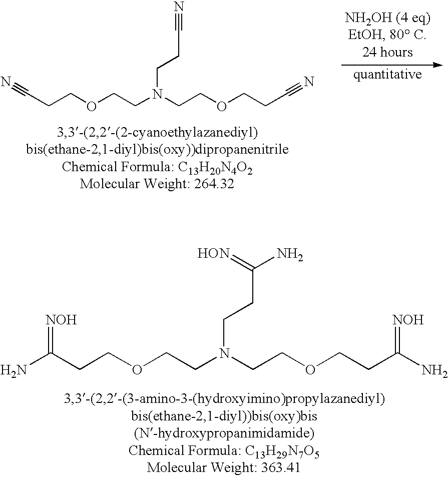

Treatment of 3,3′-(2,2′-(2-cyanoethylazanediyl)bis(ethane-2,1-diyl)bis(oxy))dipropanenitrile (0.8 g, 3 mmol) with NH₂OH (0.74 cm³, 12.1 mmol) in EtOH (8 cm³) gave 3,3′-(2,2′-(3-amino-3-(hydroxyimino)propylazanediyl)bis(ethane-2,1-diyl))bis(oxy)bis(N′-hydroxypropanimidamide) (1.09 g, 100%) as an oil.

### Reaction of iminodipropionitrile to give 3,3′-azanediylbis(N′-hydroxypropanimidamide)

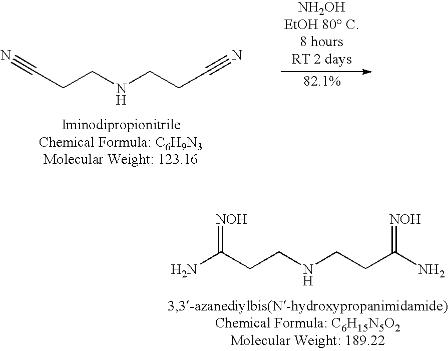

Iminodipropionitrile (1 g, 8 mmol) and hydroxylamine (50% in water, 1 cm³, 1.07 g, 16 mmol, 2 eq) in EtOH (8 cm³) were stirred at room temperature for 2 days and then at 80° C. for 8 hours. The mixture was allowed to cool and the precipitated crystals were collected by filtration and dried in high vacuum line to give the product 3,3′-azanediylbis(N′-hydroxypropanimidamide) (1.24 g, 82.1%) as a white solid, mp 180° C. (lit 160° C.

### Reaction of 3,3′,3″,3′″-(ethane-1,2-diylbis(azanetriyl))tetrapropanenitrile to give 3,3′,3″,3′″-(ethane-1,2-diylbis(azanetriyl))tetrakis(N′-hydroxypropanimidamide) to produce EDTA analogue

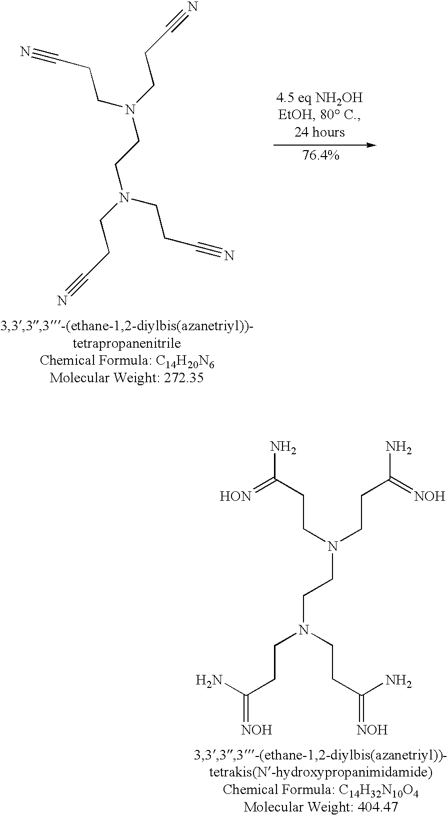

A solution of 3,3′,3″,3′″-(ethane-1,2-diylbis(azanetriyl))tetrapropanenitrile (1 g, 4 mmol) and NH₂OH (50% in water, 1.1 cm³, 18.1 mmol) in EtOH (10 cm³) was stirred at 80° C. for 24 hours and was then allowed to cool to room temperature. The solid formed was collected by filtration and dried under vacuum to give 3,3′,3″,3″′-(ethane-1,2-diylbis(azanetriyl))tetrakis(N′-hydroxypropanimidamide) (1.17 g, 76.4%) as a white solid, mp 191-192° C.

### Reaction of 3,3′-(2,2-bis((2-cyanoethoxy)methyl)propane-1,3-diyl)bis(oxy)dipropanenitrile with hydroxylamine to give 3,3′-(2,2-bis((3-(hydroxyamino)-3-iminopropoxy)methyl)propane-1,3-diyl)bis(oxy)bis(N-hydroxypropanimidamide)

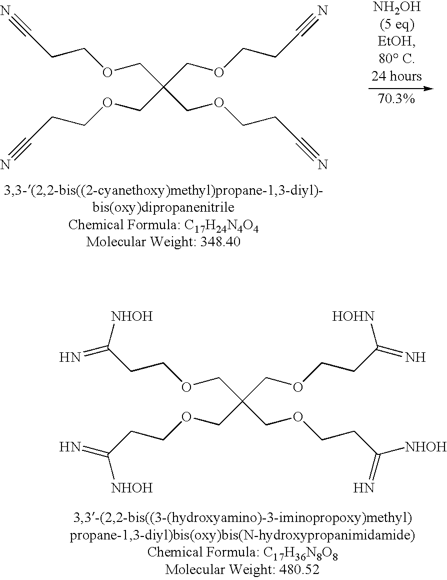

To a solution of 3,3′-(2,2-bis((2-cyanoethoxy)methyl)propane-1,3-diyl)bis(oxy)dipropanenitrile (1 g, 2.9 mmol) in EtOH (10 ml) was added NH2OH (50% in water, 0.88 ml, 0.948 g, 14.4 mmol), the mixture was stirred at 80° C. for 24 hours and was then cooled to room temperature. Evaporation of the solvent and excess NH2OH in the rotary evaporator followed by high vacuum for 12 hours gave 3,3′-(2,2-bis((3-(hydroxyamino)-3-iminopropoxy)methyl)propane-1,3-diyl)bis(oxy)bis(N-hydroxypropanimidamide) (0.98 g, 70.3%) as a white solid, mp 60° C.;

### Reaction of 3,3′-(2-cyanophenylazanediyl)dipropanenitrile with hydroxylamine to give 3,3′-(2-(N′-hydroxycarbamimidoyl)phenylazanediyl)bis(N′-hydroxypropanimidamide)

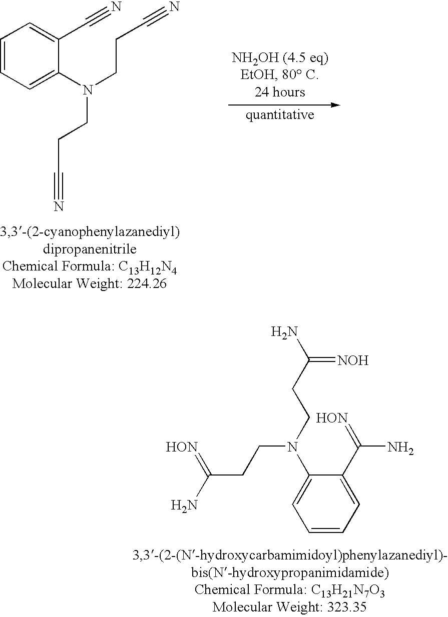

Treatment of 3,3′-(2-cyanophenylazanediyl)dipropanenitrile (1 g, 4.46 mmol) with NH2OH (1.23 ml, 20 mmol) in EtOH (10 ml) gave a crude product that was triturated with CH₂Cl₂ to give 3,3′-(2-(N′-hydroxycarbamimidoyl)phenylazanediyl)bis(N′-hydroxypropanimidamide) (1.44 g, 100%) as a solid, decomposed. 81° C.

### Reaction of N,N-bis(2-cyanoethyl)acetamide with hydroxylamine to Give N,N-bis(3-amino-3-(hydroxyimino)propyl)acetamide

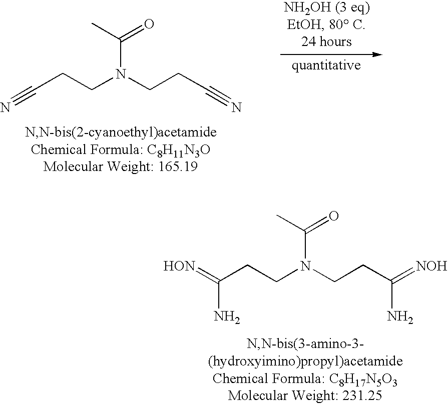

Treatment of N,N-bis(2-cyanoethyl)acetamide (0.5 g, 3.03 mmol) with NH₂OH (0.56 ml, 9.1 mmol) in EtOH (5 ml) gave N,N-bis(3-amino-3-(hydroxyimino)propyl)acetamide (0.564 g, 100%) as a white solid, mp 56.4-58° C.;

### Reaction of 3,3′-(2,2′-(methylazanediyl)bis(ethane-2,1-diyl)bis(oxy))dipropanenitrile with hydroxylamine to give 3,3′-(2,2′-(methylazanediyl)bis(ethane-2,1-diyl)bis(oxy))bis(N′-hydroxypropanimidamide)

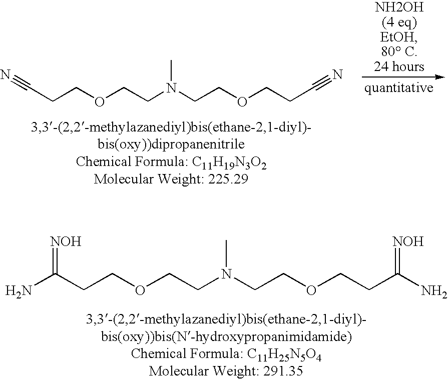

Treatment of 3,3′-(2,2′-(methylazanediyl)bis(ethane-2,1-diyl)bis(oxy))dipropanenitrile (1 g, 4.4 mmol) with NH₂OH (0.82 ml, 13.3 mmol) in EtOH (10 ml) gave 3,3′-(2,2′-(methylazanediyl)bis(ethane-2,1-diyl)bis(oxy))bis(N′-hydroxypropanimidamide) (1.28 g, 100%) as an oil.

### Reaction of Glycol Derivative 3,3′-(ethane-1,2-diylbis(oxy))dipropanenitrile to give 3,3′-(ethane-1,2-diylbis(oxy))bis(N′-hydroxypropanimidamide)

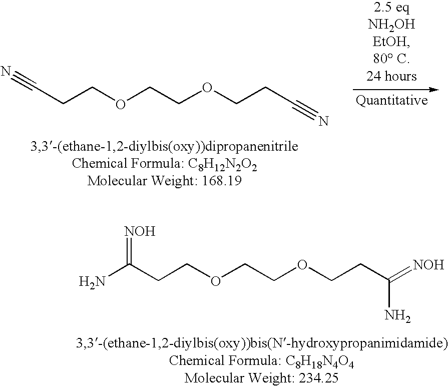

A solution of 3,3′-(ethane-1,2-diylbis(oxy))dipropanenitrile (1 g, 5 mmol) and NH₂OH (50% in water, 0.77 cm³, 12.5 mmol) in EtOH (10 cm³) was stirred at 80° C. for 24 hours and then at room temperature for 24 hours. The solvent and excess NH₂OH were evaporated off and the residue was freeze-dried to give 3,3′-(ethane-1,2-diylbis(oxy))bis(N′-hydroxypropanimidamide) (1.33 g, 100%) as a viscous oil.

### Reaction of 3,3′-(piperazine-1,4-diyl)dipropanenitrile to give 3,3′-(piperazine-1,4-diyl)bis(N′-hydroxypropanimidamide)

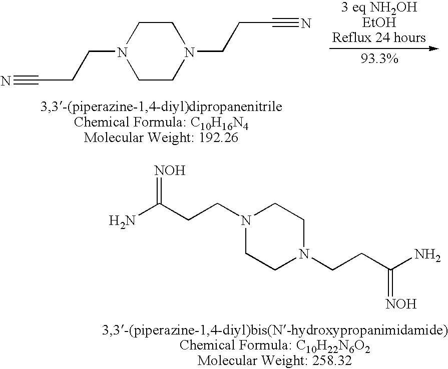

A solution of 3,3′-(piperazine-1,4-diyl)dipropanenitrile (1 g, 5.2 mmol) and NH₂OH (50% in water, 0.96 cm³, 15.6 mmol) in EtOH (10 cm³) were heated to reflux for 24 hours, after which the mixture was allowed to cool to room temperature. The solid formed was collected by filtration and dried in high vacuum line to give 3,3′-(piperazine-1,4-diyl)bis(N′-hydroxypropanimidamide) (1.25 g, 93.3%) as a white solid, deep 238° C. (brown colouration at >220° C.

### Reaction of cyanoethylated sorbitol compound with hydroxylamine to give 1,2,3,4,5,6-hexakis-O-[3-(hydroxyamino)-3-iminopropyl hexitol

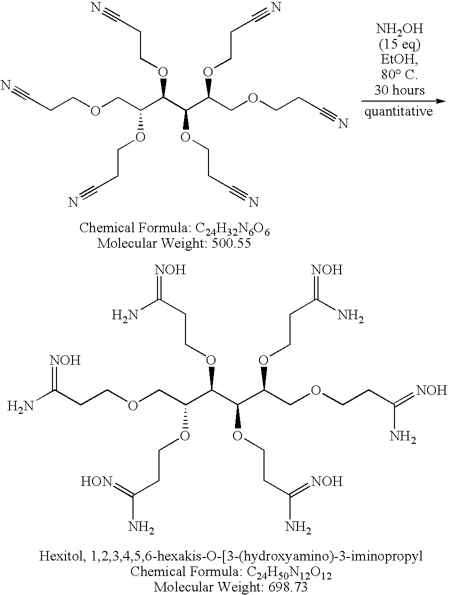

A solution of cyanoethylated product of sorbitol (0.48 g, 0.96 mmol) and NH₂OH (50% in water, 0.41 ml, 0.44 g, 6.71 mmol) in EtOH (5 ml) was stirred at 80° C. for 24 hours. Evaporation of solvent and NMR analysis of the residue showed incomplete conversion. The product was dissolved in water (10 ml) and EtOH (100 ml) and NH₂OH (0.5 g, 7.6 mmol) was added. The mixture was stirred at 80° C. for a further 7 hours. Removal of all volatiles after the reaction gave 1,2,3,4,5,6-hexakis-O-[3-(hydroxyamino)-3-iminopropyl hexitol, (0.67 g, 100%) as a white solid, mp 92-94° C. (decomposed)

### Reaction of Benzonitrile to give N′-hydroxybenzimidamide

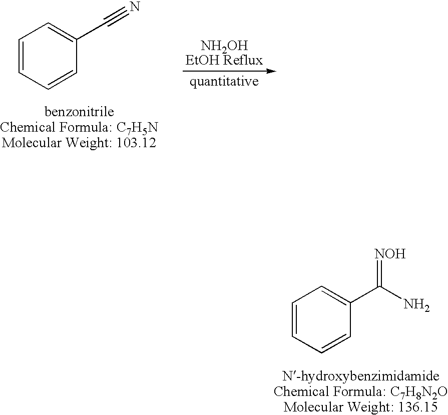

Benzonitrile (0.99 cm³, 1 g, 9.7 mmol) and hydroxylamine (50% in water, 0.89 cm³, 0.96 g, 14.55 mmol, 1.5 eq) were stirred under reflux in EtOH (10 cm³) for 48 hours. The solvent was evaporated under reduced pressure and water (10 cm³) was added to the residue. The mixture was extracted with dichloromethane (100 cm³) and the organic extract was evaporated under reduced pressure. The residue was purified by column chromatography to give the product N′-hydroxybenzimidamide (1.32 g, 100%) as a white crystalline solid, mp 79-81° C. (lit 79-80° C. This procedure is suitable for all starting materials bearing a benzene ring.

### Reaction of 3-phenylpropionitrile to give N′-hydroxy-3-phenylpropanimidamide

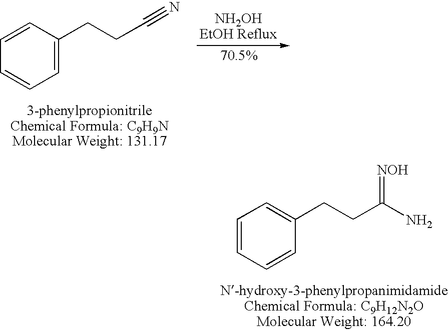

Phenylpropionitrile (1 g, 7.6 mmol) was reacted with hydroxylamine (50% in water, 0.94 cm³, 15.2 mmol, 2 eq) in EtOH (7.6 cm³) in the same manner as in the preparation of N′-hydroxybenzimidamide (EtOAc used in extraction) to give the product N′-hydroxy-3-phenylpropanimidamide (0.88 g, 70.5%) as a white solid, mp 42-43° C.

### Reaction of m-tolunitrile to give N′-hydroxy-3-methylbenzimidamide

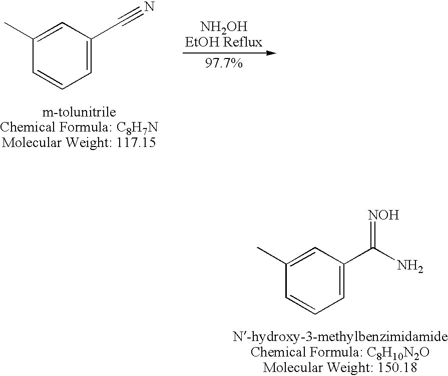

The reaction of m-Tolunitrile (1 g, 8.54 mmol) and hydroxylamine (0.78 cm³, 12.8 mmol, 1.5 eq) in EtOH (8.5 cm³) was performed in the same manner as in the preparation of N′-hydroxybenzimidamide, to give the product N′-hydroxy-3-methylbenzimidamide (1.25 g, 97.7%) as a white solid, mp 92° C. (lit 88-90° C.).

### Reaction of benzyl cyanide to give N′-hydroxy-2-phenylacetimidamide

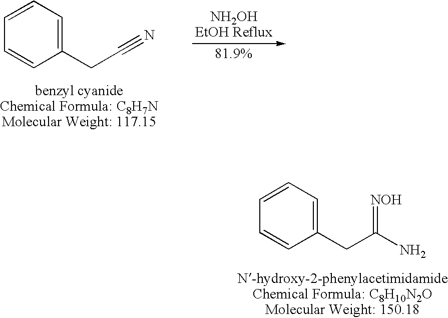

Benzyl cyanide (1 g, 8.5 mmol) and hydroxylamine (50% in water, 1.04 cm3, 17 mmol, 2 eq) in EtOH (8.5 cm³) were reacted in the same manner as in the preparation of N′-hydroxybenzimidamide (EtOAc used in extraction) to give the product N′-hydroxy-2-phenylacetimidamide (1.04 g, 81.9%) as a pale yellow solid, mp 63.5-64.5° C. (lit 57-59° C.).

### Reaction of anthranilonitrile to give 2-amino-N′-hydroxybenzimidamide

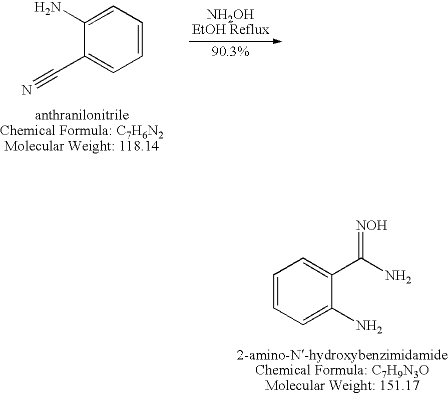

Anthranilonitrile (1 g, 8.5 mmol) and hydroxylamine (50% in water, 0.57 cm³, 9.3 mmol, 1.1 eq) in EtOH (42.5 cm³) were stirred under reflux for 24 hours, after which the volatiles were removed under reduced pressure and residue was partitioned between water (5 cm³) and CH₂Cl₂ (100 cm³). The organic phase was evaporated to dryness in the rotary evaporator followed by high vacuum line to give the product 2-amino-N′-hydroxybenzimidamide (1.16 g, 90.3%) as a solid, mp 85-86° C.

### Reaction of phthalonitrile to give isoindoline-1,3-dione dioxime

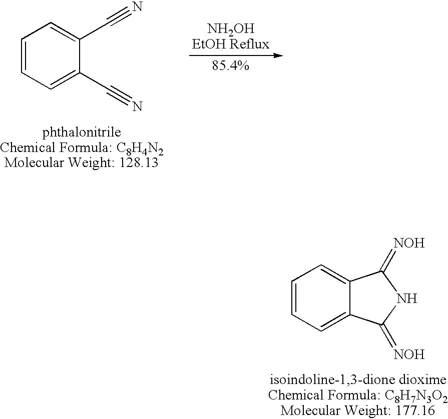

Phthalonitrile (1 g, 7.8 mmol) and hydroxylamine (1.9 cm³, 31.2 mmol, 4 eq) in EtOH (25 cm³) were stirred under reflux for 60 hours, after which the volatiles were removed under reduced pressure and the residue was washed with EtOH (2 cm³) and CH₂Cl₂ (2 cm³) to give the cyclised product isoindoline-1,3-dione dioxime (1.18 g, 85.4%) as a pale yellow solid, mp 272-275° C. (decomposed) (lit 271° C.).

### Reaction of 2-cyanophenylacetonitrile to give the cyclised product 3-aminoisoquinolin-1(4H)-one oxime or 3-(hydroxyamino)-3,4-dihydroisoquinolin-1-amine

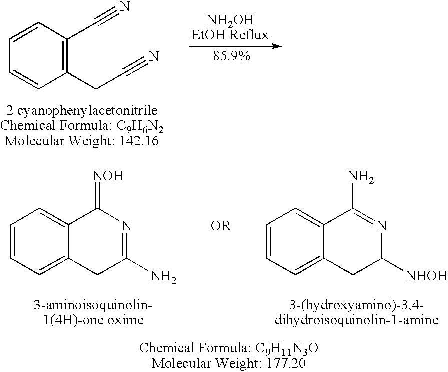

A solution of 2-cyanophenylacetonitrile (1 g, 7 mmol) and hydroxylamine (1.7 cm³, 28.1 mmol, 4 eq) in EtOH (25 cm³) were stirred under reflux for 60 hours, after which the volatiles were removed under reduced pressure. The residue was recrystallised from EtOH-water (1:4, 15 cm³) to give the cyclised product 3-aminoisoquinolin-1(4H)-one oxime or 3-(hydroxyamino)-3,4-dihydroisoquinolin-1-amine (1.15 g, 85.9%) as a solid, mp 92.5-94.5° C.

### Reaction of cinnamonitrile to give N′-hydroxycinnamimidamide

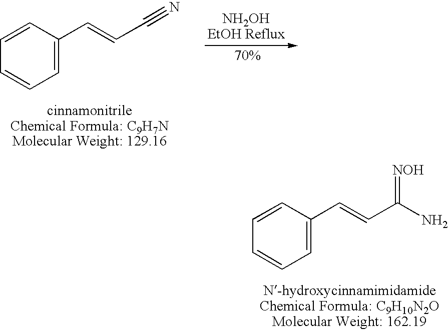

Cinnamonitrile (1 g, 7.74 mmol) and hydroxylamine (0.71 cm³, 11.6 mmol, 1.5 eq) were reacted in EtOH (7 cm³) as described for AO6 (two chromatographic separations were needed in purification) to give N′-hydroxycinnamimidamide (0.88 g, 70%) as a light orange solid, mp 85-87° C. (lit 93° C.).

### Reaction of 5-cyanophthalide to give the product N′-hydroxy-1-oxo-1,3-dihydroisobenzofuran-5-carboximidamide

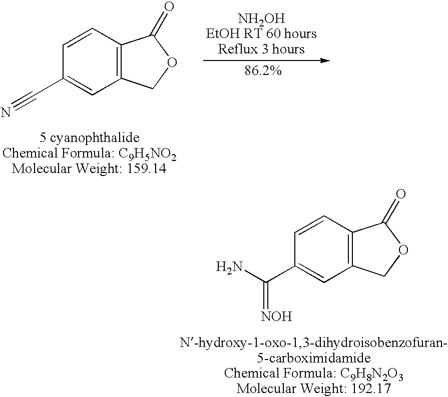

A solution of 5-cyanophthalide (1 g, 6.28 mmol) and hydroxylamine (50% in water, 0.77 cm³, 0.83 g, 12.6 mmol, 2 eq) in EtOH (50 cm³) was stirred at room temperature for 60 hours and then under reflux for 3 hours. After cooling to room temperature and standing overnight, the solid formed was collected by filtration and dried in high vacuum line to give the product N′-hydroxy-1-oxo-1,3-dihydroisobenzofuran-5-carboximidamide (1.04 g, 86.2%) as a white solid, mp 223-226° C. (decomposed).

### Reaction of 4-chlorobenzonitrile to give the product 4-chloro-N′-hydroxybenzimidamide

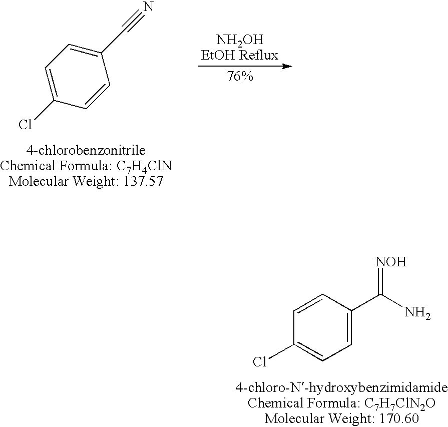

A solution of 4-chlorobenzonitrile (1 g, 7.23 mmol) and hydroxylamine (50% in water, 0.67 cm³, 10.9 mmol, 1.5 eq) in EtOH (12.5 cm³) was stirred under reflux for 48 hours. The solvent was removed under reduced pressure and the residue was washed with CH₂Cl₂ (10 cm³) to give the product 4-chloro-N′-hydroxybenzimidamide (0.94 g, 76%) as a white solid, mp 133-135° C.

### Reaction of 3-(phenylamino)propanenitrile to give N′-hydroxy-3-(phenylamino)propanimidamide

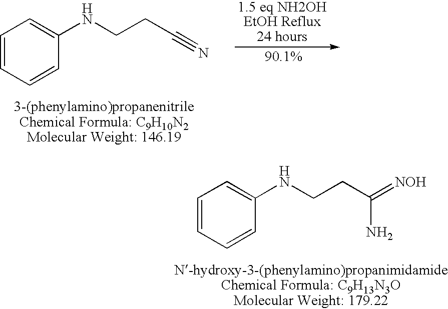

A solution of 3-(phenylamino)propanenitrile (1 g, 6.84 mmol) and NH₂OH (50% in water, 0.63 cm³, 10.26 mmol) in EtOH (10 cm³) were heated to reflux for 24 hours, after which the solvent and excess hydroxylamine were removed by rotary evaporator. To the residue was added water (10 cm³) and the mixture was extracted with CH₂Cl₂ (100 cm³). The extracts were concentrated under reduced pressure and the residue was purified by column chromatography (silica, Et₂O) to give N′-hydroxy-3-(phenylamino)propanimidamide (0.77 g, 62.8%) as a white solid, mp 93-95° C. (lit mp 91-91.5° C.).

### Reaction of 4-pyridinecarbonitrile to give the product N′-hydroxyisonicotinimidamide

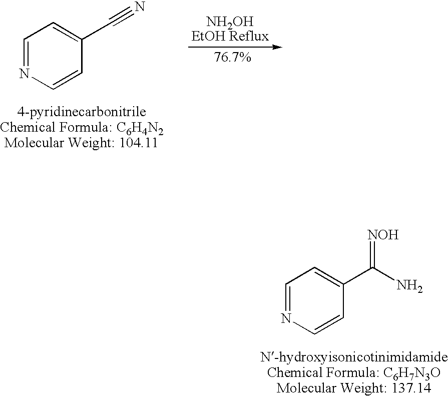

Pyridinecarbonitrile (1 g, 9.6 mmol) and hydroxylamine (50% in water, 0.88 cm³, 14.4 mmol, 1.5 eq) in EtOH (10 cm³) were stirred under reflux for 18 hours, after which the volatiles were removed under reduced pressure and the residue was recrystallised from EtOH to give the product N′-hydroxyisonicotinimidamide (1.01 g, 76.7%) as a solid, mp 203-205° C.

### Cyanoethylation of Sorbitol to produce multi substituted-(2-amidoximo)ethoxy)hexane (Sorbitol:Acrylonitrile=1:1 DS1)

A one-liter three-necked round-bottomed flask was equipped with a stirrer, reflux condenser, thermometer, and addition funnel under nitrogen. Lithium hydroxide monohydrate (1.0 g, 23.8 mmol, 0.036 eq) dissolved in water (18.5 ml) was added to the flask, followed by the addition of sorbitol (120 g, 659 mmol) in one portion, and then water (100 ml). The solution was warmed to 42° C. in a water bath and treated with acrylonitrile (43.6 ml, 659 mmol), drop-wise via the addition funnel for a period of 2 hr, while maintaining the temperature at 42° C. After the addition was complete, the solution was warmed to 50-55° C. for 4 hr and then allowed to cool to room temperature. The reaction was neutralized by addition of acetic acid (2.5 ml) and allowed to stand overnight at room temperature. The solution was evaporated under reduced pressure to give the product as a clear, viscous oil (155.4 g). Tetramethylammonium hydroxide can be used as a substitute for lithium hydroxide. Elemental analysis: Found, 40.95% C; 3.85% N. The IR spectrum showed a peak at 2255 cm⁻¹ indicative of a nitrile group.

### Cyanoethylation of Sorbitol to produce multi substituted-(2-amidoximo)ethoxy)hexane (Sorbitol:Acrylonitrile=1:3 DS3)

A one liter three-neck round-bottomed flask was equipped with a mechanical stirrer, reflux condenser, thermometer, and 100 ml addition funnel under nitrogen. Lithium hydroxide (1.0 g, 23.8 mmol, 0.036 eq) dissolved in water (18.5 ml) was added to the flask, followed by the addition of the first portion of sorbitol (60.0 g, 329 mmol) and then water (50 ml). The solution was warmed to 42° C. in a water bath and treated with acrylonitrile (42 ml, 633 mmol, 0.96 eq) drop-wise via the addition funnel for a period of 1 hr while maintaining the temperature at 42° C. The second portion of sorbitol (60 g, 329 mmol) and water (50 ml) were added to the flask. The second portion of the acrylonitrile (89.1 ml, 1.344 mol), was added in a drop-wise fashion over a period of 1 hr. After the addition was complete, the solution was warmed to 50-55° C. for 4 hr and then allowed to cool to room temperature. The reaction was neutralized by addition of acetic acid (2.5 ml) and allowed to stand overnight at room temperature. The solution was evaporated under reduced pressure to give the product as a clear, viscous oil (228.23 g). Tetramethylammonium hydroxide can be used as a substitute for lithium hydroxide. Elemental analysis: Found: 49.16% C; 10.76% N. The IR spectrum showed a peak at 2252 cm⁻¹ indicative of a nitrile group.

### Cyanoethylation of Sorbitol to produce multi substituted-(2-amidoximo)ethoxy)hexane (Sorbitol:Acrylonitrile=1:6 DS6)

A 1000 ml 3-necked round-bottomed flask equipped with an mechanical stirrer, reflux condenser, nitrogen purge, dropping funnel, and thermometer was charged with water (18.5 ml) and lithium hydroxide monohydrate (1.75 g) and the first portion of sorbitol (44.8 g). The solution was heated to 42° C. with a water bath with stirring and the second portion of sorbitol (39.2 g) was added directly to the reaction flask. The first portion of acrylonitrile (100 ml) was then added to the reaction drop-wise via a 500 ml addition funnel over a period of 2 hr. The reaction was slightly exothermic, raising the temperature to 51° C. The final portion of sorbitol (32 g) was added for a total of 0.638 moles followed by a final portion of acrylonitrile (190 ml) over 2.5 hr keeping the reaction temperature below 60° C. (A total of 4.41 moles of acrylonitrile was used.) The reaction solution was then heated to 50-55° C. for 4 hr. The solution was then allowed to cool to room temperature and the reaction was neutralized by addition of acetic acid (2.5 ml). Removal of the solvent under reduced pressure gave the product as a clear, viscous oil (324 g). Tetramethylammonuium hydroxide can be used as a substitute for lithium hydroxide. The IR spectrum showed a peak at 2251 cm⁻¹, indicative of a nitrile group.

### Preparation of (1,2,3,4,5,6-(hexa-(2-amidoximo)ethoxy)hexane hexitol

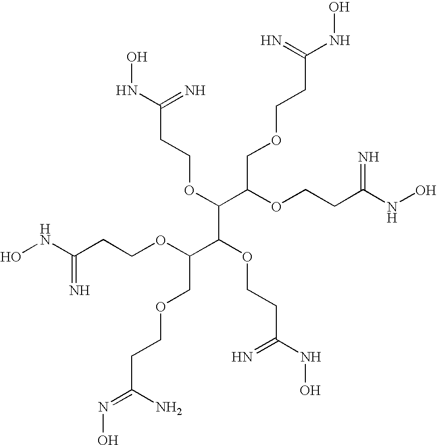

A 1000 mL three-necked round-bottomed flask was equipped with a mechanical stirrer, condenser, and addition funnel under nitrogen. DS6 (14.77 g, 29.5 mmol) and water (200 mL) were added to the flask and stirred. In a separate 500 mL Erlenmeyer flask, hydroxylamine hydrochloride (11.47 g, 165 mmol, 5.6 eq) was dissolved in water (178 ml) and then treated with ammonium hydroxide (22.1 ml of 28% solution, 177 mmol, 6.0 eq) for a total volume of 200 mL. The hydroxylamine solution was then added in one portion directly to the mixture in the round-bottomed flask at room temperature. The stirred mixture was heated at 80° C. for 2 hr, pH=8-9, and then allowed to cool to room temperature. Hydroxylamine freebase (50%) aqueous solution can be used to replace the solution by blending hydroxylamine chloride and ammonium hydroxide. The IR spectrum indicated loss of most of the nitrile peak at 2250 cm⁻¹ and the appearance of a new peak at 1660 cm⁻¹, indicative of the amidoxime or hydroxamic acid.

Preparation and analysis of polyamidoxime is essentially that described in U.S. Pat. No. 3,345,344, which is incorporated herein by reference in its entirety. In that process 80 parts by weight of polyacrylonitrile of molecular weight of about 130,000 in the form of very fine powder (−300 mesh) was suspended in a solution of 300 parts by weight of hydroxylammonium sulfate, 140 parts by weight of sodium hydroxide and 2500 parts by weight of deionized water. The pH of the solution was 7.6. The mixture was heated to 90° C. and held at that temperature for 12 hours, all of the time under vigorous agitation. It was cooled to 35° C. and the product filtered off and washed repeatedly with deionized water. The resin remained insoluble throughout the reaction, but was softened somewhat by the chemical and heat. This caused it to grow from a very fine powder to small clusters of 10 to 20 mesh. The product weighed 130 grams. The yield is always considerably more than theoretical because of a firmly occluded salt. The product is essentially a poly-amidoxime having the following reoccurring unit

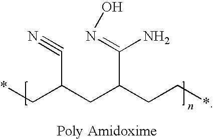

The following structure depicts mental complexing using amidoxime compounds.

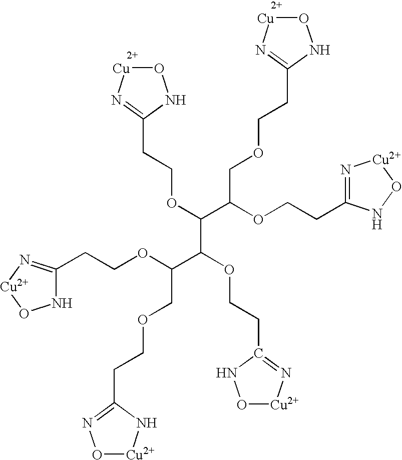

Amidoxime chelating agents can substitute for organic carboxylic acids, organic carboxylic ammonium salts or amine carboxylates in their use in cleaning formulations and processes.

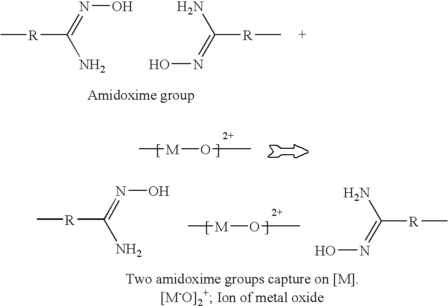

In an exemplary embodiment, the FEOL stripping and cleaning compositions of the present invention for stripping-cleaning ion-implanted wafer substrates comprise a) an amidoxime compound, b) at least one organic stripping solvent, and c) water.

The FEOL stripping and cleaning compositions of this invention may additionally comprise one or more components such as acids, bases, surfactants and other chelating agents.

With reference to the present invention, as hereinafter more fully described, the claimed compounds can be applied to applications in the state of the art forming a background to the present invention, which includes the following U.S. patents, the disclosures of which are hereby incorporated herein, in their respective entireties.

### Example of Embodiments of the Present Invention

In an exemplary embodiment, the compositions comprising an amidoxime compound are further diluted with water prior to removing residue from a substrate, such as during integrated circuit fabrication. In a particular embodiment, the dilution factor is from about 10 to about 500.

### Example 1

The patents and publications referred to in the specification are hereby incorporated by reference in their entireties. An exemplary embodiment involves a method for removing organometallic and organosilicate residues remaining after a dry etch process from semiconductor substrates. The substrate is exposed to a conditioning solution of phosphoric acid, hydrofluoric acid, and a carboxylic acid, such as acetic acid, which removes the remaining dry etch residues while minimizing removal of material from desired substrate features. The approximate proportions of the conditioning solution are typically 80 to 95 percent by weight amidoxime compound and acetic acid, 1 to 15 percent by weight phosphoric acid, and 0.01 to 5.0 percent by weight hydrofluoric acid. See, U.S. Pat. No. 7,261,835.

Another exemplary embodiment includes from about 0.5% to about 24% by weight of complexing agents with amidoxime functional groups with an aqueous semiconductor cleaning solution having a pH between about 1.5 and about 6 and comprising: at least about 75% by weight of a mixture of water and an organic solvent; from about 0.5% to about 10% by weight phosphoric acid; optionally one or more other acid compounds; optionally one or more fluoride-containing compounds; and at least one alkaline compound selected from the group consisting of: a trialkylammonium hydroxide and/or a tetraalkylammonium hydroxide; a hydroxylamine derivative; and one or more alkanolamines.

### Example 2

Table 1 lists other exemplary embodiments of the present invention where the formulations additionally include from about 0.5% to about 24% by weight of compounds with amidoxime functional groups in aqueous semiconductor cleaning solutions. Such formulations may contain additional components consistent with this application such as surfactants, alkaline components, and organic solvents.

TABLE 1
Exemplary Formulations with Chelating Agents for Use
with Amidoxime Compounds

| H₃PO₄ (wt %) | Other Acid | wt % |
|---|---|---|
| 2 | methanesulfonic | 1.47 |
| 2 | pyrophosphoric acid (PPA) | 3.0 |
| 2 | Fluorosicilic | 0.24 |
| 2 | Oxalic | 2.0 |
| 4 | Oxalic | 2.0 |
| 6 | Glycolic | 1.0 |
| 3 | Oxalic | 2.0 |
| 3 | Lactic | 2.0 |
| 4 | Lactic | 2.0 |
| 3 | Citric | 2.0 |
| 4 | Citric | 2.0 |
| 3 | PPA | 0.5 |
| 3 | Glycolic | 2.0 |
| 6 | Glycolic | 2.0 |
| 3 | PPA | 2.0 |
| 3 | PPA | 4.0 |

### Example 3

Another exemplary embodiment is a composition for cleaning or etching a semiconductor substrate and method for using the same. The compositions include from about 0.01% to about 50%, more preferably about 0.5% to about 24% by weight of compounds with amidoxime functional groups may include a fluorine-containing compound as an active agent such as a quaternary ammonium fluoride, a quaternary phosphonium fluoride, sulfonium fluoride, more generally an-onium fluoride or “multi” quaternary-onium fluoride that includes two or more quaternary-onium groups linked together by one or more carbon-containing groups. The composition may further include a pH adjusting acid such as a mineral acid, carboxylic acid, dicarboxylic acid, sulfonic acid, or combination thereof to give a pH of about 2 to 9. The composition can be anhydrous and may further include an organic solvent such as an alcohol, amide, ether, or combination thereof. The compositions are useful for obtaining improved etch rate, etch selectivity, etch uniformity and cleaning criteria on a variety of substrates.

### Example 4

In another exemplary embodiment, the present invention can be used with methods and compositions for removing silicon-containing sacrificial layers from Micro Electro Mechanical System (MEMS) and other semiconductor substrates having such sacrificial layers is described. The etching compositions include a supercritical fluid (SCF), an etchant species, a co-solvent, chelating agent containing at least one amidoxime group, and optionally a surfactant. Such etching compositions overcome the intrinsic deficiency of SCFs as cleaning reagents, viz., the non-polar character of SCFs and their associated inability to solubilize polar species that must be removed from the semiconductor substrate. The resultant etched substrates experience lower incidents of stiction relative to substrates etched using conventional wet etching techniques. See U.S. Pat. No. 7,160,815.

### Example 5

In another exemplary embodiment, the invention uses a supercritical fluid (SFC)-based composition, comprising at least one co-solvent, at least one etchant species, and optionally at least one surfactant, wherein said at least one etchant comprises an alkyl phosphonium difluoride and wherein said SFC-based composition is useful for etching sacrificial silicon-containing layers, said compositions containing from about 0.01% to about 50% by weight, preferably about 0.5% to about 24%, of compounds with one or more chelating group, at least one being an amidoxime functional groups. In another embodiment the surfactant comprises at least one nonionic or anionic surfactant, or a combination thereof, and the surfactant is preferably a nonionic surfactant selected from the group consisting of fluoroalkyl surfactants, polyethylene glycols, polypropylene glycols, polyethylene ethers, polypropylene glycol ethers, carboxylic acid salts, dodecylbenzenesulfonic acid; dodecylbeuzenesulfonic salts, polyaciylate polymers, dinonylphenyl polyoxyethylene, silicone polymers, modified silicone polymers, acetylenic diols, modified acetylenic diols, alkylammonium salts, modified alkylammonium salts, and combinations comprising at least one of the foregoing.

### Example 6

Another exemplary embodiment of the present invention is a composition for use in semiconductor processing wherein the composition comprises water, phosphoric acid, and an organic acid; wherein the organic acid is ascorbic acid or is an organic acid having two or more carboxylic acid groups (e.g., citric acid). The said compositions containing from about 0.01% to about 50% by weight, preferably about 0.5% to about 24%, of compounds with one or more chelating groups/agents, at least one being an amidoxime functional group/compound and such compounds can be in addition to, part of, or in substitution of the organic acid. The water can be present in about 40 wt. % to about 85 wt. % of the composition, the phosphoric acid can be present in about 0.01 wt. % to about 10 wt. % of the composition, and the organic acid can be present in about 10 wt. % to about 60 wt. % of the composition. The composition can be used for cleaning various surfaces, such as, for example, patterned metal layers and vias by exposing the surfaces to the composition. See U.S. Pat. No. 7,135,444.

### Example 7

The present invention can also be used with a polishing liquid composition for polishing a surface, with one embodiment comprising an insulating layer and a metal layer, the polishing liquid composition comprising a compound having six or more carbon atoms and a structure in which each of two or more adjacent carbon atoms has a hydroxyl group in a molecule, and water, wherein the compound having a structure in which each of two or more adjacent carbon atoms has a hydroxyl group in a molecule is represented by the formula (I): R¹—X—(CH₂)_{q}—[CH(OH)]—CH₂OH (I) wherein R¹ is a hydrocarbon group having 1 to 12 carbon atoms; X is a group represented by (CH₂)ₘ, wherein m is 1, oxygen atom, sulfur atom, COO group, OCO group, a group represented by NR² or O(R²O)P(O)O, wherein R² is hydrogen atom or a hydrocarbon group having 1 to 24 carbon atoms; q is 0 or 1; and n is an integer of 1 to 4, further comprising from about 0.01% to about 50% by weight, preferably about 0.5% to about 24%, of compounds with one or more chelating groups/agents, at least one being an amidoxime functional group/compound and such compounds can be in addition to, part of, or in substitution of an organic acid. Some embodiments includes an abrasive. See U.S. Pat. No. 7,118,685.

### Example 8

Another exemplary embodiment of the present invention is a composition for use in semiconductor processing wherein the composition comprises water, phosphoric acid, and an organic acid; wherein the organic acid is ascorbic acid or is an organic acid having two or more carboxylic acid groups (e.g., citric acid), further comprising from about 0.01% to about 50% by weight, preferably about 0.5% to about 24%, of compounds with one or more chelating groups/agents, at least one being an amidoxime functional group/compound and such compounds can be in addition to, part of, or in substitution of the organic acid. The water can be present in about 40 wt. % to about 85 wt. % of the composition, the phosphoric acid can be present in about 0.01 wt. % to about 10 wt. % of the composition, and the organic acid can be present in about 10 wt. % to about 60 wt. % of the composition. The composition can be used for cleaning various surfaces, such as, for example, patterned metal layers and vias by exposing the surfaces to the composition. See U.S. Pat. Nos. 7,087,561; 7,067,466; and 7,029,588.

### Example 9

In another exemplary embodiment of the present invention, from about 0.01% to about 50% by weight, preferably about 0.5% to about 24%, of compounds with one or more chelating groups/agents, at least one being an amidoxime functional group/compound can be used with an oxidizing solution and process for the in situ oxidation of contaminants, including hydrocarbon, organic, bacterial, phosphonic acid, and other contaminants, the contaminants being found in various surfaces and media, including soil, sludge, and water. In a preferred embodiment, the solution further includes a peroxygen compound, such as hydrogen peroxide, in solution with a pre-mixed solution of a carboxylic acid and a halogen salt, such as glycolic acid and sodium bromide, respectively.

### Example 10

In another exemplary embodiment of the present invention, from about 0.01% to about 5% by weight, preferably about 0.01 to about 0.1% of compounds with one or more chelating groups/agents, at least one being an amidoxime functional group/compound can be used with a chemical mechanical polishing slurry that is free of heteropolyacid and consisting essentially of about 3 to about 5 percent abrasive, about 3 to about 5 percent hydrogen peroxide, about 0.05 to about 0.1 percent citric acid, about 0.05 to about 0.5 percent iminodiacetic acid, about 0.005 to about 0.02 percent ammonia, and about 85-90 percent water, wherein the abrasive consists essentially of polymethylmethacrylate. See U.S. Pat. No. 7,029,373.

### Example 11

Another exemplary embodiment of the present invention is a non-corrosive cleaning composition for removing residues from a substrate comprising: (a) water; (b) at least one hydroxyl ammonium compound; (c) at least one basic compound, preferably selected from the group consisting of amines and quaternary ammonium hydroxides; (d) at least one organic carboxylic acid; (e) from about 0.01% to about 50% by weight, preferably about 0.5% to about 24%, of compounds with one or more chelating groups/agents, at least one being an amidoxime functional group/compound and such compounds can be in addition to, part of, or in substitution of the organic acid; and (f) optionally, a polyhydric compound. The pH of the composition is preferably between about 2 to about 6. See U.S. Pat. No. 7,001,874.

### Example 12

The present invention may also be used with a cleaning solution where the cleaning solution also contains one of polyvalent carboxylic acid and its salt, such as where the polyvalent carboxylic acid contains at least one selected from the group consisting of oxalic acid, citric acid, malic acid, maleic acid, succinic acid, tartaric acid, and malonic acid, wherein the cleaning solution contains from about 0.01% to about 50% by weight, preferably about 0.5% to about 24%, of compounds with one or more chelating groups/agents, at least one being an amidoxime functional group/compound and such compounds can be in addition to, part of, or in substitution of the organic acid, which can be used in addition to, as part of, or in substitution of the polyvalent carboxylic acid. In another embodiment, the cleaning solution further contains a polyamino carboxylic acid and its salt. See U.S. Pat. No. 6,998,352.

### Example 13

A further exemplary embodiment of the present invention is a method of chemically-mechanically polishing a substrate, which method comprises: (i) contacting a substrate comprising at least one layer of ruthenium and at least one layer of copper with a polishing pad and a chemical-mechanical polishing composition comprising: (a) an abrasive consisting of .alpha.-alumina treated with a negatively-charged polymer or copolymer, (b) hydrogen peroxide, (c) from about 0.01% to about 50% by weight, preferably about 0.5% to about 24% of compounds with one or more chelating groups/agents, at least one being an amidoxime functional group/compound; (d) at least one heterocyclic compound, wherein the at least one heterocyclic compound comprises at least one nitrogen atom, (e) a phosphonic acid, and (f) water, (ii) moving the polishing pad relative to the substrate, and (iii) abrading at least a portion of the substrate to polish the substrate, wherein the pH of the water and any components dissolved or suspended therein is about 6 to about 12, wherein the at least one layer of ruthenium and at least one layer of copper are in electrical contact and are in contact with the polishing composition, wherein the difference between the open circuit potential of copper and the open circuit potential of ruthenium in the water and any components dissolved or suspended therein is about 50 mV or less, and wherein a selectivity for polishing copper as compared to ruthenium is about 2 or less.

### Example 14

Another exemplary embodiment of the present invention is to a semiconductor wafer cleaning formulation, including 1-21% wt. fluoride source, 20-55% wt. organic amine(s), 0.5-40% wt. nitrogenous component, e.g., a nitrogen-containing carboxylic acid or an imine, 23-50% wt. water, and 0-21% wt. of compounds with one or more chelating groups/agents, at least one being an amidoxime functional group/compound. The formulations are useful to remove residue from wafers following a resist plasma ashing step, such as inorganic residue from semiconductor wafers containing delicate copper interconnecting structures. See U.S. Pat. No. 6,967,169.

### Example 15

The present invention also includes a method for chemical mechanical polishing copper, barrier material and dielectric material, the method comprises the steps of: a) providing a first chemical mechanical polishing slurry comprising (i) 1-10 wt. % silica particles, (ii) 1-12 wt. % oxidizing agent, and (iii) 0-2 wt. % corrosion inhibitor and cleaning agent, wherein said first slurry has a higher removal rate on copper relative to a lower removal rate on said barrier material; b) chemical mechanical polishing a semiconductor wafer surface with said first slurry; c) providing a second chemical mechanical polishing slurry comprising (i) 1-10 wt. % silica particles, (ii) 0.1-1.5 wt. % oxidizing agent, and (iii) 0.1-2 wt. % carboxylic acid, having a pH in a range from about 2 to about 5, wherein the amount of (ii) is not more than the amount of (iii), and wherein said second slurry has a higher removal rate on said barrier material relative to a lower removal rate on said dielectric material and an intermediate removal rate on copper; and d) chemical mechanical polishing said semiconductor wafer surface with said second slurry, wherein either or both slurries contains from about 0.01% to about 50% by weight, preferably about 0.5% to about 24%, of compounds with one or more chelating groups/agents, at least one being an amidoxime functional group/compound. See U.S. Pat. No. 6,936,542.

### Example 16

The present invention further includes a method for cleaning a surface of a substrate, which comprises at least the following steps (1) and (2), wherein the step (2) is carried out after carrying out the step (1): Step (1): A cleaning step of cleaning the surface of the substrate with an alkaline cleaning agent containing a complexing agent, and Step (2): A cleaning step employing a cleaning agent having a hydrofluoric acid content C (wt %) of from 0.03 to 3 wt %, the complexing agent is from about 0.01% to about 50% by weight, preferably about 0.5% to about 24%, of compounds with one or more chelating groups/agents, at least one being an amidoxime functional group/compound. See U.S. Pat. No. 6,896,744.

### Example 17

Another exemplary embodiment of the present invention is a cleaning gas that is obtained by vaporizing a carboxylic acid and/or a compound with one or more chelating groups/agents, at least one being an amidoxime functional group/compound which is supplied into a treatment chamber having an insulating substance adhering to the inside thereof, and the inside of the treatment chamber is evacuated. When the cleaning gas supplied into the treatment chamber comes in contact with the insulating substance adhering to an inside wall and a susceptor in the treatment chamber, the insulating substance is turned into a complex, so that the complex of the insulating substance is formed. The complex of the insulating substance is easily vaporized due to its high vapor pressure. The vaporized complex of the insulating substance is discharged out of the treatment chamber by the evacuation. See U.S. Pat. No. 6,893,964.

### Example 18

The present invention includes a method for rinsing metallized semiconductor substrates following treatment of the substrates with an etch residue removal chemistry, the method comprising the steps of: providing at least one metallized semiconductor substrate, the substrate having etch residue removal chemistry thereon, wherein the etch residue removal chemistry includes N-methylpyrrolidinone; rinsing the etch residue removal chemistry from the substrate and minimizing metal corrosion of the substrate by rinsing the substrate with an aqueous medium comprising an anti-corrosive agent including an organic acid selected from the group consisting of mono- and polycarboxylic acids in an amount effective to minimize metal corrosion; removing the aqueous medium from the process vessel; and introducing a drying vapor into the process vessel which the substrate remains substantially stationary within the process vessel, wherein the remover includes from about 0.01% to about 50% by weight, preferably about 0.5% to about 24%, of compounds with one or more chelating groups/agents, at least one being an amidoxime functional group/compound, which can be in addition to, part of, or in substitution of the organic acid. The composition may further include acetic acid. See U.S. Pat. No. 6,878,213.

### Example 19

The present invention may also be used with the compositions of U.S. Pat. No. 6,849,200 wherein the iminodiacetic acid component is supplemented by or substituted with compounds with one or more chelating groups/agents, at least one being an amidoxime functional group/compound.

### Example 20

The present invention also includes a method of cleaning a surface of a copper-containing material by exposing the surface to an acidic mixture comprising NO₃⁻, F⁻, and one or more compounds with one or more chelating groups/agents, at least one being an amidoxime functional group/compound. The mixture may also include one or more organic acids to remove at least some of the particles. See U.S. Pat. No. 6,835,668.

### Example 21

The present invention also includes a cleaning composition comprising at least one of fluoride salts and hydrogendifluoride salts; an organic solvent having a heteroatom or atoms; optionally one or more surfactants in an amount of from 0.0001 to 10.0%; water and from about 0.01% to about 50% by weight, preferably about 0.5% to about 24%, of compounds with one or more chelating groups/agents, at least one being an amidoxime functional group/compound. See U.S. Pat. No. 6,831,048.

### Example 22

The present invention further includes a glycol-free composition for cleaning a semiconductor substrate, the composition consisting essentially of: a. an acidic buffer solution having an acid selected from a carboxylic acid and a polybasic acid and an ammonium salt of the acid in a molar ratio of acid to ammonium salt ranging from 10:1 to 1:10 and wherein the acidic buffer solution is present in an amount sufficient to maintain a pH of the composition from about 3 to about 6, b. from 30% by weight to 90% by weight of an organic polar solvent that is miscible in all proportion in water, c. from 0.1% by weight to 20% by weight of fluoride, d. from 0.5% by weight to 40% by weight of water, and e. optionally up to 15% by weight of a corrosion inhibitor. The composition further contains from about 0.01% to about 50% by weight, preferably about 0.5% to about 24%, of compounds with one or more chelating groups/agents, at least one being an amidoxime functional group/compound or such compounds may be used in place of the corrosion inhibitor. See U.S. Pat. No. 6,828,289.

### Example 23

The present invention further includes compositions containing AEEA and or AEEA derivatives which can be present in an amount ranging from about 1% to about 99%, though in most instances the amount ranges from about 10% to about 85%. For each AEEA range given for various compositions described herein, there is a “high-AEEA” embodiment where the amount of AEEA is in the upper half of the range, and a “low-AEEA” embodiment where AEEA is present in an amount bounded by the lower half of the range. Generally, the higher AEEA embodiments exhibit lower etch rates than the low AEEA embodiments for selected substrates, the embodiments further include from about 0.01% to about 50% by weight, preferably about 0.5% to about 24%, of compounds with one or more chelating groups/agents, at least one being an amidoxime functional group/compound. In most embodiments, these compositions also include other compounds, particularly polar organic solvents, water, alkanolamines, hydroxylamines, additional chelating agents, and/or corrosion inhibitors. See U.S. Pat. No. 6,825,156.

### Example 24

A composition for the stripping of photoresist and the cleaning of residues from substrates, and for silicon oxide etch, comprising from about 0.01 percent by weight to about 10 percent by weight of one or more fluoride compounds, from about 10 percent by weight to about 95% by weight of a sulfoxide or sulfone solvent, and from about 20 percent by weight to about 50 percent by weight water, further including from about 0.01% to about 50% by weight, preferably about 0.5% to about 24%, of compounds with one or more chelating groups/agents, at least one being an amidoxime functional group/compound. The composition may contain corrosion inhibitors, chelating agents, co-solvents, basic amine compounds, surfactants, acids and bases. See U.S. Pat. No. 6,777,380.

### Example 25

A polishing composition for polishing a semiconductor substrate has a pH of under 5.0 and comprises (a) a carboxylic acid polymer comprising polymerized unsaturated carboxylic acid monomers having a number average molecular weight of about 20,000 to 1,500,000 or blends of high and low number average molecular weight polymers of polymerized unsaturated carboxylic acid monomers, (b) 1 to 15% by weight of an oxidizing agent, (c) up to 3.0% by weight of abrasive particles, (d) 50-5,000 ppm (parts per million) of an inhibitor, (e) up to 3.0% by weight of a complexing agent, such as, malic acid, and (f) 0.1 to 5.0% by weight of a surfactant, from about 0.01% to about 50% by weight, preferably about 0.5% to about 24%, of compounds with one or more chelating groups/agents, at least one being an amidoxime functional group/compound. See U.S. Pat. No. 6,679,928.

### Example 26

Particulate and metal ion contamination is removed from a surface, such as a semiconductor wafer containing copper damascene or dual damascene features, employing aqueous composition comprising a fluoride containing compound; a dicarboxylic acid and/or salt thereof; and a hydroxycarboxylic acid and/or salt thereof, the composition contains from about 0.01% to about 50% by weight, preferably about 0.5% to about 24%, of compounds with one or more chelating groups/agents, at least one being an amidoxime functional group/compound. See U.S. Pat. No. 6,673,757.

### Example 27

A semiconductor wafer cleaning formulation, including 2-98% wt. organic amine, 0-50% wt. water, 0.1-60% wt. 1,3-dicarbonyl compound chelating agent, 0-25% wt. of additional different chelating agent(s), 0.5-40% wt. nitrogen-containing carboxylic acid or an imine, and 2-98% wt polar organic solvent. The formulations are useful to remove residue from wafers following a resist plasma ashing step, such as inorganic residue from semiconductor wafers containing delicate copper interconnecting structures.

### Example 28

Another exemplary embodiment of the present invention is a method of removing etch residue from etcher equipment parts. The compositions used are aqueous, acidic compositions containing fluoride and polar, organic solvents. The compositions are free of glycols and hydroxyl amine and have a low surface tension and viscosity and further include from about 0.01% to about 50% by weight, preferably about 0.5% to about 24%, of compounds with one or more chelating groups/agents, at least one being an amidoxime functional group/compound. See U.S. Pat. No. 6,656,894.

### Example 29

The invention includes a method of cleaning a surface of a copper-containing material by exposing the surface to an acidic mixture comprising NO³—, F— and from about 0.01% to about 50% by weight, preferably about 0.5% to about 24%, of compounds with one or more chelating groups/agents, at least one being an amidoxime functional group/compound and/or one or more organic acid anions having carboxylate groups. The invention also includes an improved semiconductor processing method of forming an opening to a copper-containing material. A mass is formed over a copper-containing material within an opening in a substrate. The mass contains at least one of an oxide barrier material and a dielectric material. A second opening is etched through the mass into the copper-containing material to form a base surface of the copper-containing material that is at least partially covered by particles comprising at least one of a copper oxide, a silicon oxide or a copper fluoride. The base surface is cleaned with a solution comprising nitric acid, hydrofluoric acid and one or more organic acids to remove at least some of the particles.

One or more organic acids may be used in the composition of this example. An exemplary composition includes an acetic acid solution (99.8%, by weight in water), an HF solution (49%, by weight in water), an HNO₃ solution (70.4%, by weight in water), and H₂O, the resulting cleaning mixture being: from about 3% to about 20% of compounds with one or more chelating groups/agents, at least one being an amidoxime compound, by weight; from about 0.1% to about 2.0% HNO₃ by weight; and from about 0.05% to about 3.0% HF, by weight. See U.S. Pat. No. 6,589,882.

### Example 30

Another exemplary embodiment of the present invention is a composition for selective etching of oxides over a metal. The composition contains water, hydroxylammonium salt, one or more compounds with one or more chelating groups/agents, at least one being an amidoxime functional group/compound, a fluorine containing compound, and optionally, a base. The pH of the composition is about 2 to 6. See U.S. Pat. No. 6,589,439.

### Example 31

Another exemplary embodiment of the present invention is an etching treatment comprising a combination including hydrofluoric acid of 15 percent by weight to 19 percent by weight, one or more compounds with one or more chelating groups/agents, at least one being an amidoxime functional group/compound of 0.5 percent by weight to 24 percent by weight and ammonium fluoride of 12 percent by weight to 42 percent by weight, said combination having a hydrogen ion concentration of 10⁻⁶ mol/L to 10^{-1.8}, further comprising a surfactant of 0.001 percent by weight to 1 percent by weight. See U.S. Pat. No. 6,585,910.

### Example 32

Another exemplary embodiment of the present invention is a semiconductor wafer cleaning formulation, including 2-98% wt. organic amine, 0-50% wt. water, 0.1-60% wt. one or more compounds with one or more chelating groups/agents, at least one being an amidoxime functional group/compound, 0-25% wt. of additional different chelating agent(s), 0.1-40% wt. nitrogen-containing carboxylic acid or an imine, optionally 1,3-dicarbonyl compound chelating agent, and 2-98% wt polar organic solvent. The formulations are useful to remove residue from wafers following a resist plasma ashing step, such as inorganic residue from semiconductor wafers containing delicate copper interconnecting structures. See U.S. Pat. No. 6,566,315.

### Example 33

An exemplary embodiment of the present invention is a method for removing organometallic and organosilicate residues remaining after a dry etch process from semiconductor substrates. The substrate is exposed to a conditioning solution of a fluorine source, a non-aqueous solvent, a complementary acid, and a surface passivation agent. The fluorine source is typically hydrofluoric acid. The non-aqueous solvent is typically a polyhydric alcohol such as propylene glycol. The complementary acid is typically either phosphoric acid or hydrochloric acid. The surface passivation agent is one or more compounds with one or more chelating groups/agents, at least one being an amidoxime functional group/compound, and may optionally include a carboxylic acid such as citric acid. Exposing the substrate to the conditioning solution removes the remaining dry etch residues while minimizing removal of material from desired substrate features. See U.S. Pat. No. 6,562,726.

### Example 34

Another exemplary embodiment of the present invention is a stripping and cleaning composition for the removal of residue from metal and dielectric surfaces in the manufacture of semi-conductors and microcircuits. The composition is an aqueous system including organic polar solvents including corrosive inhibitor component from one or more compounds with one or more chelating groups/agents, at least one being an amidoxime functional group/compound and optionally a select group of aromatic carboxylic acids used in effective inhibiting amounts. A method in accordance with this invention for the removal of residues from metal and dielectric surfaces comprises the steps of contacting the metal or dielectric surface with the above inhibited compositions for a time sufficient to remove the residues. See U.S. Pat. No. 6,558,879.

### Example 35

Another exemplary embodiment of the present invention is a homogeneous non-aqueous composition containing a fluorinated solvent, ozone, one or more compounds with one or more chelating groups/agents, at least one being an amidoxime functional group/compound, and optionally a co-solvent and the use of these compositions for cleaning and oxidizing substrates is described. See U.S. Pat. No. 6,537,380.

### Example 36

The present invention also includes a chemical mechanical polishing slurry and method for using the slurry for polishing copper, barrier material and dielectric material that comprises a first and second slurry. The first slurry has a high removal rate on copper and a low removal rate on barrier material. The second slurry has a high removal rate on barrier material and a low removal rate on copper and dielectric material. The first and second slurries at least comprise silica particles, an oxidizing agent, one or more compounds with one or more chelating groups/agents, at least one being an amidoxime functional group/compound, optionally a corrosion inhibitor, and a cleaning agent. See, U.S. Pat. No. 6,527,819.

### Example 37

Another exemplary embodiment of the present invention is a method for removing organometallic and organosihicate residues remaining after a dry etch process from semiconductor substrates. The substrate is exposed to a conditioning solution of phosphoric acid, hydrofluoric acid, and one or more compounds with one or more chelating groups/agents, at least one being an amidoxime functional group/compound, and optionally a carboxylic acid, such as acetic acid, which removes the remaining dry etch residues while minimizing removal of material from desired substrate features. The approximate proportions of the conditioning solution are typically 80 to 95 percent by weight one or more compounds with one or more chelating groups/agents, at least one being an amidoxime functional group/compound and carboxylic acid, 1 to 15 percent by weight phosphoric acid, and 0.01 to 5.0 percent by weight hydrofluoric acid. U.S. Pat. No. 6,517,738.

### Example 38

Another exemplary embodiment of the present invention is a composition for use in semiconductor processing wherein the composition comprises water, phosphoric acid, and one or more compounds with one or more chelating groups/agents, at least one being an amidoxime functional group/compound, and optionally an organic acid; wherein the organic acid is ascorbic acid or is an organic acid having two or more carboxylic acid groups (e.g., citric acid). The water can be present in about 40 wt. % to about 85 wt. % of the composition, the phosphoric acid can be present in about 0.01 wt. % to about 10 wt. % of the composition, and the one or more compounds with one or more chelating groups/agents, at least one being an amidoxime functional group/compound and organic acid can be present in about 10 wt. % to about 60 wt. % of the composition. The composition can be used for cleaning various surfaces, such as, for example, patterned metal layers and vias by exposing the surfaces to the composition. See U.S. Pat. No. 6,486,108.

### Example 39

Another exemplary embodiment of the present invention is a method for removing organometallic and organosilicate residues remaining after a dry etch process from semiconductor substrates. The substrate is exposed to a conditioning solution of phosphoric acid, hydrofluoric acid, and one or more compounds with one or more chelating groups/agents, at least one being an amidoxime functional group/compound, and optionally a carboxylic acid, such as acetic acid, which removes the remaining dry etch residues while minimizing removal of material from desired substrate features. The approximate proportions of the conditioning solution are typically 80 to 95 percent by weight one or more compounds with one or more chelating groups/agents, at least one being an amidoxime functional group/compound and acetic acid, 1 to 15 percent by weight phosphoric acid, and 0.01 to 5.0 percent by weight hydrofluoric acid. See U.S. Pat. No. 6,453,914.

### Example 40

Another exemplary embodiment of the present invention is a method for cleaning a substrate which has a metal material and a semiconductor material both exposed at the surface and which has been subjected to a chemical mechanical polishing treatment, the substrate is first cleaned with a first cleaning solution containing ammonia water, etc. and then with a second cleaning solution containing (a) a first complexing agent capable of easily forming a complex with the oxide of said metal material, etc. and (b) an anionic or cationic surfactant. See U.S. Pat. No. 6,444,583.

### Example 41

The present invention is also exemplified by a cleaning agent for semiconductor parts, which can decrease a load on the environment and has a high cleaning effect on CMP (chemical mechanical polishing) abrasive particles, metallic impurities and other impurities left on the semiconductor parts such as semiconductor substrates after the CMP, comprising a (co)polymer having one or more compounds with one or more chelating groups/agents, at least one being an amidoxime functional group/compound, and optionally at least one kind of group selected from the group consisting of sulfonic acid (salt) groups and carboxylic acid (salt) groups, the cleaning agent further containing a phosphonic acid (salt) group-containing (co)polymer, a phosphonic acid compound or a surfactant as needed; and a method for cleaning semiconductor parts with the above cleaning agent. See U.S. Pat. No. 6,440,856.

### Example 42

The present invention also includes a non-corrosive cleaning composition for removing residues from a substrate. The composition comprises: (a) water; (b) at least one hydroxylammonium compound; (c) at least one basic compound, preferably selected from the group consisting of amines and quaternary ammonium hydroxides; (d) one or more compounds with one or more chelating groups/agents, at least one being an amidoxime functional group/compound, (e) optionally at least one organic carboxylic acid; and (f) optionally, a polyhydric compound. The pH of the composition is preferably between about 2 to about 6. See U.S. Pat. No. 6,413,923.

### Example 43

Another embodiment of the present invention is a composition comprising a slurry having an acidic pH and a corrosion inhibitor with one or more compounds with one or more chelating groups/agents, at least one being an amidoxime functional group/compound, and optionally a carboxylic acid corrosion inhibitor, wherein said carboxylic acid is selected from the group consisting of: glycine, oxalic acid, malonic acid, succinic acid and nitrilotriacetic acid. U.S. Pat. No. 6,409,781.

### Example 44

Another exemplary embodiment of the present invention is a chemical formulation consisting of a chelating agent, wherein said chelating agent is one or more compounds with one or more chelating groups/agents, at least one being an amidoxime functional group/compound, and optionally one or more additional chelating agents selected from the group consisting of iminodiacetic, malonic, oxalic, succinic, boric and malic acids and 2,4 pentanedione; a fluoride; and a glycol solvent, wherein said chelating agents consist of approximately 0.1-10% by weight of the formulation; and wherein said fluoride consists of a compound selected from the group consisting of ammonium fluoride, an organic derivative of ammonium fluoride, and a organic derivative of a polyammonium fluoride; and wherein said fluoride consists of approximately 1.65-7% by weight of the formulation; and wherein said glycol solvent consists of approximately 73-98.25% by weight of said formulation, further comprising: an amine, wherein said amine consists of approximately 0.1-10% by weight of said formulation. The chelating agents generally contain one or more compounds with one or more chelating groups/agents, at least one being an amidoxime functional group/compound, and optionally contain two carboxylic acid groups or two hydroxyl groups or two carbonyl groups such that the two groups in the chelating agent are in close proximity to each other. Other chelating agents which are also weakly to moderately acidic and are structurally similar to those claimed are also expected to be suitable. See U.S. Pat. No. 6,383,410.

### Example 45

Another exemplary embodiment of the present invention is a cleaning composition comprising a partially fluorinated solvent, a co-solvent, one or more compounds with one or more chelating groups/agents, at least one being an amidoxime functional group/compound, and ozone, wherein said fluorinated solvent comprises hydrofluoroethers, wherein said co-solvent is selected from the group consisting of ethers, esters, tertiary alcohols, carboxylic acids, ketones and aliphatic hydrocarbons. See U.S. Pat. No. 6,372,700.

### Example 46

Another exemplary embodiment of the present invention is a combination of one or more compounds with one or more chelating groups/agents, at least one being an amidoxime functional group/compound and optionally a carboxylic acid corrosion inhibitor. The combination of corrosion inhibitors can effectively inhibit metal corrosion of aluminum, copper, and their alloys. Suitable carboxylic acids include monocarboxylic and polycarboxylic acids. For example, the carboxylic acid may be, but is not limited to, formic acid, acetic acid, propionic acid, valeric acid, isovaleric acid, oxalic acid, malonic acid, succinic acid, glutaric acid, maleic acid, filmaric acid, phthalic acid, 1,2,3-benzenetricarboxylic acid, glycolic acid, lactic acid, citric acid, salicylic acid, tartaric acid, gluconic acid, and mixtures thereof. A preferred carboxylic acid is citric acid.

### Example 47

Another exemplary embodiment of the present invention is a composition for selective etching of oxides over a metal comprising: (a) water; (b) hydroxylammonium salt in an amount about 0.1 wt. % to about 0.5 wt. % of said composition; (c) one or more compounds with one or more chelating groups/agents, at least one being an amidoxime functional group/compound; (d) optionally a carboxylic acid selected from the group consisting of: formic acid, acetic acid, propionic acid, valeric acid, isovaleric acid, oxalic acid, malonic acid, succinic acid, glutaric acid, maleic acid, fumaric acid, phthalic acid, 1,2,3-benzenetricarboxylic acid, glycolic acid, lactic acid, citric acid, salicylic acid, tartaric acid, gluconic acid, and mixtures thereof; (e) a fluorine-containing compound; and (e) optionally, base. See U.S. Pat. No. 6,361,712.

### Example 48

In a further aspect, the invention relates to a semiconductor wafer cleaning formulation for use in post plasma ashing semiconductor fabrication, comprising the following components in the percentage by weight (based on the total weight of the formulation) ranges shown

| | |
|---|---|
| Organic amine(s) | 2-98% by weight |
| Water | 0-50% by weight |
| amidoxime chelating agent | 0.1-60% by weight |
| Complexing agent | 0-25% by weight |
| Nitrogen-containing carboxylic acid or imine | 0.5-40% by weight |
| polar organic solvent | 2-98% by weight. |

### Example 49

Another exemplary embodiment of the present invention is an anhydrous cleaning composition comprising 88 weight percent or more of a fluorinated solvent, from 0.005 to 2 weight percent of hydrogen fluoride or complex thereof, and from 0.01 to 5 weight percent of a co-solvent, wherein said co-solvent is selected from one or more compounds with one or more chelating groups/agents, at least one being an amidoxime functional group/compound, ethers, polyethers, carboxylic acids, primary and secondary alcohols, phenolic alcohols, ketones, aliphatic hydrocarbons and aromatic hydrocarbons. See U.S. Pat. No. 6,310,018.

### Example 50

| A. | Amidoxime compound | 2.5% | by weight |
|---|---|---|---|
| | Tetramethylammonium fluoride | 4.5% | by weight |
| | Ethylene glycol | 93% | by weight |
| B. | Amidoxime compound | 1.3% | by weight |
| | Pentamethyldiethylenetriammonium | 4.6% | by weight |
| | trifluoride | | |
| | Ethylene glycol | 94.1% | by weight |
| C. | Amidoxime compound | 1.25% | by weight |
| | Triethanolammonium fluoride | 5% | by weight |
| | Ethylene glycol | 93.75% | by weight |
| D. | Amidoxime compound | 2.8% | by weight |
| | Tetramethylammonium fluoride | 5.1% | by weight |
| | Ethylene glycol | 92.1% | by weight |
| E. | Amidoxime compound | 2% | by weight |
| | Ammonium fluoride | 7% | by weight |
| | Ethylene glycol | 91% | by weight |
| F. | Amidoxime compound | 2.8% | by weight |
| | Ammonium fluoride | 5% | by weight |
| | Ethylene glycol | 92.2% | by weight |

### Example 51

Another exemplary embodiment of the present invention is a composition comprising a chelating agent, a fluoride salt, and a glycol solvent, wherein said chelating agent is weakly to moderately acidic, and consists of approximately 0.1-10% by weight of the formulation; and wherein said fluoride salt consists of a compound selected from the group consisting of ammonium fluoride, an organic derivative of ammonium fluoride, and a organic derivative of a polyammonium fluoride; and wherein said fluoride salt consists of approximately 1.65-7% by weight of the formulation; and wherein said glycol solvent consists of 73-98.25% by weight of said formulation; and further including an amine, wherein said amine consists of approximately 0.1-10% by weight of said formulation; and wherein said chelating agent is an amidoxime or hydroxamic acid. See U.S. Pat. No. 6,280,651.

### Example 52

Another exemplary embodiment of the present invention is a cleaning agent for use in producing semiconductor devices, which consists essentially of an aqueous solution containing (A) 0.1 to 15% by weight based on the total amount of the cleaning agent of at least one fluorine-containing compound selected from the group consisting of hydrofluoric acid, ammonium fluoride, ammonium hydrogenfluoride, acidic ammonium fluoride, methylamine salt of hydrogen fluoride, ethylamine salt of hydrogen fluoride, propylamine salt of hydrogen fluoride and tetramethylammonium fluoride, (B) 0.1 to 15% by weight based on the total amount of the cleaning agent of a salt of boric acid and (C) 0.5 to 50% by weight of one or more compounds with one or more chelating groups/agents, at least one being an amidoxime functional group/compound; and (d) 5 to 80% by weight based on the total amount of the cleaning agent of a water-soluble organic solvent, and optionally further containing at least one of a quaternary ammonium salt, an ammonium salt of an organic carboxylic acid, an amine salt of an organic carboxylic acid and a surfactant. See U.S. Pat. No. 6,265,309.

### Example 53

Another exemplary embodiment of the present invention is a cleaning liquid in the form of an aqueous solution for cleaning a semiconductor device during production of a semiconductor device, which comprises (A) a fluorine-containing compound; (B) a water-soluble or water-miscible organic solvent; (C) one or more compounds with one or more chelating groups/agents, at least one being an amidoxime functional group/compound; (D) optionally, an organic acid; and (E) a quaternary ammonium salt. In some embodiments the cleaning solution also contains a surfactant. The organic acid is typically selected from the group consisting of formic acid, acetic acid, propionic acid, butyric acid, isobutyric acid, valeric acid, isovaleric acid, heptanoic acid, lauric acid, palmitic acid, stearic acid, acrylic acid, crotonic acid, methacrylic acid, oxalic acid, malonic acid, maleic acid, succinic acid, adipic acid, azelaic acid, sebacic acid, benzoic acid, toluic acid, phthalic acid, trimellitic acid, pyromellitic acid, benzenesulfonic acid, toluenesulfonic acid, salicylic acid and phthalic anhydride. See U.S. Pat. No. 5,972,862.

### Example 54

Another exemplary embodiment is a method for semiconductor processing comprising etching of oxide layers, especially etching thick SiO₂ layers and/or last step in the cleaning process wherein the oxide layers are etched in the gas phase with a mixture of hydrogen fluoride, one or more compounds with one or more chelating groups/agents, at least one being an amidoxime functional group/compound, and optionally one or more carboxylic acids, eventually in admixture with water. See U.S. Pat. No. 5,922,624.

### Example 55

The complexing agents of the present invention may also be added to the rinse containing a peroxide of U.S. Pat. No. 5,911,836.

### Example 56

Another exemplary embodiment of the present invention is a method and apparatus for increasing the deposition of ions onto a surface, such as the adsorption of uranium ions on the detecting surface of a radionuclide detector. The method includes the step of exposing the surface to one or more compounds with one or more chelating groups/agents, at least one being an amidoxime functional group/compound, and optionally, a phosphate ion solution, which has an affinity for the dissolved species to be deposited on the surface. This provides, for example, enhanced sensitivity of the radionuclide detector. See U.S. Pat. No. 5,652,013.

### Example 57

Another exemplary embodiment of the present invention is a stripping and cleaning agent for removing dry-etching photoresist residues, and a method for forming an aluminum based line pattern using the stripping and cleaning agent. The stripping and cleaning agent contains (a) from 5 to 50% by weight of one or more compounds with one or more chelating groups/agents, at least one being an amidoxime functional group/compound; (b) from 0.5 to 15% by weight of a fluorine compound; and (c) a solvent, including water The inventive method is advantageously applied to treating a dry-etched semiconductor substrate with the stripping and cleaning agent. The semiconductor substrate comprises a semiconductor wafer having thereon a conductive layer containing aluminum. The conductive layer is dry-etched through a patterned photoresist mask to form a wiring body having etched side walls. The dry etching forms a side wall protection film on the side walls. In accordance with the inventive method, the side wall protection film and other resist residues are completely released without corroding the wiring body. See, U.S. Pat. No. 5,630,904.

### Example 58

### Particle Performance on Thermal Oxide

| | DIW | DS6-10 | | DS6-10 + GA | DQ2010 |
|---|---|---|---|---|---|
| Dilution | | | | | |
| ratio | — | 1 | 10 | 10 | 50 |
| 0.1up | 334 | 170 | 154 | 89 | 190 |
| 0.12up | 234 | 126 | 108 | 65 | 147 |
| 0.14up | 263 | 97 | 67 | 45 | 115 |
| 0.17up | 229 | 76 | 44 | 20 | 80 |
| 0.2up | 99 | 60 | 35 | 24 | 60 |
| 0.3up | 51 | 36 | 11 | 10 | 41 |
| 0.5up | 17 | 22 | 4 | 4 | 26 |

### Example 59

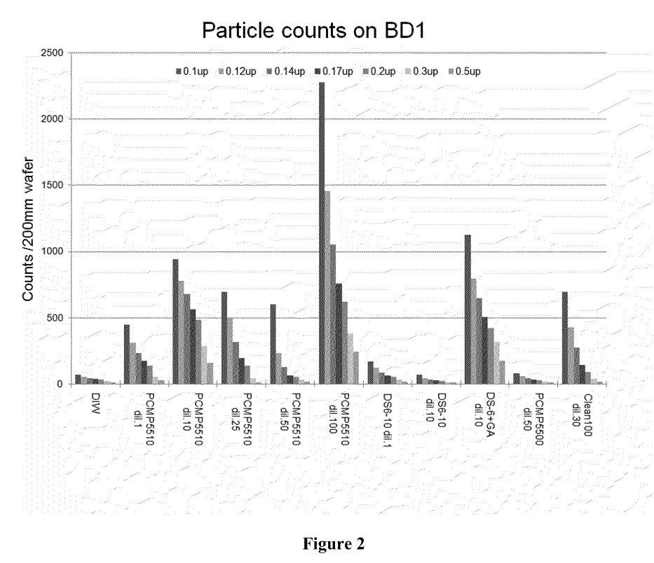

### Particle Performance on Blackdiamond (BD1) (see FIG. 2)

| | DIW | DS6-10 | | DS6-10 + GA | DQ2010 |
|---|---|---|---|---|---|
| Dilution ratio | — | 1 | 10 | 10 | 50 |
| 0.1up | 68 | 168 | 66 | 1124 | 80 |
| 0.12up | 51 | 122 | 44 | 791 | 56 |
| 0.14up | 43 | 82 | 33 | 645 | 41 |
| 0.17up | 35 | 64 | 25 | 506 | 29 |
| 0.2up | 31 | 51 | 21 | 422 | 25 |
| 0.3up | 21 | 33 | 11 | 316 | 14 |
| 0.5up | 12 | 16 | 9 | 174 | 8 |

### Example 60

### Metal Contamination Thermal Oxide

| | K | Ca | Cr | Mn | Fe | Co | Ni | Cu | Zn |
|---|---|---|---|---|---|---|---|---|---|
| DIW | 4.7 | ND | <1 | <1 | 2.0 | <1 | ND | <1 | ND |
| Dil 10 | <1 | ND | <1 | <1 | <1 | ND | ND | 5.1 | ND |
| Dil 25 | ND | ND | 1.0 | <1 | 4.5 | <1 | <1 | 4.6 | ND |
| Dil 50 | 3.8 | ND | <1 | ND | 1.0 | <1 | ND | 4.3 | ND |
| Dil 100 | <1 | ND | <1 | <1 | <1 | <1 | ND | 4.2 | ND |
| DS6-10 | 4.0 | <1 | <1 | <1 | <1 | ND | ND | 2.0 | ND |
| Dil 10 | 2.8 | <1 | <1 | ND | 1.6 | <1 | ND | <1 | ND |
| DS6 + GA | 1.9 | <1 | <1 | <1 | <1 | ND | ND | 5.4 | ND |
| DQ2010 dil 50 | 2.6 | <1 | <1 | <1 | <1 | <1 | ND | <1 | ND |

### Example 61

### Metal Contamination BD1

| | K | Ca | Cr | Mn | Fe | Co | Ni | Cu | Zn |
|---|---|---|---|---|---|---|---|---|---|
| DIW | 1.2 | ND | <1 | ND | <1 | ND | ND | <1 | ND |
| Dil 10 | 21.3 | ND | <1 | <1 | 1.7 | <1 | ND | 19.8 | ND |
| Dil 25 | 17.6 | <1 | <1 | <1 | 1.7 | <1 | ND | 21.4 | ND |
| Dil 50 | 14.2 | ND | <1 | ND | 1.3 | <1 | ND | 18.8 | ND |
| Dil 100 | 16.5 | ND | <1 | <1 | 1.2 | <1 | ND | 18.1 | ND |
| DS6-10 | 7.1 | ND | <1 | <1 | 1.5 | <1 | ND | 9.6 | ND |
| Dil 10 | 3.1 | 1.0 | <1 | <1 | 1.3 | <1 | ND | 4.4 | ND |
| DS6 + GA | 51.5 | <1 | ND | ND | 1.9 | <1 | ND | 58.2 | ND |
| DQ 2010 | 21.3 | ND | <1 | <1 | <1 | ND | ND | 1.9 | ND |
| dil 50 | | | | | | | | | |

### Example 62

U.S. Pat. No. 6,927,176 describes the effectiveness of chelating compounds due to their binding sites. See, e.g., FIGS. 2a and 2b of U.S. Pat. No. 6,927,176. The patent indicates that there are 6 binding sites as shown:

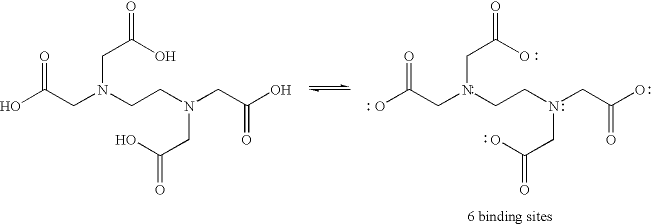

By applying the same principal applying to an amidoxime compound, obtained from the conversion of a cyanoethylation compound of ethylenediamine, a total of 14 binding sites is the result, as depicted below:

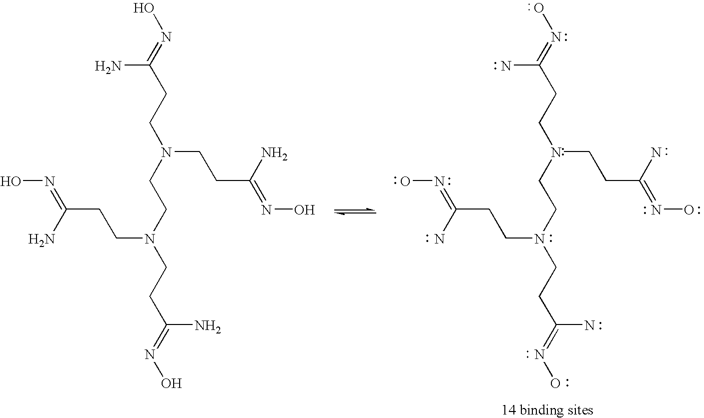

The amidoxime 1,2,3,4,5,6-(hexa-(2-amidoximo)ethoxy)hexane has 18 binding sites as depicted below:

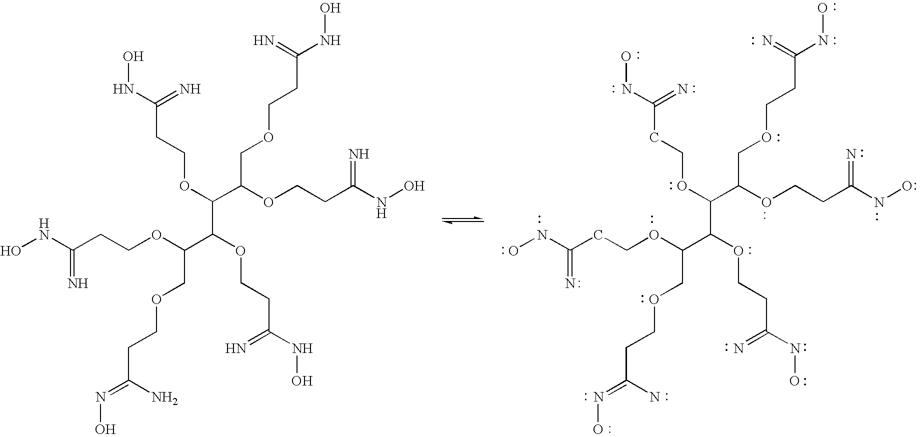

The amidoxime chelating agents of the invention can substitute for polyacrylates, carbonates, phosphonates, and gluconates, ethylenediaminetetraacetic acid (EDTA), N,N′-bis(2-hydroxyphenyl)ethylenediiminodiacetic acid (HPED), triethylenetetranitrilohexaacetic acid (TTHA), desferriferrioxamine B, N,N′,N″-tris[2-(N-hydroxycarbonyl)ethyl]-1,3,5-benzenetricarboxamide (BAMTPH), and ethylenediaminodiorthohydroxyphenylacetic acid (EDDHA).

In an exemplary embodiment, solutions of the present application include compositions comprising:

A) An organic compound with one or more amidoxime functional group thereof.

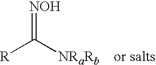

In an exemplary embodiment, Rₐ and R_{b} are independently hydrogen, alkyl, hetero-alkyl, alkyl-aryl, or alkyl-heteroaryl groups. R is independently selected from alkyl, alkyl-aryl, or alkyl-heteroaryl groups. In these embodiments, chelation of the amidoxime to metal centers may be favored because, in reaction with a metal centre, a proton can be lost from NRₐR_{b} so as to form a nominally covalent bond with the metal center. In another embodiment, NRₐR_{b} is further substituted with R_{c} so the amidoxime has the following chemical formula:

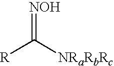

In this exemplary embodiment, a negatively charged counter-ion balances the positive charge on the nitrogen atom. Any negatively charged counter-ion may be used, for example chloride, bromide, iodide, a SO₄ ion, a PF₆ ion or a ClO₄ ion. In an exemplary embodiment, R_{c} may be hydrogen or an R group as defined below. In a particular embodiment, Rₐ, R_{b} and/or R_{c} can join onto one another and/or join onto R so as to form one or more cycles.

In an exemplary embodiment, the amidoxime compounds of the invention are represented by the following structures (and their resonance/tautomeric forms).

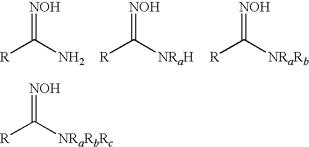

wherein R is an alkyl, heteroalkyl, alkyl-aryl, alkyl-heteroaryl, aryl or heteroaryl group. In a particular embodiment, R may be connected to one or more of Rₐ, R_{b} and R_{c}. A representative amidoxime compound within the scope of the the above structures is shown below:

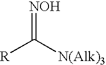

wherein Alk is an alkyl group as defined below. The three alkyl groups may be independently selected or may be the same. In a particular embodiment, the alkyl group is methyl or ethyl.

The alkyl group may be completely saturated or may contain unsaturated groups (i.e., may contain alkene and alkyne functional groups, so the term “alkyl” encompasses the terms “alkylene”, “alkenylene” and “alkynylene” within its scope).

The alkyl group may be straight-chained or branched. The alkyl group may contain any number of carbon and hydrogen atoms. While alkyl groups having a lesser number of carbon atoms tend to be more soluble in polar solvents such as DMSO and water, alkyl groups having a greater number of carbons can have other advantageous properties, for example surfactant properties. Therefore, in one embodiment, the alkyl group contains 1 to 10 carbon atoms, for example the alkyl group is a lower alkyl group containing 1 to 6 carbon atoms. In another embodiment, the alkyl group contains 10 or more carbon atoms, for example 10 to 24 carbon atoms. The alkyl group may be unsubstituted (i.e. the alkyl group contains only carbon and hydrogen). The unsubstituted alkyl group may be unsaturated or saturated. Examples of possible saturated unsubstituted alkyl groups include methyl, ethyl, n-propyl, sec-propyl, cyclopropyl, n-butyl, sec-butyl, tert-butyl, cyclobutyl, pentyl (branched or unbranched), hexyl (branched or unbranched), heptyl (branched or unbranched), octyl (branched or unbranched), nonyl (branched or unbranched), and decyl (branched or unbranched). Saturated unsubstituted alkyl groups having a greater number of carbons may also be used. Cyclic alkyl groups may also be used, so the alkyl group may comprise, for example, a cyclopropyl group, a cylcobutyl group, a cyclopentyl group, a cyclohexyl group, a cycloheptyl group, a cyclooctyl group, a cylcononyl group and/or a cyclodecyl group. These cyclic alkyl groups may directly append the amidoxime group or may be joined to the amidoxime through one or more carbon atoms.

Examples of amidoxime compounds containing unsubstituted saturated alkyl groups include, but are not limited to:

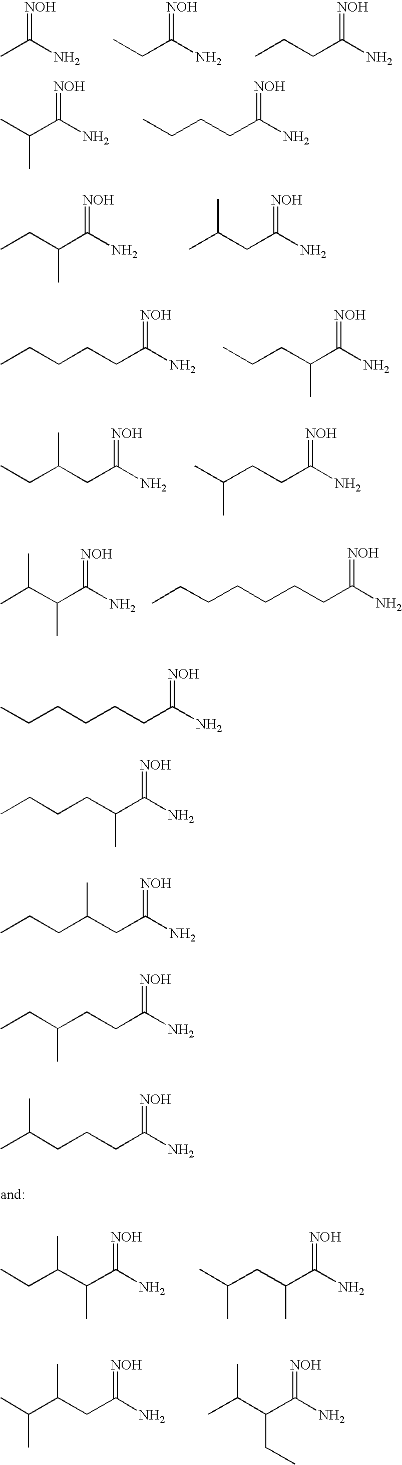

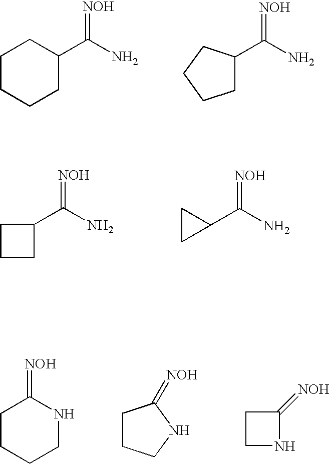

Examples further include:

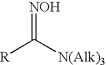

wherein Alk is methyl or ethyl and R is an alkyl group. R may be, for example, an alkyl group containing 8 to 25 carbon atoms. If the alkyl group is substituted, it may, for example, be substituted at the opposite end of the alkyl group to the amidoxime group. For example, the alkyl group may be substituted antipodally to the amidoxime group by one or more halogens, for example fluorine.

Examples further include alkyl groups appending two or more amidoxime functional groups. For example, the amidoxime may have the following structure:

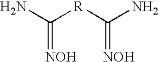

where R is independently selected from alkylene, heteroalkylene, arylene, heteroarylene, alkylene-heteroaryl, or alkylene-aryl group. For example, R may be a straight chained alkylene group, such as an unsubstituted straight chained alkylene group. Examples of suitable groups include methyl, ethyl, propyl, butyl, pentyl, hexyl, heptyl, octyl, nonyl and decyl.

Specific examples of unsubstituted saturated alkyl amidoximes include the following:

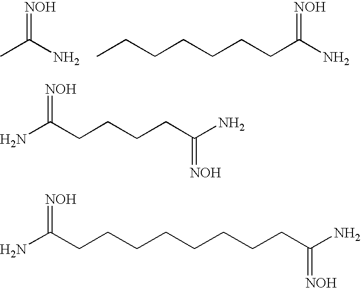

If the alkyl group is unsaturated, it may have one or more unsaturated carbon-carbon bonds in the alkyl chain. These unsaturated group(s) may optionally be in conjugation with the amidoxime group. A specific example of an unsubstituted unsaturated alkyl amidoxime molecules is as shown:

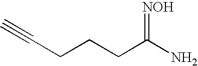

The alkyl group may also be substituted with one or more heteroatoms or groups of heteroatoms. Groups containing heteroatoms joined to carbon atoms are contained within the scope of the term “heteroalklyl”. One or more alkyl substituents include, but are not limited to, a halogen atom, including fluorine, chlorine, bromine or iodine, —OH, ═O, —NH₂, ═NH, —NHOH, ═NOH, —OPO(OH)₂, —SH, ═S or —SO₂OH. In a particular embodiment, the substituent is an oxime group (═NOH).

If the alkyl group is substituted with ═O, the alkyl group may comprise an aldehyde, a ketone, a carboxylic acid or an amide. In an exemplary embodiment, there is an enolizable hydrogen adjacent to the ═O, ═NH or ═NOH (i.e., there is a hydrogen in the alpha position to the carbonyl). The alkyl group may comprise the following functionalities: —(CZ₁)—CH—(CZ₂)—, wherein Z₁ and Z₂ are independently selected from O, NH and NOH. The CH in this group is further substituted with hydrogen or an alkyl group or joined to the amidoxime functional group. Thus, an alkyl group appending an amidoxime group may simply be substituted with, for example one or more independently-selected halogens, for example fluorine, chlorine, bromine or iodine. In a particular embodiment, the halogens are substituted at the antipodal (i.e., opposite) end of the alkyl group to the amidoxime group. This arrangement may, for example, provide surfactant activity, in particular for example if the halogen is fluorine.

A specific example of an amidoxime group substituted with a substituted alkyl group is as shown:

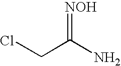

Compounds that are substituted in a β position are conveniently synthesized from readily-available starting materials. Examples of such compounds include, but are not limited to:

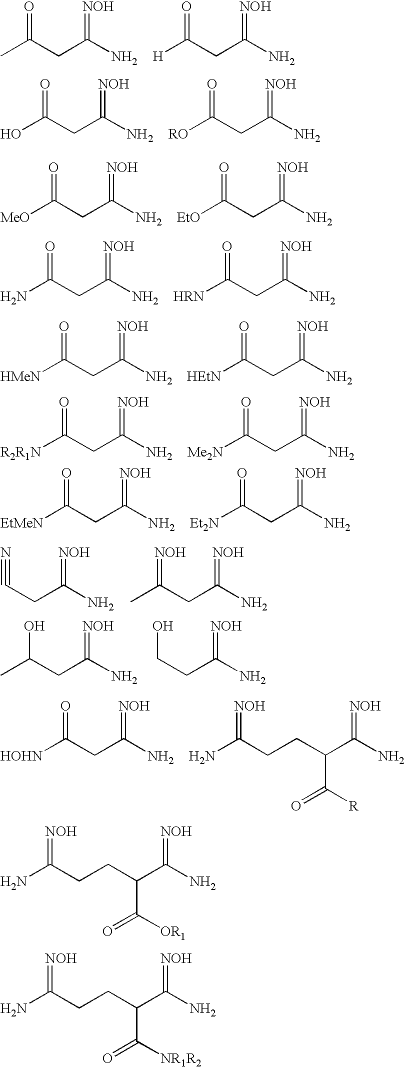

wherein R₁ and R₂ are independently selected from hydrogen and alkyl groups.

Specific examples of substituted alkyl amidoxime molecules are as shown:

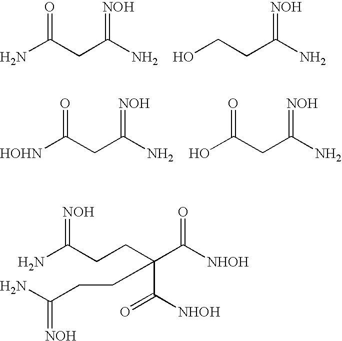

Some of these molecules can exist as different isomers. For example:

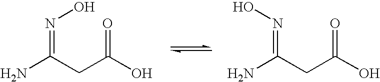

The different isomers can be differentiated by carbon-13 NMR.

When R is a heteroalkyl group, the amidoxime may have the following chemical structure:

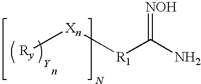

where “n” varies from 1 to N and y varies from 1 to Yₙ; N varies from 0 to 3; Yₙ varies from 0 to 5. In this formula, R₁ is independently-selected alkylene groups; R_{y} is independently selected from alkyl, or hetero-alkyl groups, or adjoins R₁ so to form a heterocycle with the directly appending X. R₁ may also be a direct bond, so that the amidoxime group is connected directly to the one or more heteroatoms. Xₙ is a heteroatom or a group of heteroatoms selected from boron, nitrogen, oxygen, silicon, phosphorus and sulphur. Each heteroatom or group of heteroatoms and each alkyl group is independently selected from one another. The above formula includes an amidoxime group directly bearing an alkyl group. The alkyl group is substituted with N independently-selected heteroatoms or groups of heteroatoms. Each heteroatom or group of heteroatoms is itself substituted with one or more independently-selected alkyl groups or hetero-alkyl groups. For example, X may be or may comprise boron, nitrogen, oxygen, silicon, phosphorus or sulphur. In one embodiment, X is oxygen. In this case, X may be part of an ether group (—O—), an ester (—O—CO—), —O—CO—O—, —O—CO—NH—, —O—CO—NR₂—, —O—CNH—, —O—CNH—O—, —O—CNH—NH—, —O—CNH—NR₂—, —O—CNOH—, —O—CNOH—O—, —O—CNOH—NH— or —O—CNOH—NR₂—, wherein R₂ is independently selected alkyl group, hetero-alkyl group, or hetero-aryl group. In another embodiment, X is a nitrogen atom. In this case, X may be part of one of the following groups: —NR₂H, —NR₂—, —NR₂R₃— (with an appropriate counter-ion), —NHNH—, —NH—CO—, —NR2-CO—, —NH—CO—O—, —NH—CO—NH—, —NH—CO—NR₂—, —NR₂—CO—NH—, —NR₂—CO—NR₃—, —NH—CNH—, —NR2-CNH—, —NH—CNH—O—, —NH—CNH—NH—, —NH—CNH—NR₂—, —NR₂—CNH—NH—, —NR₂—CNH—NR₃—, —NH—CNOH—, —NR2-CNOH—, —NH—CNOH—O—, —NH—CNOH—NH—, —NH—CNOH—NR₂—, —NR₂—CNOH—NH—, —NR₂—CNOH—NR₃—. R₂ to R₃ are independently selected alkyl groups, hetero-alkyl groups, or hetero-aryl groups, wherein the heteroalkyl group and hetero-aryl group may be unsubstituted or substituted with one or more heteroatoms or group of heteroatoms or itself be substituted with another heteroalkyl group. If more than one hetero-substituent is present, the substituents are independently selected from one another unless they form a part of a particular functional group (e.g., an amide group).

In another embodiment, X comprises boron. In this case, X may also comprise oxygen. In another embodiment, X comprises phosphorus. In this case, X may also comprise oxygen, for example in an —OPO(OH)(OR₂) group or an —OPO(OR₂)(OR₃) group. In another embodiment, X comprises sulphur, for example as a thiol ether or as a sulphone.

The term heteroalkyl also includes within its scope cyclic alkyl groups containing a heteroatom. If X is N or O, examples of such groups include a lactone, lactam or lactim. Further examples of heteroalkyl groups include azetidines, oxetane, thietane, dithietane, dihydrofuran, tetrahydrofuran, dihydrothiophene, tetrahydrothiophene, piperidine, pyroline, pyrolidine, tetrahydropyran, dihydropyran, thiane, piperazine, oxazine, dithiane, dioxane and morpholine. These cyclic groups may be directly joined to the amidoxime group or may be joined to the amidoxime group through an alkyl group. The heteroalkyl group may be unsubstituted or substituted with one or more hetero-atoms or group of hetero-atoms or itself be substituted with another heteroalkyl group. If more than one hetero-substituent is present, the substituents are independently selected from one another unless they form a part of a particular functional group (e.g. an amide group). One or more of the substituents may be a halogen atom, including fluorine, chlorine, bromine or iodine, —OH, ═O, —NH₂, ═NH, —NHOH, ═NOH, —OPO(OH)₂, —SH, ═S or —SO₂OH. In one embodiment, the substituent is an oxime group (═NOH). The heteroalkyl group may also be itself substituted with one or more amidoxime functional groups. If the heteroalkyl group is substituted with ═O, the heteroalkyl group may comprise an aldehyde, a ketone, a carboxylic acid or an amide. Preferably, there is an enolizable hydrogen adjacent to the ═O, ═NH or ═NOH (i.e. there is a hydrogen in the alpha position to the carbonyl). The heteroalkyl group may comprise the following functionality: —(CZ₁)—CH—(CZ₂)—, wherein Z₁ and Z₂ are independently selected from O, NH and NOH. The CH in this group is further substituted with hydrogen or an alkyl group or heteroalkyl group or joined to the amidoxime functional group.

Amines are versatile functional groups for use in the present invention, in part because of their ease of preparation. For example, by using acrylonitrile, a variety of functionalized amines can be synthesized. Examples include, but are not limited to:

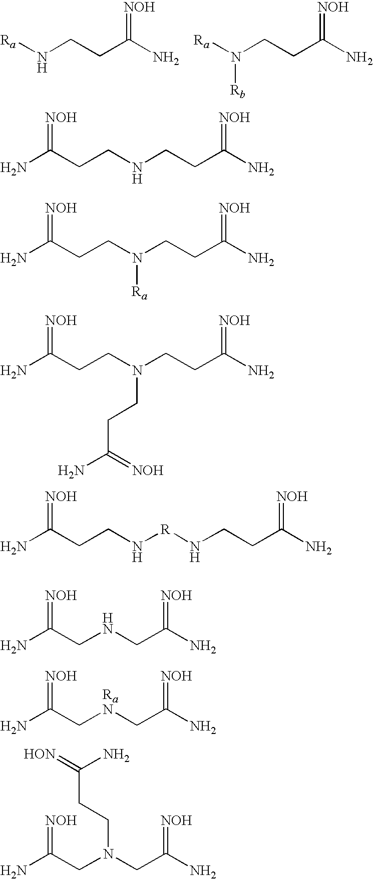

where Rₐ and R_{b} and R are independently-selected R groups as previously defined. In one embodiment, R_{c} is an alkyl group, for example a straight-chained unsubstituted alkyl group containing 1 to 8 carbon atoms. For example, R_{c} may be CH₂—CH₂. Rₐ and R_{b} may be independently selected alkyl groups, for example unsubstituted alkyl groups containing 1 to 8 carbon atoms, for example methyl or ethyl.

Specific examples of amidoximes comprising a heteroalkyl group include:

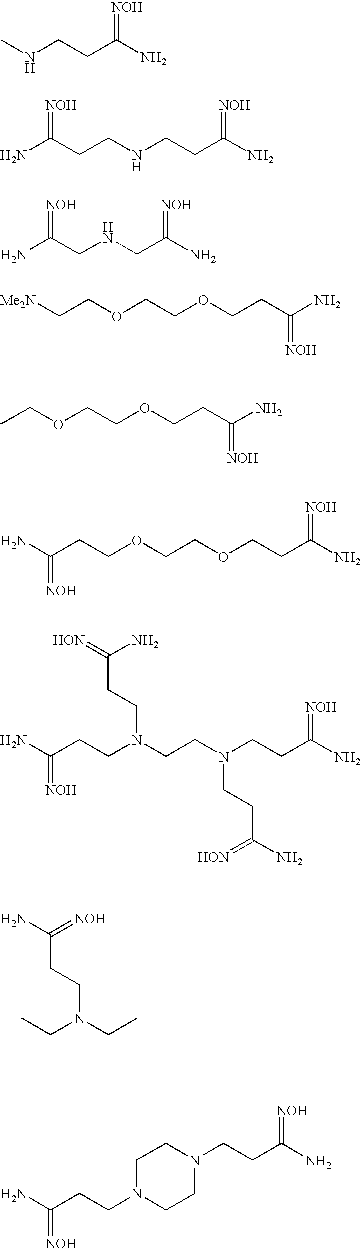

R may itself be a heteroatom or group of heteroatoms. The heteroatoms may be unsubstituted or substituted with one or more alkyl groups. For example, R may be H, NH₂, NHR₁, OR₁ or NR₁R₂, wherein R₁ and R₂ are independently-selected alkyl groups.

R may be an aryl group. The term “aryl” refers to a group comprising an aromatic cycle. The cycle is made from carbon atoms. The cycle itself may contain any number of atoms, for example 3 to 10 atoms. For the sake of convenient synthesis, cycles comprising 5 or 6 atoms have been found to be particularly useful. An example of an aryl substituent is a phenyl group.

The aryl group may be unsubstituted. A specific example of an amidoxime bearing an unsubstituted aryl is:

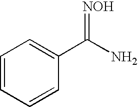

The aryl group may also be substituted with one or more alkyl groups, heteroalkyl groups or hetero-atom substituents. If more than one substituent is present, the substituents are independently selected from one another.

One or more of the heteroatom substituents may be for example, a halogen atom, including fluorine, chlorine, bromine or iodine, —OH, ═O, —NH₂, ═NH, —NHOH, ═NOH, —OPO(OH)₂, —SH, ═S or —SO₂OH. In a particular embodiment, the substituent is an oxime group (═NOH).

The one or more alkyl groups are the alkyl groups defined previously and the one or more heteroalkyl groups are the heteroalkyl groups defined previously. Specific examples of substituted aryl amidoxime molecules are as shown:

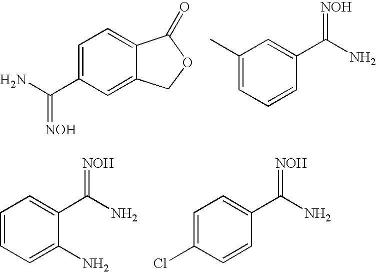

R may also be heteroaryl. The term heteroaryl refers to an aryl group containing one or more hetero-atoms in its aromatic cycle. The one or more hetero-atoms are independently-selected from, for example, boron, nitrogen, oxygen, silicon, phosphorus and sulfur. Examples of heteroaryl groups include pyrrole, furan, thiophene, pyridine, melamine, pyran, thiine, diazine and thiazine.

The heteroaryl group may be unsubstituted. A specific example of an unsubstituted heteroaryl amidoxime molecule is as shown:

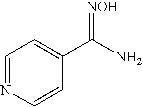

In an exemplary embodiment, the heteroaryl group may be attached to the amidoxime group through its heteroatom, for example (the following molecule being accompanied by a counter anion):

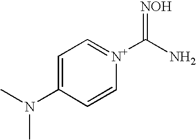

The heteroaryl group may be substituted with one or more alkyl groups, heteroalkyl groups or hetero-atom substituents. If more than one substituent is present, the substituents are independently selected from one another. One or more of the heteroatom substituents may be, for example, a halogen atom, including fluorine, chlorine, bromine or iodine, —OH, ═O, —NH₂, ═NH, —NHOH, ═NOH, —OPO(OH)₂, —SH, ═S or —SO₂OH. The one or more alkyl groups are as defined previously and the one or more heteroalkyl groups are as defined previously.

Within the scope of the term aryl are alkyl-aryl groups. The term “alkyl-aryl” refers to an amidoxime group bearing (i.e., directly joined to) an alkyl group (i.e., an “alkylene-aryl” group). The alkyl group is then itself substituted with an aryl group. Correspondingly, within the scope of the term heteroaryl are alkyl-heteroaryl groups. The alkyl group may be any alkyl group previously defined. The aryl/heteroaryl group may also be any aryl group known in the art. Both the alkyl group and the aryl/heteroalkyl group may be unsubstituted. Specific examples of unsubstituted alkyl-aryl amidoxime molecules are as shown:

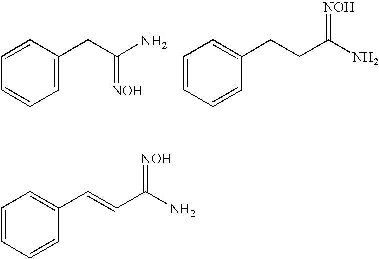

Alternatively, one or both of the alkyl group and the aryl/heteroalkyl group may be substituted. If the alkyl group is substituted, it may be substituted with one or more hetero-atoms or groups containing hetero-atoms. If the aryl/heteroalkyl group is substituted, it may be substituted with one or more alkyl groups, heteroalkyl groups or hetero-atom substituents. If more than one substituent is present, the substituents are independently selected from one another. One or more of the heteroatom substituents may be, for example, a halogen atom, including fluorine, chlorine, bromine or iodine, —OH, ═O, —NH₂, ═NH, —NHOH, ═NOH, —OPO(OH)₂, —SH, ═S or —SO₂OH. In one embodiment, the substituent is an oxime group (═NOH). The alkyl group may also be itself substituted with one or more amidoxime functional groups. If the alkyl group is substituted with ═O, the alkyl group may comprise an aldehyde, a ketone, a carboxylic acid or an amide. Preferably, there is an enolizable hydrogen adjacent to the ═O, ═NH or ═NOH (i.e. there is a hydrogen in the alpha position to the carbonyl). The alkyl group may comprise the following functionality: —(CZ₁)—CH—(CZ₂)—, wherein Z₁ and Z₂ are independently selected from O, NH and NOH. The CH in this group is further substituted with hydrogen or an alkyl group or heteroalkyl group or joined to the amidoxime functional group. Within the scope of the term aryl are also heteroalkyl-aryl groups. The term “heteroalkyl-aryl” refers to an amidoxime group bearing (i.e. directly joined to) an heteroalkyl group. The heteroalkyl group is then itself substituted with an aryl group. Correspondingly, within the scope of the term heteroaryl are also heteroalkyl-aryl groups. The heteroalkyl group may be any alkyl group known in the art or described herein. The aryl/heteroaryl group may also be any aryl group known in the art or described herein. Both the heteroalkyl group and the aryl/heteroaryl group may be unsubstituted. Alternatively, one or both of the heteroalkyl group and the aryl/heteroaryl group may be substituted. If the heteroalkyl group is substituted, it may be substituted with one or more hetero-atoms or groups containing hetero-atoms. If the aryl/heteroaryl group is substituted, it may be substituted with one or more alkyl groups, heteroalkyl groups or hetero-atom substituents. If more than one substituent is present, the substituents are independently selected from one another. One or more of the hetero-atom substituents may be, for example, a halogen atom, including fluorine, chlorine, bromine or iodine, —OH, ═O, —NH₂, ═NH, —NHOH, ═NOH, —OPO(OH)₂, —SH, ═S or —SO₂OH. In one embodiment, the substituent is an oxime group (═NOH). The alkyl group may also be itself substituted with one or more amidoxime functional groups. If the heteroalkyl group is substituted with ═O, the heteroalkyl group may comprise an aldehyde, a ketone, a carboxylic acid or an amide. Preferably, there is an enolizable hydrogen adjacent to the ═O, ═NH or ═NOH (i.e. there is a hydrogen in the alpha position to the carbonyl). The heteroalkyl group may comprise the following functionality: —(CZ₁)—CH—(CZ₂)—, wherein Z₁ and Z₂ are independently selected from O, NH and NOH. The CH in this group is further substituted with hydrogen or an alkyl group or heteroalkyl group or joined to the amidoxime functional group. A preferred substituent to any type of R group is a tetra-valent nitrogen. In other words, any of the above groups may be substituted with —NRₐR_{b}R_{c}R_{d} where Rₐ to R_{d} are independently-selected R groups as defined herein. In one embodiment, Rₐ to R_{d} are unsubstituted saturated alkyl groups having 1 to 6 carbon atoms. For example, one or more of (for example all of) Rₐ to R_{d} are methyl and/or ethyl. With this substituent, the tetra-valent nitrogen is preferably substituted in an antipodal position to the amidoxime group. For example, if R is a straight-chained unsubstituted saturated alkyl group of the form (CH₂)ₙ, then the tetra-valent nitrogen is at one end of the alkyl group and the amidoxime group is at the other end. In this embodiment, n is preferably 1, 2, 3, 4, 5 or 6.

In an exemplary embodiment, the present invention provides an amidoxime molecule that contains only one amidoxime functional group. In another embodiment, the present invention provides an amidoxime molecule containing two or more amidoxime functional groups. In fact, a large number of functional groups can be contained in a single molecule, for example if a polymer has repeating units having appending amidoxime functional groups. Examples of amidoxime compounds that contain more than one amidoxime functional groups have been described previously throughout the specification.

Amidoxime compounds may be conveniently prepared from nitrile-containing molecules as follows:

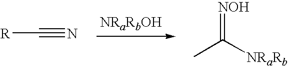

Typically, to prepare a molecule having Rₐ═R_{b}═H, hydroxylamine is used. If one or both of Rₐ and R_{b} in the desired amidoxime is not hydrogen, the amidoxime can be prepared either using the corresponding hydroxylamine or by further reacting the amidoxime once it has been formed. This may, for example, occur by intra-molecular reaction of the amidoxime. Accordingly, amidoxime molecules containing more than one amidoxime functional groups can be conveniently prepared from precursors having more than one nitrile group. Specific amidoxime molecules having two amidoxime functional groups which have been synthesised in this way include, but are not limited to:

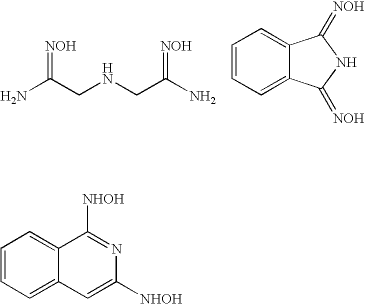

One exemplary method of forming the nitrile precursors to the amidoximes of the present invention is by nucleophilic substitution of a leaving group with a nucleophile. Nucleophiles are well known to the person skilled in the art, see for example the Guidebook to Mechanism in Organic Chemistry by Peter Sykes. Examples of suitable nucleophiles are molecules having an OH, SH, NH— or a suitable CH— group, for example one having a low pKₐ (for example below about 15). For OH, SH and NH—, the hydrogen is optionally removed before acting as a nucleophile in order to augment its nucleophilicity. For CH—, they hydrogen is usually removed with a suitable base so that it can act as a nucleophile. Leaving groups are well known to the person skilled in the art, see for example the Guidebook to Mechanism in Organic Chemistry by Peter Sykes. Examples of suitable leaving groups include Cl, Br, I, O-tosyl, O-mesolate and other leaving group well known to the person skilled in the art. The ability to act as a leaving group may be enhanced by adding an acid, either protic or Lewis. For example, a nitrile can be formed accordingly:

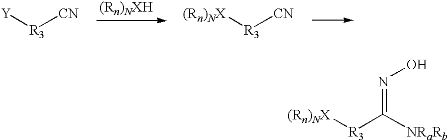

In this example, R₃ is independently selected from alkylene, heteroalkylene, arylene, heteroarylene, alkylene-heteroaryl, or alkylene-aryl group. Rₙ is independently selected from hydrogen, alkyl, heteroalkyl, aryl, heteroaryl, alkyl-heteroaryl, or alkyl-aryl group. X may be any a nucleophile selected from O, S, N, and suitable C. N varies from 1 to 3. Y is a leaving group. For XH═OH, the OH may be an alcohol group or may, for example, be part of a hemiacetal or carboxylic acid group. For X═NH—, the NH may be part of a primary or secondary amine (i.e. NH₂ or NHR₅), NH—CO—, NH—CNH—, NH—CHOH— or —NHNR₅R₆ (wherein R₅ and R₆ are independently-selected alkyl, heteroalkyl, aryl, heteroaryl or alkyl-aryl). For XH═CH—, For XH═CH—, wherein a stabilized anion may be formed. XH may be selected from but not limited to —CHCO—R₅, —CHCOOH, —CHCN, —CHCO—OR₅, —CHCO—NR₅R₆, —CHCNH—R₅, —CHCNH—OR₅, —CHCNH—NR₅R₆, —CHCNOH—R₅, —CHCNOH—OR₅ and —CHCNOH—NR₅R₆.

A specific example is:

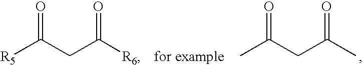

wherein R₅ and R₆ are independently-selected alkyl, heteroalkyl, aryl, heteroaryl or alkyl-aryl or a heteroatom optionally substituted with any of these groups. In one embodiment, either one or both of R₅ and R₆ are oxygen or nitrogen atoms optionally independently substituted with alkyl, heteroalkyl, aryl, heteroaryl or alkyl-aryl groups, for example:

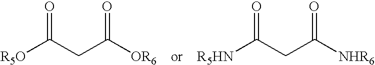

The compounds may also be formed by any type of nucleophilic reaction using any of the above nucleophiles.

The following reaction is versatile for producing nitrile precursors for amidoxime compounds:

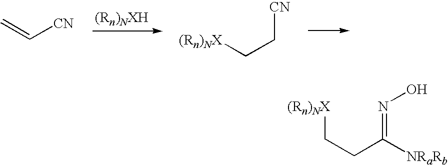

In this example, X bears N independently-selected substituents. Each Rₙ is independently chosen from hydrogen, alkyl, heteroalkyl, aryl, heteroaryl and alkylaryl as previously defined. X is a nucleophile as previously defined. The acrylonitrile may be substituted as desired. For example, the acrylonitrile may have the following formula:

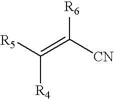

wherein R₄, R₅ and R₆ are independently selected from hydrogen, heteteroatoms, heterogroups, alkyl, heteroalkyl, aryl and heteroaryl.

Accordingly, the present invention also relates to amidoxime compounds for use in semiconductor processing prepared by the addition of a nucleophile to an unsubstituted or substituted acrylonitrile. Once nucleophilic addition to the acrylonitrile has occurred, the intermediate can be functionalized using standard chemistry known to the person skilled in the art:

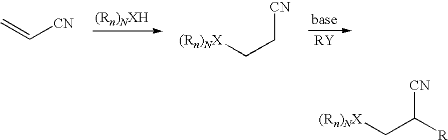

where Y is a leaving group as previously defined. Examples of simple nucleophiles with show the adaptability of this reaction include:

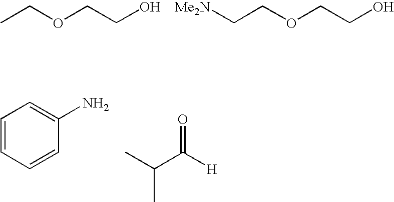

This reaction is particularly versatile, especially when applied to the synthesis of multidentate amidoxime compounds (i.e. molecules containing two or more amidoxime functional groups). For example, it can be used to functionalize compounds having two or more NH groups. In one example, the reaction can be used to functionalize a molecule containing two or more primary amines For example:

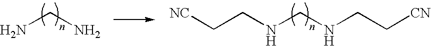

where n is 1 or more, for example 1 to 24. Further functionalization of a primary amine is possible. For example, a tetradentate amidoxime, for example the functional equivalent of EDTA, may be conveniently formed:

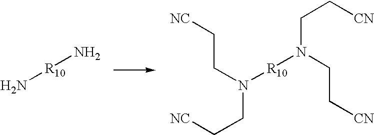

wherein R₁₀ is alkyl, heteroalkyl, aryl or heteroaryl. In an alternative conceived embodiment, R₁₀ is nothing: the starting material is hydrazine. An example of this reaction where R₁₀ is CH₂CH₂ is provided in the examples. In a related embodiment, a molecule having two or more secondary amines can be functionaized:

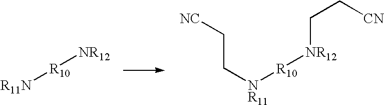

where R₁₀ is defined as above and R₁₁ and R₁₂ are independently selected alkyl, heteroalkyl, aryl or heteroaryl. Again, an embodiment where R₁₀ is nothing is contemplated. For example, the secondary amines can be part of a cyclic system:

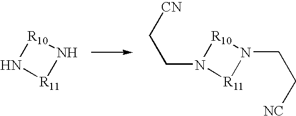

where R₁₀ and R₁₁ are defined above. For example, common solvent used in semiconductor processing can be functionalized with amidoxime functional groups. For example:

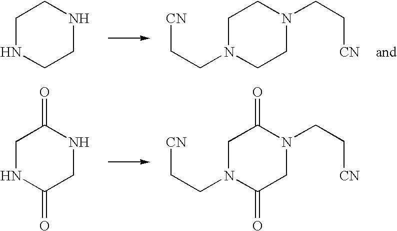

Details of theses reactions are contained in the examples. Similarly, an oxygen nucleophile may be used to provide nitrile precursors to amidoxime molecules. In an exemplary embodiment, the nucleophile is an alcohol:

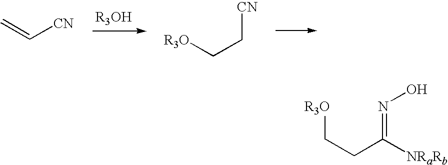

where R₃ is alkyl, heteroalkyl, aryl or heteroaryl.

For example, polyalcohol compounds may be functionalized. Poly-alcohols are molecules that contain more than one alcohol functional group. As an example, the following is a polyalcohol:

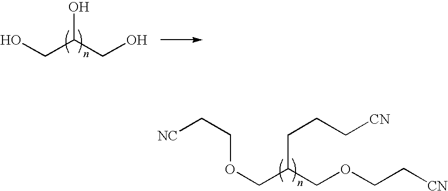

wherein n is 0 or more, for example 0 to 24. In one example, n is 0 (glycol). In another example, n is 6 (sorbitol). In another example, the polyalcohol forms part of a polymer. For example, reaction may be carried out with a polymer comprising polyethylene oxide. For example, the polymer may contain just ethylene oxide units, or may comprise polyethylene oxide units as a copolymer (i.e. with one or more other monomer units). For example, the polymer may be a block copolymer comprising polyethylene oxide. For copolymers, especially block copolymers, the polymer may comprise a monomer unit not containing alcohol units. For example, the polymer may comprise blocks of polyethylene glycol (PEG). Copolymer (e.g. block copolymers) of polyethylene oxide and polyethylene glycol may be advantageous because the surfactant properties of the blocks of polyethylene glycol can be used and controlled.

Carbon nucleophiles can also be used. Many carbon nucleophiles are known in the art. For example, an enol group can act as a nucleophile. Harder carbon-based nucleophiles can be generated by deprotonation of a carbon. While many carbons bearing a proton can be deprotonated if a strong enough base is provided, it is often more convenient to be able to use a weak base to generate a carbon nucleophile, for example NaOEt or LDA. As a result, in one embodiment, a CH group having a pKₐ of 20 or less, for example 15 or less, is deprotonated to form the carbon-based nucleophile. An example of a suitable carbon-based nucleophile is a molecule having the beta-diketone functionality (it being understood that the term beta-diketone also covers aldehydes, esters, amides and other C═O containing functional groups. Furthermore, one or both of the C═O groups may be replaced by NH or NOH). For example:

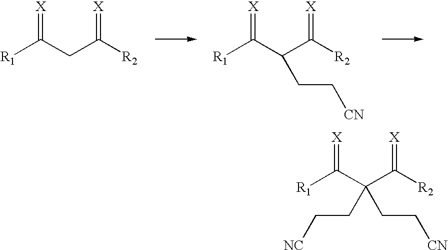

where R₁ and R₂ are independently selected alkyl groups, heteroalkyl groups, aryl groups, heteroaryl groups and heteroatoms. A specific example of this reaction sequence where R₁═R₂═OEt is given in the examples. Nitrile groups themselves act to lower the pKₐ of hydrogens in the alpha position. This in fact means that sometimes control of reaction conditions is preferably used to prevent a cyano compound, once formed by reaction of a nucleophile with acrylonitrile, from deprotonating at its alpha position and reacting with a second acrylonitrile group. For example, selection of base and reaction conditions (e.g. temperature) can be used to prevent this secondary reaction. However, this observation can be taken advantage of to functionalize molecules that already contain one or more nitrile functionalities. For example, the following reaction occurs in basic conditions:

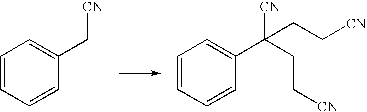

The cyanoethylation process usually requires a strong base as a catalyst. Most often such bases are alkali metal hydroxides such as, e.g., sodium oxide, lithium hydroxide, sodium hydroxide and potassium hydroxide. These metals, in turn, can exist as impurities in the amidoxime compound solution. The existence of such metals in the amidoxime compound solution is not acceptable for use in electronic, and more specifically, semiconductor manufacturing processes and as stabilizer for hydroxylamine freebase and other radical sensitive reaction chemicals.

Prefer alkali bases are metal ion free organic ammonium hydroxide compound, such as tetramethylammonium hydroxide, trimethylbenzylammonium hydroxide and the like.

Water

Within the scope of this invention, water may be introduced into the composition essentially only in chemically and/or physically bound form or as a constituent of the raw materials or compounds.

The composition further comprises chemicals from one or more groups selecting from the following:

Solvent—From about 1% to 99% by weight.

The compositions of the present invention also include 0% to about 99% by weight and more typically about 1% to about 80% by weight of a water miscible organic solvent where the solvent(s) is/are preferably chosen from the group of water miscible organic solvents.

Examples of water miscible organic solvents include, but are not limited to, dimethylacetamide (DMAC), N-methyl pyrrolidinone (NMP), N-Ethyl pyrrolidone (NEP), N-Hydroxyethyl Pyrrolidone (HEP), N-Cyclohexyl Pyrrolidone (CHP) dimethylsulfoxide (DMSO), Sulfolane, dimethylformamide (DMF), N-methylformamide (NMF), formamide, Monoethanol amine (MEA), Diglycolamine, dimethyl-2-piperidone (DMPD), morpholine, N-morpholine-N-Oxide (NMNO), tetrahydrofurfuryl alcohol, cyclohexanol, cyclohexanone, polyethylene glycols and polypropylene glycols, glycerol, glycerol carbonate, triacetin, ethylene glycol, propylene glycol, propylene carbonate, hexylene glycol, ethanol and n-propanol and/or isopropanol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy, ethoxy or butoxy triglycol, I-butoxyethoxy-2-propanol, 3-methyl-3-methoxybutanol, propylene glycol t-butyl ether,and other amides, alcohols or pyrrolidones, ketones, sulfoxides, or multifunctional compounds, such as hydroxyamides or aminoalcohols, and mixtures of these solvents thereof. The preferred solvents, when employed, are dimethyl acetamide and dimethyl-2-piperidone, dimethylsufoxide and N-methylpyrrolidinone, diglycolamine, and monoethanolamine.

Acids—From about 0.001% to 15% by weight

Possible acids are either inorganic acids or organic acids provided these are compatible with the other ingredients. Inorganic acids include hydrochloric acid, hydrofluoric acid, sulfuric acid, phosphoric acid, phosphorous acid, hypophosphorous acid, phosphonic acid, nitric acid, and the like. Organic acids include monomeric and/or polymeric organic acids from the groups of unbranched saturated or unsaturated monocarboxylic acids, of branched saturated or unsaturated monocarboxylic acids, of saturated and unsaturated dicarboxylic acids, of aromatic mono-, di- and tricarboxylic acids, of sugar acids, of hydroxy acids, of oxo acids, of amino acids and/or of polymeric carboxylic acids are preferred. From the group of unbranched saturated or unsaturated monocarboxylic acids: methanoic acid (formic acid), ethanoic acid (acetic acid), propanoic acid (propionic acid), pentanoic acid (valeric acid), hexanoic acid (caproic acid), heptanoic acid (enanthic acid), octanoic acid (caprylic acid), nonanoic acid (pelargonic acid), decanoic acid (capric acid), undecanoic acid, dodecanoic acid (lauric acid), tridecanoic acid, tetradecanoic acid (myristic acid), pentadecanoic acid, hexadecanoic acid (palmitic acid), heptadecanoic acid (margaric acid), octadecanoic acid (stearic acid), eicosanoic acid (arachidic acid), docosanoic acid (behenic acid), tetracosanoic acid (lignoceric acid), hexacosanoic acid (cerotic acid), triacontanoic acid (melissic acid), 9c-hexadecenoic acid (palmitoleic acid), 6c-octadecenoic acid (petroselic acid), 6t-octadecenoic acid (petroselaidic acid), 9c-octadecenoic acid (oleic acid), 9t-octadecenoic acid (elaidic acid), 9c,12c-octadecadienoic acid (linoleic acid), 9t,12t-octadecadienoic acid (linolaidic acid) and 9c,12c,15c-octadecatrienoic acid (linolenic acid). From the group of branched saturated or unsaturated monocarboxylic acids: 2-methylpentanoic acid, 2-ethylhexanoic acid, 2-propylheptanoic acid, 2-butyloctanoic acid, 2-pentylnonanoic acid, 2-hexyldecanoic acid, 2-heptylundecanoic acid, 2-octyldodecanoic acid, 2-nonyltridecanoic acid, 2-decyltetradecanoic acid, 2-undecylpentadecanoic acid, 2-dodecylhexadecanoic acid, 2-tridecylheptadecanoic acid, 2-tetradecyloctadecanoic acid, 2-pentadecylnonadecanoic acid, 2-hexadecyleicosanoic acid, 2-heptadecylheneicosanoic acid. From the group of unbranched saturated or unsaturated di- or tricarboxylic acids: propanedioic acid (malonic acid), butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), 2c-butenedioic acid (maleic acid), 2t-butenedioic acid (fumaric acid), 2-butynedicarboxylic acid (acetylenedicarboxylic acid).

From the group of aromatic mono-, di- and tricarboxylic acids: benzoic acid, 2-carboxybenzoic acid (phthalic acid), 3-carboxybenzoic acid (isophthalic acid), 4-carboxybenzoic acid (terephthalic acid), 3,4-dicarboxybenzoic acid (trimellitic acid), and 3,5-dicarboxybenzoic acid (trimesionic acid). From the group of sugar acids: galactonic acid, mannonic acid, fructonic acid, arabinonic acid, xylonic acid, ribonic acid, 2-deoxyribonic acid, alginic acid.

From the group of hydroxy acids: hydroxyphenylacetic acid (mandelic acid), 2-hydroxypropionic acid (lactic acid), hydroxysuccinic acid (malic acid), 2,3-dihydroxybutanedioic acid (tartaric acid), 2-hydroxy-1,2,3-propanetricarboxylic acid (citric acid), ascorbic acid, 2-hydroxybenzoic acid (salicylic acid), an d 3,4,5-trihydroxybenzoic acid (gallic acid). From the group of oxo acids: 2-oxopropionic acid (pyruvic acid) and 4-oxopentanoic acid (levulinic acid). From the group of amino acids: alanine, valine, leucine, isoleucine, proline, tryptophan, phenylalanine, methionine, glycine, serine, tyrosine, threonine, cysteine, asparagine, glutamine, aspartic acid, glutamic acid, lysine, arginine, and histidine.

Bases—from about 1% to 45% by weight

Possible bases are either inorganic bases or organic bases provided these are compatible with the other ingredients. Inorganic bases include sodium hydroxide, lithium hydroxide, potassium hydroxide, ammonium hydroxide and the like. Organic bases including organic amines, and quaternary alkylammonium hydroxide which may include, but are not limited to, tetramethylammonium hydroxide (TMAH), TMAH pentahydrate, benzyltetramethylammonium hydroxide (BTMAH), TBAH, choline, and Tris(2-hydroxyethyl)methylammonium hydroxide (TEMAH).

Activator—from about 0.001% to 25% by weight

According to the present invention, the cleaning compositions comprise one or more substances from the group of activators, in particular from the groups of polyacylated alkylenediamines, in particular tetraacetylethylenediamine (TAED), N-acylimides, in particular N-nonanoylsuccinimide (NOSI), acylated phenolsulfonates, in particular n-nonanoyl- or isononanoyloxybenzenesulfonate (n- or iso-NOBS) and n-methylmorpholiniumacetonitrile, methylsulfate (MMA), and “nitrile quaternary” compound in amounts of from 0.1 to 20% by weight, preferably from 0.5 to 15% by weight and in particular from 1 to 10% by weight, in each case based on the total composition to enhance the oxidation/reduction performance of the cleaning solutions. The “nitrile quats”, cationic nitrites has the formula,

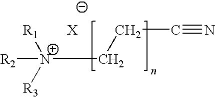

Compounds having oxidation and reduction potential—From about 0.001% to 25% by weight

These compounds include hydroxylamine and its salts, such as hydroxylamine chloride, hydroxylamine nitrate, hydroxylamine sulfate, hydroxylamine phosphate or its derivatives, such as N,N-diethylhydroxylamine, N-Phenylhydroxylamine, hydrazine and its derivatives; hydrogen peroxide; persulfate salts of ammonium, potassium and sodium, permanganate salt of potassium, sodium; and other sources of peroxide are selected from the group consisting of: perborate monohydrate, perborate tetrahydrate, percarbonate, salts thereof, and combinations thereof. For environmental reasons, hydroxylamine phosphate is not preferred.

Other compounds which may be used as ingredients within the scope of the present invention are the diacyl peroxides, such as, for example, dibenzoyl peroxide. Further typical organic compounds which have oxidation/reduction potentials are the peroxy acids, particular examples being the alkyl peroxy acids and the aryl peroxy acids. Preferred representatives are (a) peroxybenzoic acid and its ring substituted derivatives, such as alkylperoxybenzoic acids, but also peroxy-a-naphthoic acid and magnesium monoperphthalate, (b) the aliphatic or substituted aliphatic peroxy acids, such as peroxylauric acid, peroxystearic acid, c-phthalimidoperoxycaproic acid [phthaloiminoperoxyhexanoic acid (PAP)], o-carboxybenzamidoperoxycaproic acid, N-nonenylamidoperadipic acid and N-nonenylamidopersuccinate, and (c) aliphatic and araliphatic peroxydicarboxylic acids, such as 1,2-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid) may be used.

Other Chelating agents—Preferably, the cleaning composition comprises (by weight of the composition) from 0.0% to 15% of additional one or more chelant.

A further possible group of ingredients are the chelate complexing agents. Chelate complexing agents are substances which form cyclic compounds with metal ions, where a single ligand occupies more than one coordination site on a central atom, i.e. is at least “bidentate”. In this case, stretched compounds are thus normally closed by complex formation via an ion to give rings. The number of bonded ligands depends on the coordination number of the central ion.

Complexing groups (ligands) of customary complex forming polymers are iminodiacetic acid, hydroxyquinoline, thiourea, guanidine, dithiocarbamate, hydroxamic acid, amidoxime, aminophosphoric acid, (cycl.) polyamino, mercapto, 1,3-dicarbonyl and crown ether radicals, some of which have very specific activities toward ions of different metals. For the purposes of the present invention, it is possible to use complexing agents of the prior art. These may belong to different chemical groups. In exemplary embodiments, the chelating/complexing agents include the following, individually or in a mixture with one another:

1) polycarboxylic acids in which the sum of the carboxyl and optionally hydroxyl groups is at least 5, such as gluconic acid;

2) nitrogen-containing mono- or polycarboxylic acids, such as ethylenediaminetetraacetic acid (EDTA), N-hydroxyethylethylenediaminetriacetic acid, diethylenetriaminepentaacetic acid, hydroxy-ethyliminodiacetic acid, nitridodiacetic acid-3-propionic acid, isoserinediacetic acid, N,N-di(.beta.-hydroxyethyl)glycine, N-(1,2-dicarboxy-2-hydroxyethyl)glycine, N-(1,2-dicarboxy-2-hydroxyethyl)-aspartic acid or nitrilotriacetic acid (NTA);

3) geminal diphosphonic acids, such as 1-hydroxyethane-1,1-diphosphonic acid (HEDP), higher homologs thereof having up to 8 carbon atoms, and hydroxy or amino group-containing derivatives thereof and 1-aminoethane-1,1-diphosphonic acid, higher homologs thereof having up to 8 carbon atoms, and hydroxy or amino group-containing derivatives thereof;

4) aminophosphonic acids, such as ethylenediamine-tetra(methylenephosphonic acid); diethylenetriaminepenta(methylenephosphonic acid) or nitrilotri(methylenephosphonic acid);

5) phosphonopolycarboxylic acids, such as 2-phosphonobutane-1,2,4-tricarboxylic acid; and

6) cyclodextrins.

Surfactants—From about 10 ppm to 5%.

The compositions according to the invention may thus also comprise anionic, cationic, and/or amphoteric surfactants as surfactant component.

Source of fluoride ions—From an amount about 0.001% to 10%

Sources of fluoride ions include, but are not limited to, ammonium bifluoride, ammonium fluoride, hydrofluoric acid, sodium hexafluorosilicate, fluorosilicic acid and tetrafluoroboric acid.

Although ideally situated for a single wafer process, the solution according to the present invention can also be used in an immersion bath for a batch type cleaning process and provide improved cleaning.

The components of the claimed compositions can be metered and mixed in situ just prior dispensing to the substrate surface for treatment. Furthermore, analytical devices can be installed to monitor the composition and chemical ingredients can be re-constituted to mixture to the specification to deliver the cleaning performance. Critical paramenters that can be monitored includes physical and chemical properties of the composition, such as pH, water concentration, oxidation/reduction potential and solvent components.

Exemplary amidoxime compounds from nitriles:

| | Nitrile (N) | Amidoxime (AO) |
|---|---|---|
| 3 | 3-hydroxypropionitrile | N′,3-dihydroxypropanimidamide |
| 4 | Acetonitrile | NN′-hydroxyacetimidamide |
| 5 | 3-methylaminopropionitrile | N′-hydroxy-3-(methylamino) |
| | | propanimidamide |
| 6 | Benzonitrile | N′-hydroxybenzimidamide |
| 8 | 3,3′ iminodipropionitrile | 3,3′-azanediylbis(N′-hydroxy- |
| | | propanimidamide) |
| 9 | octanonitrile | N′-hydroxyoctanimidamide |
| 10 | 3-phenylpropionitrile | N′-hydroxy-3-phenylpropanimidamide |
| 11 | ethyl 2-cyanoacetate | 3-amino-N-hydroxy-3-(hydroxyimino) |
| | | propanamide |
| 12 | 2-cyanoacetic acid | 3-amino-3-(hydroxyimino)propanoic |
| | | acid |
| 13 | 2-cyanoacetamide | 3-amino-3-(hydroxyimino)propanamide |
| 15 | adiponitrile | N′1,N′6-dihydroxyadipimidamide |
| 16 | sebaconitrile | N′1,N′10-dihydroxydecanebis(imid- |
| | | amide) |
| 17 | 4-pyridinecarbonitrile | N′-hydroxyisonicotinimidamide |
| 18 | m-tolunitrile | N′-hydroxy-3-methylbenzimidamide |
| 19 | phthalonitrile | isoindoline-1,3-dione dioxime |
| 20 | glycolonitrile | N′,2-dihydroxyacetimidamide |
| 21 | chloroacetonitrile | 2-chloro-N′-hydroxyacetimidamide |
| 22 | benzyl cyanide | product N′-hydroxy-2-phenyl- |
| | | acetimidamide |
| 24 | Anthranilonitrile | 2-amino-N′-hydroxybenzimidamide |
| 25 | 3,3′ iminodiacetonitrile | 2,2′-azanediylbis(N′-hydroxy- |
| | | acetimidamide) |
| 26 | 5-cyanophthalide | N′-hydroxy-1-oxo-1,3-dihydroiso- |
| | | benzofuran-5-carboximidamide |
| 27 | 2-cyanophenylacetonitrile | 3-aminoisoquinolin-1(4H)-one oxime |
| | | or 3-(hydroxyamino)-3,4-dihydro- |
| | | isoquinolin-1-amine |
| 29 | cinnamonitrile | N′-hydroxycinnamimidamide |
| 30 | 5-hexynenitrile | 4-cyano-N′-hydroxybutanimidamide |
| 31 | 4-chlorobenzonitrile | 4-chloro-N′-hydroxybenzimidamide |

For example, N3 represents 3-hydroxypropionitrile and AO3 is N′,3-dihydroxypropanimidamide from reacting 3-hydroxypropionitrile with hydroxylamine to form its corresponding amidoxime.

Exemplary amidoxime compounds from nitriles by cyanoethylation of nucleophilic compounds:

| | Nucleophilic | Cyanoethylated Compounds | Amidoxime from cyanoethylated |
|---|---|---|---|
| ID | compounds | (CE) | compounds (AO) |
| 01 | Sorbitol | 1,2,3,4,5,6-hexakis-O-(2- | 1,2,3,4,5,6-hexakis-O-[3-(hydroxyamino)-3- |
| | | cyanoetyl)hexitol | iminopropyl Hexitol |
| 07 | ethylenediamine | 3,3′,3″,3″′-(ethane-1,2- | 3,3′,3″,3″′-(ethane-1,2-diylbis(azanetriyl)) |
| | | diylbis(azanetriyl))tetrapropane- | tetrakis(N′-hydroxypropanimidamide) |
| | | nitrile | |
| 28 | ethylene glycol | 3,3′-(ethane-1,2-diylbis(oxy)) | 3,3′-(ethane-1,2-diylbis(oxy))bis(N′- |
| | | dipropanenitrile | hydroxypropanimidamide) |
| 34 | diethylamine | 3-(diethylamino)propane nitrile | 3-(diethylamino)-N′- |
| | | | hydroxypropanimidamide |
| 35 | piperazine | 3,3′-(piperazine-1,4- | 3,3′-(piperazine-1,4-diyl)bis(N′- |
| | | diyl)dipropanenitrile | hydroxypropanimidamide) |
| 36 | 2-ethoxyethanol | 3-(2-ethoxyethoxy) | 3-(2-ethoxyethoxy)-N′- |
| | | propanenitrile | hydroxypropanimidamide |
| 37 | 2-(2- | 3-(2-(2-(dimethylamino) | 3-(2-(2-(dimethylamino)ethoxy)ethoxy)-N′- |
| | dimethylamino | ethoxy)ethoxy)propanenitrile | hydroxypropanimidamide |
| | ethoxy)ethanol | | |
| 38 | isobutyraldehyde | 4,4-dimethyl-5-oxo | N′-hydroxy-4,4-dimethyl-5- |
| | | pentanenitrile | oxopentanimidamide |
| 39 | diethyl malonate | diethyl 2,2-bis(2-cyanoethyl) | 2,2-bis(3-amino-3- |
| | | malonate | (hydroxyimino)propyl)malonic acid |
| 40 | aniline | 3-(phenylamino) propanenitrile | N′-hydroxy-3-(phenylamino) |
| | | | propanimidamide |
| 41 | ammonia | 3,3′,3″-nitrilotri propanenitrile | 3,3′,3″-nitrilotris(N′- |
| | | | hydroxypropanimidamide) |
| 42 | diethyl malonate | 2,2-bis(2-cyanoethyl) malonic | 2,2-bis(3-amino-3- |
| | | acid | (hydroxyimino)propyl)malonic acid |
| 43 | Glycine (Mono | 2-(2-cyanoethylamino)acetic | 2-(3-amino-3-(hydroxyimino) |
| | cyanoethylated) | acid | propylamino)acetic acid |
| 44 | Glycine | 2-(bis(2-cyanoethyl)amino) | 2-(bis(3-amino-3-(hydroxyimino) |
| | (Dicyanothylated) | acetic acid | propyl)amino)acetic acid |
| 45 | malononitrile | propane-1,1,3-tricarbonitrile | N1,N′1,N′3-trihydroxypropane-1,1,3- |
| | | | tris(carboximidamide) |
| 46 | cyanoacetamide | 2,4-dicyano-2-(2- | 5-amino-2-(3-amino-3- |
| | | cyanoethyl)butanamide | (hydroxyimino)propyl)-2-(N′- |
| | | | hydroxycarbamimidoyl)-5- |
| | | | (hydroxyimino)pentanamide |
| 47 | Pentaerythritol | 3,3′-(2,2-bis((2-cyanoethoxy) | 3,3′-(2,2-bis((3-(hydroxyamino)-3- |
| | | methyl) propane-1,3- | iminopropoxy)methyl)propane-1,3- |
| | | diyl)bis(oxy) dipropanenitrile | diyl)bis(oxy)bis(N- |
| | | | hydroxypropanimidamide) |
| 48 | N-methyl | 3,3′-(2,2′-(methylazanediyl) | 3,3′-(2,2′-(methylazanediyl)bis(ethane-2,1- |
| | diethanol amine | bis(ethane-2,1-diyl) | diyl)bis(oxy))bis(N′- |
| | | bis(oxy))dipropanenitrile | hydroxypropanimidamide) |
| 49 | glycine anhydride | 3,3′-(2,5-dioxopiperazine-1,4- | 3,3′-(2,5-dioxopiperazine-1,4-diyl)bis(N′- |
| | | diyl)dipropanenitrile | hydroxypropanimidamide) |
| 50 | acetamide | N,N-bis(2-cyanoethyl)acetamide | N,N-bis(3-amino-3- |
| | | | (hydroxyimino)propyl)acetamide |
| 51 | anthranilonitrile | 3,3′-(2-cyanophenylazanediyl) | 3,3′-(2-(N′-hydroxycarbamimidoyl) |
| | | dipropanenitrile | phenylazanediyl)bis |
| | | | (N′-hydroxypropanimidamide) |
| 52 | diethanolamine | 3,3′-(2,2′-(2- | 3,3′-(2,2′-(3-amino-3- |
| | | cyanoethylazanediyl)bis(ethane- | (hydroxyimino)propylazanediyl)bis(ethane |
| | | 2,1-diyl)bis(oxy))dipropane | 2,1-diyl))bis(oxy)bis(N′- |
| | | nitrile | hydroxypropanimidamide) |

For example, CE36 represents cyanoethylated product of ethylene glycol and AO36 is from reacting 3-(2-ethoxyethoxy)propanenitrile with hydroxylamine to form its corresponding amidoxime.

Thus, a novel cleaning method and solution for use in a FEOL cleaning process have been described. It is to be appreciated that the disclosed specific embodiments of the present invention are only illustrative of the present invention and one of ordinary skill in the art will appreciate the ability to substitute features or to eliminate disclosed features.

What is claimed is:

1. A method of cleaning a surface of a substrate at the front end of line wherein the composition comprises at least one amidoxime compound and water.

2. The method of claim 1 further comprising a base.

3. The method of claim 1 further comprising a compound with an oxidation and reduction potential.

4. The method of claim 1 further comprising an acid.

5. The method of claim 1, wherein the at least one amidoxime compound is prepared from the reaction of a nitrile compound with hydroxylamine.

6. The method of claim 2, where the base is selected from the group consisting of ammonia, an organic ammonium compound, an oxaammonium compound, salts thereof, and mixtures thereof.

7. The method of claim 3, where the compound with an oxidation and reduction potential is selected from the group consisting of hydrogen peroxide, hydroxylamine free base and its salts, and mixtures thereof

8. The method of claim 4, where the acid is selected from the group consisting of hydrochloric acid, hydrofluoric acid, nitric acid, sulfuric acid, phosphoric acid and mixtures thereof.

9. The method of claim 5, wherein the nitrile compound is prepared from cyanoethylation of a compound selected from the group consisting of sugar alcohols, hydroxy acids, sugar acids, monomeric polyols, polyhydric alcohols, glycol ethers, polymeric polyols, polyethylene glycols, polypropylene glycols, amines, amides, imides, amino alcohols, and synthetic polymers containing at least one functional group that is —OH or —NHR, where R is H or alkyl, heteroalkyl, aryl or heteroaryl.

10. The method according to claim 1, wherein the amidoxime compound is present in an amount sufficient to minimize the deposition of a metal impurity, and ranges from 10 ppm to 25%.

11. A method of cleaning a surface of a substrate at the front end of line wherein the composition comprises at least one amidoxime compound, hydrogen peroxide, ammonium hydroxide and water.

12. The method of claim 11 where the relative ratios of the ammonium hydroxide/hydrogen peroxide/water is 1:1:5 to 1:20:100.

13. A method of cleaning a surface of a substrate at the front end of line wherein the composition comprises at least one amidoxime compound, hydrogen peroxide, hydrochloric acid or hydrofluoric acid and water.

14. The method of claim 13 where the relative ratios of the hydrochloric acid/hydrogen peroxide/water is 1:1:6 to 1:35:65.

15. The method of claim 13, where the acid is hydrofluoric acid.

16. A method of applying the composition of claim 25 to a semiconductor substrate prior to processing of the substrate.

17. The method of claim 16, wherein the composition is applied to a semiconductor substrate prior to a metalization process.

18. The method of claim 16, wherein the composition is applied to a semiconductor substrate prior to a cleaning process.

19. The method of claim 16, wherein the composition is applied to a semiconductor substrate prior to an etching process.

20. A method of processing a wafer comprising contacting the wafer with an aqueous cleaning solution comprising at least one amidoxime compound, wherein the wafer is exposed to the solution for a time in the approximate range of 30 seconds to 600 seconds.

21. The method according to claim 20, wherein the amidoxime compound is present in an amount sufficient to minimize deposition of a metal impurity.

22. The method of claim 21, wherein the amidoxime compound is present in an amount of about 100 ppm to about 25 percent by weight.

23. The method of claim 20, wherein the cleaning solution further comprises an additional chelating or complexing agent in the amount of up to about 2 percent by weight.

24. The method of claim 20, wherein the cleaning solution further comprises a surfactant in an amount of about 10 ppm to about 5 percent by weight.

25. A cleaning composition for stripping-cleaning ion-implanted wafer substrates from FEOL processes, the composition comprising: a) at least one amidoxime compound b) at least one organic stripping solvent, and c) water.

26. The composition of claim 25 further comprising at least one of ammonium fluoride, ammonium bifluoride and hydrogen fluoride.

27. The composition of claim 25 further comprising at least one acid selected from an inorganic or an organic acid.

28. The composition of claim 25 further comprising at least one alkanolamine selected from monoethanolamine and diglycolamine.

29. The composition of claim 25 further comprising an additional chelating or complexing agent in an amount up to about 15 percent by weight.

30. The composition of claim 25 further comprising a surfactant in an amount of about 10 ppm to about 5 percent by weight.

31. The composition of claim 25, wherein the at least one organic stripping solvent is selected from the group consisting of N-methyl-2-pyrrolidone, dimethyl sulfoxide (DMSO), tetrahydrothiophene-1,1-dioxide compounds, dimethylacetamide and dimethyiformamide.

32. A cleaning composition for stripping-cleaning ion-implanted wafer substrates from FEOL processes, wherein the composition comprises from about 45 to about 82 wt % of an organic solvent; about 0.8 to about 0.1 wt % of ammonium fluoride; about 0.8 to about 3 wt % of hydrochloric acid; about 15 to about 50 wt % of water; and hydrogen peroxide, wherein the hydrogen peroxide is present in an amount such that the weight ratio of the other components to the hydrogen peroxide component is about 2:1 to about 5:1.

33. A cleaning composition for stripping-cleaning ion-implanted wafer substrates from FEOL processes, wherein the composition comprises an organic solvent in an amount of up to about 99 percent by weight; a base in an amount of about 1 to about 45 percent by weight; an activator in an amount of about 0.001 to about 25 percent by weight; an additional chelating or complexing agent in an amount of up to about 15 percent by weight; and a surfactant in an amount of about 10 ppm to about 5 percent by weight.

34. A method of cleaning a wafer at the front end of line comprising: placing a wafer in a single wafer cleaning tool; cleaning the wafer with a solution comprising: water; an amidoxime; an organic solvent in an amount of up to about 99 percent by weight; optionally a base in an amount of about 1 to about 45 percent by weight; optionally a compound with oxidation and reduction potential in an amount of about 0.001 to about 25 percent by weight; optionally an activator in an amount of about 0.001 to about 25 percent by weight; an additional chelating or complexing agent in an amount of up to about 15 percent by weight; optionally a surfactant in an amount of about 10 ppm to about 5 percent by weight; and optionally a fluoride ion source in an amount of about 0.001 to about 10 percent by weight.

35. A method of cleaning a wafer at front end of line comprising: placing a wafer in single wafer cleaning tool; cleaning said wafer with a solution comprising: water; an amidoxime compound; an organic solvent in an amount of up to about 99 percent by weight; optionally an acid in an amount of about 0.001 to about 15 percent by weight; optionally a compound with oxidation and reduction potential in an amount of about 0.001 to about 25 percent by weight; optionally an activator in an amount of about 0.001 to about 25 percent by weight; an additional chelating or complexing agent in an amount of up to about 15 percent by weight; optionally a surfactant in an amount of about 10 ppm to about 5 percent by weight; and optionally a fluoride ion source in an amount of about 0.001 to about 10 percent by weight.

36. The method of claim 34 or claim 35, wherein the cleaning solution comprising at least one amidoxime compound is further diluted prior to use.

37. The method of claim 36, wherein the dilution factor is from about 10 to 500.
